(19) United States
(12) Patent Application Publication
(10) Pub. No.: US 2009/0150405 A1
(43) Pub. Date: Jun. 11, 2009

(54) Systems and Methods for Expressing Data Using a Media Markup Language

(76) Inventors: Nicholas A. Grouf, Beverly Hills, CA (US); David Waxman, Los Angeles, CA (US); Marco DeMello, Los Angeles, CA (US); Alexander Lichstein, Santa Monica, CA (US); Craig Tadlock, Santa Monica, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/172,968

(22) Filed: Jul. 14, 2008

Related U.S. Application Data
(60) Provisional application No. 60/949,632, filed on Jul. 13, 2007.

(51) Int. Cl. G06F 17/30

(52) U.S. Cl. 707/10; 707/102; 707/E17.044; 707/E17.001

(57) ABSTRACT

Disclosed herein are methods and systems for integrating data from disparate data stores associated with disparate sources. One or more network interfaces are coupled to a plurality of disparate data stores, wherein the data stores supply advertising inventory data, and wherein different data stores store data related to different types of advertising media in different formats. An engine is provided that transforms the inventory data from the data stores into a common format. The transformed data is stored in an integrated data store. An interface provides access to the transformed advertising inventory data to a computer-based media transaction system.

### CROSS-REFERENCE TO RELATED APPLICATIONS

This application claims the benefit of U.S. Provisional Application No. 60/949,632, filed Jul. 13, 2007, the content of which is incorporated herein by reference in its entirety.

This application is related to copending application, entitled METHODS AND SYSTEMS FOR SEARCHING FOR SECURE FILE TRANSMISSION, Serial Number [Unknown] [Attorney Docket No. SPTRN.008A], copending application, entitled METHODS AND SYSTEM FOR SEARCHING ACROSS DISPARATE DATABASES, Ser. No. [Unknown] [Attorney Docket No. SPTRN.008A2], copending application, entitled METHODS AND SYSTEMS FOR PREDICTING FUTURE DATA, Ser. No. [Unknown] [Attorney Docket No. SPTRN.008A3], copending application, entitled DISTRIBUTED DATA SYSTEM, Ser. No. [Unknown] [Attorney Docket No. SPTRN.008A4], and copending application, entitled SYSTEMS AND METHODS FOR MEASURING DATA DISTRIBUTION EFFECTS, Ser. No. [Unknown] [Attorney Docket No. SPTRN.008A5], all filed on the same date as the present application, the entirety of which are hereby incorporated by reference.

### STATEMENT REGARDING FEDERALLY SPONSORED R&D

Not applicable.

### PARTIES OF JOINT RESEARCH AGREEMENT

Not applicable.

### REFERENCE TO SEQUENCE LISTING, TABLE, OR COMPUTER PROGRAM LISTING

Not applicable.

### BACKGROUND OF THE INVENTION

1. Field of the Invention

The present invention is related to media, and in particular to methods and systems for performing media searches, the networked distribution of media, and electronic media editing.

2. Description of the Related Art

Many conventional approaches for media creation, selection, and distribution are inefficient and often provide inferior results. Further; many conventional approaches for media distribution fail to allow content owner to adequately control how their content is used.

### SUMMARY OF THE INVENTION

The present invention is related to methods and systems for performing media searches, the networked distribution of media and the rights to utilize media, and the transference of media usage rights.

An example embodiment enables a media content owner (which is also intended to include an agent of the owner or other entity authorized by the owner) to control which other media, such as advertisements, can be played in conjunction with the owner's content and/or how other media can be played in conjunction with the owner's content. Additional optional examples will now be described.

One or more embodiments provide a method of distributing media via a network, the method comprising: including in a first media file first media content and first metadata providing one or more rules constraining whether and/or when a second media content can be played (e.g., directly in sequence before the first content, directly in sequence after the first content, between the beginning and end of the first media content, and/or while the first media content is being played); and including in the first media file a network resource address associated with the second media content which is to be accessed over a network when the first media content is played via a terminal player which receives the first media file, so that the second media content can be played.

Optionally, the method further comprises inserting in the first media file a third media content configured to be selectively played if the second media content is inaccessible when an instruction is provided indicating that the first media content is to played. Optionally, the one or more rules are specified by the owner of the first media content. Optionally, a first rule indicates that second media is allowed to be played between the beginning and end of the first media content. Optionally, a first rule indicates that second media is not allowed to be played between the beginning and end of the first media content. Optionally, a first rule indicates whether the second media is allowed to be played directly before the first media. Optionally, a first rule indicates whether the second media is allowed to be played directly after the first media. Optionally, a first rule indicates whether the second media is allowed to overlay at least a portion of the first media. Optionally, a first rule indicates whether the second media is allowed to be displayed while the first media is being played.

Optionally, the method further comprises transmitting the first media file to the terminal. Optionally, the terminal is a set-top box, a digital video recorder, a personal computer, or a phone. Optionally, the method further comprises transmitting a public key in association with the first media file. Optionally, the first media file includes MPEG content and/or vector-based content. Optionally, the second media content includes an advertisement, a second network resource address, a second network resource address associated with a merchant website, and/or a second network resource address associated with a channel. Optionally, the network resource address is specified by the owner of the first media content. Optionally, the network resource address is a uniform resource locator (URL).

One or more embodiments provide another method of securely distributing media via a network, the method comprising: in a first media file, including first media content and a locator associated with a second media content, wherein the second media content is to be accessed when the first media content is played via a terminal player so that the second media content can be played; and associating with the first media file a third media content configured to be selectively played if the second media content is inaccessible.

Optionally, the locator is specified by the owner of the first media content and is optionally in the form of a URL.

Optionally, the third media content is a video file.

Optionally, the method further comprises transmitting the first media file to the terminal player, wherein the terminal player is optionally a set-top box, a digital video recorder, a personal computer, or a phone.

Optionally, the method further comprises transmitting a public key in association with the first media file.

Optionally, the first media file includes MPEG and/or vector-based content.

One or more embodiments provides programmatic code stored on a computer readable medium, that when executed is configured to: associate a first media file first media content with first metadata providing one or more rules constraining how a and/or what second media content can be played in conjunction with the first media content; and include in the first media file a locator associated with the second media content which is to be accessed over a network when the first media content is played via a terminal player which receives the first media file.

Optionally, the code is further configured to store an indication is association with the first media content that a third media content is to be played if the second media content is inaccessible.

Optionally, a first rule indicates that second media is allowed to be played between the beginning and end of the first media content. Optionally, a first rule indicates that second media is not allowed to be played between the beginning and end of the first media content. Optionally, a first rule indicates whether the second media is allowed to be played directly before the first media. Optionally, a first rule indicates whether the second media is allowed to be played directly after the first media. Optionally, a first rule indicates whether the second media is allowed to overlay at least a portion of the first media. Optionally, a first rule indicates whether the second media is allowed to be displayed while the first media is being played. Optionally, the first media content is a video. Optionally, the second media content includes video, graphics, text, and/or audio.

One or more embodiments enable a user specification/query (e.g., of media advertising inventory, such as television, radio, or Web spots) to be utilized in performing a search operation to identify media-related matches (e.g., advertising spots). Optionally a transaction is performed or facilitated between the user and the owner(s) of the media-related matching objects (e.g., one or more advertising spots).

An example embodiment provides a method of searching for appropriate programming inventory, the method comprising: receiving a specification from a first user seeking to purchase one or more advertising spots; accessing in substantially real time advertising spot inventory data from a plurality of advertising spot inventory sellers; at least partly enabling a search to be performed on the real time advertising spot inventory data using the first user specification; at least partly based on the search, identifying one or more matches to the first user; and at least partly enabling the first user to engage in a transaction with a first entity with respect to the matching inventory.

Optionally, the method further comprises accessing and updating a seller inventory data store to reflect the transaction. Optionally, the method further comprises accessing data stores associated with at least two of the following entities: an online media entity; a television network entity; a radio network entity; an out of home advertising entity. Optionally, the method further comprises providing a user interface via which a seller can define a proposal, including ratings and dayparts.

Optionally, the method further comprises providing the first user with a user interface including: a first field for receiving a budget term; a second field for receiving a rating term; and a third field for receiving a tier term. Optionally, the one or more matches include a cluster, wherein the cluster includes a package of inventory offered by a seller, including inventory from a plurality of networks. Optionally, the method further comprises automatically generating an inventory seller proposal at least partly in response to the first user specification. Optionally, the method further comprises enabling the automatic completion of the transaction after the first user indicates the acceptance of at least one of the matches. Optionally, the method further comprises providing a user interface via which an inventory seller can specify one or more buyer preferences, such as a disfavored industry or buyer that is not to be sold spots. Optionally, a user interface is provided via which the inventory seller can specify an inventory discount. Optionally, the method further comprises providing an electronic notification regarding the transaction to the first user and the owner of the matching inventory involved in the transaction. Optionally, the method further comprises providing the first user with a buyer work sheet.

One or more embodiments provide a method of searching for appropriate programming inventory, the method comprising: accessing from a plurality of data stores media inventory data for a plurality of different media types in a plurality of different formats; transforming the media inventory data; storing the transformed media data in a first data store; receiving a first inventory query from a first user, the first inventory query specifying a rating associated with a first demographic, a program tier and/or a channel tier; at least partly enabling a search to be performed on the transformed media data using the first query; at least partly based on the search, identifying one or more matches to the first user; and at least partly enabling the first user to engage in a transaction with a first entity with respect to the matching inventory.

Optionally, the method further comprises accessing a seller inventory data store in substantially real time at least partly in response to the first query. Optionally, the method further comprises accessing and updating a seller inventory data store to reflect the transaction. Optionally, the method further comprises accessing data stores associated with at least two of the following entities: an online media entity; a television network entity; a radio network entity; an out of home advertising entity.

Optionally, the method further comprises providing the first user with a user interface including: a first field for receiving the budget term; a second field for receiving the rating term; and a third field for receiving at least one tier term. Optionally, the method further comprises providing a user interface via which a seller can define a proposal, including ratings and dayparts. Optionally, the method further comprises providing a user interface via which an inventory seller can specify one or more buyer preferences. Optionally, a first buyer preference identifies a disfavored industry. Optionally, a first buyer preference identifies a disfavored buyer. Optionally, the method further comprises providing a user interface via which the inventory seller can specify an inventory discount. Optionally, the method further comprises providing an electronic notification regarding the transaction to the first user and the owner of the matching inventory involved in the transaction. Optionally, the method further comprises providing the first user with a buyer work sheet.

Optionally, the one or more matches include a cluster, wherein the cluster includes a package of inventory offered by a seller, including inventory from a plurality of networks.

Optionally, the method further comprises automatically generating an inventory seller proposal at least partly in response to the first query. Optionally, the method further comprises enabling the automatic completion of the transaction after the first user indicates the acceptance of at least one of the matches.

One or more embodiments provide a method of searching for appropriate programming inventory, the method comprising: at least partly enabling a user interface to be provided over a network via which a first user can provide a specification regarding advertising spots, including: a program tier and/or a channel tier; a daypart; budgeting information; and at least partly enabling an electronic search for offerings from at least a second user to identify one or more offerings that correspond to the first user specification.

Optionally, a search is performed by accessing inventory data from a plurality of inventory sellers. Optionally, the first user is an advertiser and the second user is a media outlet.

Optionally, the method further comprises at least partly enabling the user interface to be provided via which the first user can specify a mix of media types.

Optionally, the user interface is configured to enable the first user to provide a total campaign budget and a periodic budget.

Optionally, the method further comprises accessing an inventory data store associated with the second user in substantially real time at least partly in response to a transaction with the first user.

Optionally, the method further comprises accessing data stores associated with at least two of the following entities: an online media entity; a television network entity; a radio network entity; an out of home advertising entity.

Optionally, the method further comprises providing a user interface via which an inventory seller can define a proposal, including ratings and dayparts. Optionally, the method further comprises automatically generating a proposal for the second user at least partly in response to the first user specification. Optionally, the method further comprises providing a user interface via which the second user can specify one or more buyer preferences (e.g., a disfavored industry or buyer).

Optionally, a user interface is provided via which the second user can specify an inventory discount. Optionally, the method further comprises providing the first user with a buyer work sheet.

One or more embodiments identify or receive an indication that a provider of advertisement inventory (e.g., spots) failed to meet one or more items of a user specification (e.g., related to demographics, such as total demographics or that of one or more subsets). Systems and methods are provided which identify advertising inventory that can be utilized to compensate for the failure.

One or more embodiments provide a method of facilitating advertising make goods, the method comprising: receiving an indication that a first inventory seller failed to provide agreed upon ratings with respect to a buyer; searching for available inventory authorized for use in a make good using indicators accessed from a data store; and generating a make good proposal substantially sufficient to make good the failure to provide agreed upon ratings.

Optionally, the method further comprises: accessing a buyer defined rule; and using the buyer defined rule in generating the make good proposal.

Optionally, the buyer defined rule relates to a program and/or channel tier, and/or to a daypart.

One or more embodiments provide programmatic code stored on a computer readable medium, that when executed is configured to: receive an indication that a first inventory seller failed to provide agreed upon ratings with respect to a buyer; search for available inventory authorized for use in a make good using indicators accessed from a data store; and generate a make good proposal substantially sufficient to make good the failure to provide agreed upon ratings.

Optionally, the code is further configured to: access a buyer defined rule; and use the buyer defined rule in generating the make good proposal. Optionally, the buyer defined rule relates to a program and/or channel tier. Optionally, the buyer defined rule relates to a daypart.

One or more embodiments provide a marketplace (e.g., an auction and/or commodity style marketplace) for performing transactions regarding advertising inventory.

One or more embodiments provides a method of conducting an auction for advertising spot inventory, the method further comprising: providing a user interface via which a seller of advertising spot inventory can specify a cluster of advertising spot inventory, including a plurality of spots; providing a user interface via which users can bid on the cluster; and determining the winner of the auction using bid amounts.

Optionally, the cluster includes advertising spots from multiple networks. Optionally, the cluster includes radio advertising spot inventory and television advertising spot inventory. Optionally, the cluster includes online advertising spot inventory and television spot inventory. Optionally, the auction is in the form of a combinatorial auction.

One or more embodiments provide a method of conducting an auction for advertising spot inventory, the method further comprising: receiving a plurality of advertising spot inventory sales offers from a plurality of sellers; receiving at least one advertising spot inventory buy offer from a first buyer; determining if the buy offer matches at least one sales offer; and if the buy offer matches at least one sales offer; facilitating a transaction between the buyer and a seller associated with at least one matching buy offer.

Optionally, the method further comprises comparing buy offers from multiple buyers with advertising spot inventory sales offers from multiple sellers. Optionally, at least one advertising spot inventory sales offer includes a plurality of spots. Optionally, at least one advertising spot inventory sales offer includes spots associated with different media types. Optionally, the method further comprises automatically concluding the transaction between the buyer and the seller associated with the matching buy offer.

One or more embodiments provide methods and systems predicting media related prices/values (e.g., for advertising content and/or spots).

One or more embodiments provide a method for predicting advertisement content prices, the method comprising: accessing information regarding a plurality of users' interest in a first advertising content; accessing information regarding historical pricing trends; accessing information indicating a correlation with respect to a first event-type and interest in the first content; and providing a pricing estimate for the use of the first content with respect to an advertisement using at least a portion of the accessed information regarding users' interest, pricing trends, and correlations. Optionally, the pricing estimate is based at least in part on a quantity of page views of a Web page associated with the first advertising content. Optionally, the pricing estimate is based at least in part on a quantity of search queries related to the content. Optionally, the pricing estimate is based at least in part on website traffic.

Optionally, the pricing estimate is based at least in part on content of a user on a website hosting the content. Optionally, the pricing estimate is based at least in part on references to the content on one or more user web logs. Optionally, the pricing estimate is based at least in part on content of a first news feed, on IP addresses of content viewers, one or more user purchase histories. Optionally, the pricing estimate is based at least in part on location of users viewing the content. Optionally, the pricing estimate is based at least in part on a Really Simple Syndication feed. Optionally, the pricing estimate is based at least in part on an ATOM feed. Optionally, a local maxima in revenue is identified.

One or more embodiments provide programmatic code stored on a computer readable medium, that when executed is configured to: access information regarding a plurality of users' interest in a first advertising content; access information regarding historical pricing trends; access information indicating a correlation with respect to a first event-type and interest in the first content; and provide a pricing estimate for the use of the first content with respect to an advertisement. Optionally, the pricing estimate is based at least in part on a quantity of page views of a Web page associated with the first advertising content. Optionally, the pricing estimate is based at least in part on a quantity of search queries related to the content. Optionally, the pricing estimate is based at least in part on website traffic. Optionally, the pricing estimate is based at least in part on a content of a user on a website hosting the content. Optionally, the pricing estimate is based at least in part on references to the content on one or more user web logs. Optionally, the pricing estimate is based at least in part on content of a first news feed, on IP addresses of content viewers, one or more user purchase histories. Optionally, the pricing estimate is based at least in part on location of users viewing the content. Optionally, the pricing estimate is based at least in part on a Really Simple Syndication feed. Optionally, the pricing estimate is based at least in part on an ATOM feed. Optionally, a local maxima in revenue is identified.

One or more embodiments provide a computer-based content pricing estimator system, comprising: a first interface configured to receive an indication as to how many search queries have been submit that are related to a first item of content; a second interface configured to receive information related to web traffic associated with the first item of content; a third interface configured to receive news information correlated with the first item of content; and a pricing engine configured to estimate a price for the first item content at least partly based on information received from the first, second, and/or third interface. Optionally, the pricing engine is further configured to generate the estimate at least partly based on blog references related to the content, on page views of a page related to the content, on a purchase history, on the locations of users viewing the content, and/or on an ATOM feed. Optionally, the pricing engine is further configured to identify a local maxima in revenue.

One or more embodiments enable data to be gathered from a plurality of sources, transformed, and stored (optionally in a unified data store, such as a database).

One or more embodiments provide a method of aggregating information related to advertising from a plurality of sources, comprising: accessing data related to an audience of media consumers from a plurality of vendors; combining at least a portion of the data from the plurality of vendors into a unified data store; and extracting data from the unified data store at least partly based on significance information. Optionally, data from a first vendor is provided with a different significance weighting than that of a second vendor. Optionally, the weighting is performed using Bayesian probabilistic determination and/or using fuzzy logic. Optionally, data is accessed from a least one vendor in substantially real time.

Optionally, the method further comprises providing an advertisement spot buy recommendation at least partly based on the extracted data. Optionally, the method further comprises receiving vendor data including a survey of experts. Optionally, the method further comprises receiving vendor data including data related to observed user behavior. Optionally, the method further comprises receiving vendor data including customer feedback. Optionally, the method further comprises receiving vendor data including geospatial data. Optionally, the method further comprises receiving vendor data including census data. Optionally, the method further comprises receiving vendor data including a demographic survey. Optionally, the method further comprises receiving vendor data including media consumption data. Optionally, the method further comprises receiving vendor data including a psychographic survey.

One or more embodiments provide programmatic code stored on a computer readable medium, that when executed is configured to: access data related to an audience of media consumers from a plurality of vendors; combine at least a portion of the data from the plurality of vendors into a unified data store; and extract data from the unified data store at least partly based on significance information.

Optionally, data from a first vendor is provided with a different significance weighting than that of a second vendor. Optionally, the weighting is performed using Bayesian probabilistic determination and/or using fuzzy logic. Optionally, data is accessed from a least one vendor in substantially real time. Optionally, the code is further configured to provide an advertisement spot buy recommendation at least partly based on the extracted data. Optionally, the code is further configured to receive vendor data including a survey of experts. Optionally, the code is further configured to receive vendor data including data related to observed user behavior. Optionally, the code is further configured to receive vendor data including customer feedback. Optionally, the code is further configured to receive vendor data including geospatial data. Optionally, the code is further configured to receive vendor data including census data.

Optionally, the code is further configured to receive vendor data including a demographic survey. Optionally, the code is further configured to receive vendor data including media consumption data. Optionally, the code is further configured to receive vendor data including a psychographic survey.

One or more embodiments provide a method of measuring communication efficacy by utilizing two or more types of communications (e.g., marketing/advertising campaigns) and measure the different effects of the communication types.

One or more embodiments provide a method of measuring communication efficacy, the method comprising: after a first direct marketing campaign related to a product or service associated with a first brand has been initiated, transmitting over a network a first query to be provided to one or more entities regarding the first brand; after an awareness campaign related to the brand has been initiated, transmitting over the network a second query to be provided to one or more entities regarding the first brand; storing responses to the first query and the second query in a computer readable medium; comparing responses to the first query with responses to the second query; and providing an indication of the awareness campaign efficacy at least partly based on differences between responses to the first query and the second query.

Optionally, the first query and the second query request the same information. Optionally, the first direct marketing campaign includes one or more types of communications, including a coupon and/or a mailing. Optionally, the first direct marketing campaign includes one or more types of communications asking a recipient to take a specified action. Optionally, the first direct marketing campaign includes one or more types of communications asking a recipient to call a specified phone number. Optionally, the first direct marketing campaign includes one or more types of communications asking a recipient to send an email to a specified address. Optionally, the first direct marketing campaign includes one or more types of communications asking a recipient to visit a website associated with the brand. Optionally, the first direct marketing campaign includes one or more types of communications instructing a recipient on the use of a first coupon. Optionally, the first query relates to recognition level of the brand. Optionally, the first query relates to how favorably the brand is viewed. Optionally, the awareness campaign does not request that a recipient take a specific action.

Optionally, the method further comprises generating a report indicating the percentage change in responses with respect to the first query and second query. Optionally, the method further comprises generating a report indicating the percentage change in responses with respect to the first query and second query for a first identified demographic group and a second identified demographic group. Optionally, the method further comprises measuring efficacy of the awareness campaign using website log data. Optionally, the method further comprises measuring efficacy of the awareness campaign using phone log data. Optionally, the method further comprises measuring efficacy of the awareness campaign using email log data. Optionally, the method further comprises measuring efficacy of the awareness campaign using advertisement broadcast verification data. Optionally, the method further comprises measuring efficacy of the awareness campaign using ratings data. Optionally, the awareness campaign is conducted at the same time as a second direct marketing campaign. Optionally, the first direct marketing campaign is conducted a first specified period of time before the awareness campaign. Optionally, the first query is provided to a first entity using one or more of a telephonic device, an email, a physical mailing and/or a web form.

One or more embodiments provide programmatic code stored on a computer readable medium, that when executed is configured to: store a response to a first query related to a brand in association with an indication that the first query was provided to at least one recipient after a direct marketing campaign was initiated; store a response to a second query related to the brand in association with an indication that the second query was provided to at least one recipient after an awareness campaign was initiated; compare the responses to the first query and the second query; and generate a report indicating the efficacy of the awareness campaign at least partly based on the comparison.

Optionally, the first query and the second query request the same information. Optionally, the code is further configured to store usage information with respect to coupons provided during the direct marketing campaign. Optionally, the code is further configured to store call quantity information with respect to calls placed to a phone number provided via the direct marketing campaign to consumers. Optionally, the code is further configured to store email quantity information with respect to emails received at an email address provided via the direct marketing campaign to consumers. Optionally, the code is further configured to store web page view information for a web page associated with the direct marketing campaign. Optionally, the first query relates to recognition level of the brand. Optionally, the first query relates to how favorably the brand is viewed. Optionally, the code is further configured to generate a report indicating a percentage change in responses with respect to the first query and second query. Optionally, the code is further configured to generate a report indicating the percentage change in responses with respect to the first query and second query for a first identified demographic group and a second identified demographic group. Optionally, the code is further configured to measure efficacy of the awareness campaign using website log data. Optionally, the code is further configured to measure efficacy of the awareness campaign using phone log data. Optionally, the code is further configured to measure efficacy of the awareness campaign using email log data. Optionally, the code is further configured to measure efficacy of the awareness campaign using advertisement broadcast verification data. Optionally, the code is further configured to measure efficacy of the awareness campaign using ratings data. Optionally, the code is further configured to provide the first query to a first entity using one or more of a telephonic device, an email, a physical mailing and/or a web form.

One or more embodiments provide a computer-implemented method for generating a unified advertising spot inventory database based on data existing in different formats stored on different systems, the method comprising: gathering advertising inventory-related data existing in the different systems in different formats; identifying various data elements in the gathered advertising inventory-related data; and at least partly based on the identification, storing the gathered data in a plurality of records in a unified data store using a common set of schema.

Optionally, the method further comprises enabling a computer-based media market place system to access the unified data store. Optionally, the method further comprises: accessing radio inventory data from a first source in a first format; using the common schema to store the radio inventory data in the unified data store; accessing television inventory data from a second source in a second format; and using the common schema to store the television inventory data in the unified data store.

Optionally, the method further comprises: accessing out of home inventory data from a first source in a first format; using the common schema to store the out of home inventory data in the unified data store; and accessing Web advertising inventory data from a second source in a second format; and using the common schema to store the Web advertising inventory data in the unified data store.

Optionally, the method further comprises: accessing data from a first source related to a first media inventory; determining the type of media the first source data is associated with; storing in a first record an indication as to the type of media the first source data is associated with; accessing data from a second source related to a second media inventory; determining the type of media a second source data is associated with, wherein the type of media the second source data is associated with is different than the type of media the first source data is associated with; and storing in a second record an indication as to the type of media the second source data is associated with.

Optionally, the method further comprises: accessing data from a first source related to a first media inventory of a first type; identifying a first date range associated with the first media inventory; storing the first data range in a first record; identifying first days of the week associated with the first media inventory; storing the first days of the week in the first record; accessing data from a second source related to a second media inventory of a second type; identifying a second date range associated with the second media inventory; storing the second data range in a second record; identifying second days of the week associated with the second media inventory; and storing the second days of the week in the second record.

Optionally, the method further comprises: accessing data from a first source related to a first media inventory of a first type; identifying a first market identifier associated with the first media inventory; storing the first market identifier in a first record; accessing data from a second source related to a second media inventory of a second type; identifying a second market identifier associated with the second media inventory; and storing the second market identifier in a second record.

Optionally, the method further comprises: accessing data from a first source related to a first media inventory of a first type; identifying a first station identifier associated with the first media inventory; storing the first station identifier in a first record; accessing data from a second source related to a second media inventory of a second type; identifying a second station identifier associated with the second media inventory; and storing the second market identifier in a second record.

One or more embodiments provide a computerized method for encoding media related data for a plurality of media types from a plurality of data sources. An example method comprises: mapping data from a first source to a first schema using a first map and/or tags; accessing data from the first source related to a first media spot; determining the type of media the first source data is associated with; storing in a first record an indication as to the type of media the first source data is associated with; identifying a time (e.g., date) range associated with the first media spot; storing the data range in the first record; identifying days of the week associated with the first media spot; storing the days of the week in the first record; identifying a market identifier associated with the first media spot; storing the market identifier in the first record; identifying a station identifier associated with the first media spot; storing the station identifier in the first record; identifying a demographic data associated with the first media spot; storing the demographic data in the first record; mapping data from a second source to a second schema using a second map and/or tags; accessing data from the second source related to a second media spot; determining the type of media the second source data is associated with, wherein the type of media the second source data is associated with is different than the type of media the first source data is associated with; storing in a second record an indication as to the type of media the second source data is associated with; identifying a date range associated with the second media spot; storing the data range in the second record; and enabling a computer-based media market place system to access the first record and the second record.

Optionally, the first record and the second record are stored on the same system. Optionally, the first record and the second record are stored in unified database. Optionally, the data from the first source related to the first media spot is in a different format then the data from the second source related to a second media spot. Optionally, the first media spot is a radio advertising spot and the second media spot is a television media spot. Optionally, the method further comprises: identifying a price associated with the first media spot; and storing the price in the first record.

Optionally, the method further comprises: identifying a currency type associated with the price; and storing the currency type in the first record. Optionally, the method further comprises: identifying a spot type associated with the first media spot; and storing an indication as to the spot type in the first record.

One or more embodiments provide a system for integrating advertising inventory data from disparate data stores in disparate sources, comprising: one or more network interfaces coupled to a plurality of disparate data stores, wherein the data stores supply advertising inventory data, wherein different data stores store data related to different types of advertising media in different formats; a module that transforms the inventory data from the data stores into a common format; a data store the stores the transformed advertising inventory data; and an interface that provides access to the transformed advertising inventory data to a computer-based media market place system.

Optionally, the module is configured to transform advertising inventory data for radio spots and television spots into the common format. Optionally, the module is configured to transform inventory data for out of home advertising inventory into the common format. Optionally, the module is configured to map the following data elements to the common format media type; spot type; time period; price; ratings; demographics.

### BRIEF DESCRIPTION OF THE DRAWINGS

Embodiments of the present invention will now be described with reference to the drawings summarized below. These drawings and the associated description are provided to illustrate example embodiments of the invention, and not to limit the scope of the invention.

FIG. 1 illustrates example systems and operating environment.

FIG. 2 illustrates an example content packaging and playback process.

FIGS. 3A-CC illustrate example media markup language elements.

FIG. 4 illustrates a hierarchical relationship of various markup language elements.

FIG. 5 illustrates an example marketplace process.

FIG. 6 illustrates an example auction process.

FIG. 7 illustrates an example make good process.

FIG. 7A illustrates an example media plan object.

FIG. 7B illustrates an example media plan schema.

FIG. 7C illustrates an example media plan class diagram.

FIG. 7D illustrates an example process for performing advertisement inventory transactions.

FIG. 8 illustrates an example audience compositing system.

FIG. 9A illustrates an example media plan transaction process.

FIG. 9B illustrates an example media plan generation process.

FIG. 10 illustrates an example advertising efficacy measurement process.

FIG. 11 illustrates an example learning system.

### DETAILED DESCRIPTION OF PREFERRED EMBODIMENTS

The present invention is related to media, and in particular to methods and systems for performing media searches, the networked distribution of media, and networked transactions related to media and the distribution of media.

Unless otherwise indicated, the functions described herein may be performed by software modules including executable code and instructions running on one or more general-purpose computers. The computers can include one or more central processing units (CPUs) that execute program code and process data, memory, including one or more of volatile memory, such as random access memory (RAM) for temporarily storing data and data structures during program execution, non-volatile memory, such as a hard disc drive, optical drive, or FLASH drive, for storing programs and data, including databases, which may be referred to as a “system database,” and a wired and/or wireless network interface for accessing an intranet and/or Internet.

In addition, the computers can include a display for displaying user interfaces, data, and the like, and one or more user input devices, such as a keyboard, mouse, pointing device, microphone and/or the like, used to navigate, provide commands, enter information, provide search queries, and/or the like. While certain descriptions may refer to a user providing an instruction by clicking on a control, button, or link, instructions can be provided using other techniques, such via a voice command or a gesture provided via an electronic pen or the like. While certain communications are described herein as being provided via an email, other communication mediums can be used as well, such as SMS messages, instant messages, voice messages, tangible documents, and so on.

The systems described herein can also be implemented using special purpose computers, terminals, state machines, and/or hardwired electronic circuits.

The example processes described herein do not necessarily have to be performed in the described sequence, and not all states have to be reached or performed. Still further, while certain example user interfaces are described herein, other user interfaces can be used. By way of example and not limitation, user interfaces, including fewer, more, or different fields can be used with different language, graphics, and menus.

Throughout the following description, the term “Web site” is used to refer to a user-accessible server site that implements basic and/or other World Wide Web standards for the coding and transmission of documents, such as hypertextual documents. These standards currently include HTML (the Hypertext Markup Language), which can be used to generate Web pages, XML, and HTTP (the Hypertext Transfer Protocol). It should be understood that the term “site” or “computer system” are not intended to imply a single geographic location, as a Web or other network site can, for example, include multiple geographically-distributed computer systems that are appropriately linked together. Furthermore, while the following description relates to an embodiment utilizing the Internet and related protocols, other networks, such as a network of interactive televisions, wireless phones, and other protocols, may be used as well. Certain functionality described herein can be provided via a centralized system and/or using buyer (e.g., an advertiser, advertising agency, aggregator, etc.) and/or seller (e.g., a media outlet, an aggregator, etc.) installations and management.

While reference may be made to certain types of advertisements and certain forms of advertisement implementation and distribution, these are provided for illustrative purpose and not to limit the invention. For example, an advertisement may be in the form of a commercial, such as a television commercial (distributed, for example, via terrestrial broadcast, cable, satellite, closed circuit systems, IP transmission, on demand (cable or otherwise), digital video recorder systems, or other forms of distribution), a product placement (e.g., in a movie, television show, or a web movie/show), virtual advertisements or product placements (e.g., an advertisement or product digitally inserted into one or more frames of a television show or sporting event, such as on otherwise blank backdrops or used to replace existing banners or billboards at an event), a radio commercial (terrestrial, short-wave, long-wave, satellite-delivered, delivered over a data network (e.g., an IP network such as the Internet), or delivered through any other mode or method of radio transmission.

By way of further example, an advertisement can be delivered on or through the Internet in any of or any combination of various forms or formats including websites, rich media applications, e-mail, and banner ads; as a print advertisement to be published in, by way of example, any of or any combination of magazines, newspapers, newspaper-delivered-magazines, directory listings and/or direct mail; as an out-of-home advertisement placed in various venues, including, billboards, theaters, cinema, restaurants and bars, elevators, transit systems, skywriting, subway platforms, or on consumer items, such as cereal boxes, supermarket bags, stickers on food, and other spaces for placement of out-of-home or in-home advertisements.

While reference may be made to a video commercial or video content, other types of content can be used as well, such as animation and other content provided, by way of example and not limitation, via FLASH, Silverlight, and/or JavaFX files. While the terms video files or video content may be used herein, it is understood that video files or video content can optionally include audio data as well. The video files are optionally in digital format (e.g. vector-based content, MPEG or other digital format).

Certain embodiments enable a user to search for a type of non-personalized, “generic”, advertising content, such as a non-personalized television spot (or Internet spot, movie spot, etc.) oriented towards a business, profession or service. The system will display a selection of potential spots from which the user can choose. User interfaces are provided via which the spot may personalized (e.g., by adding overlay text, text scripts for voice-overs), and addition information provided, such as some or all of the following: contact information, website URLs, pronunciation suggestions, comments, etc. The user may preview the personalized advertisement and accept, reject, or further modify. The personalized spot may optionally be used in advertisement slots purchased using one or more of the systems and methods described herein.

Certain embodiments refer to the use of demographics in specifying a desired target audience and in generating a media plan. In addition or instead, psychographic factors (e.g., lifestyle or interest choices) are utilized in specifying a desired target audience and in generating a media plan.

Discussed herein is the automated and/or partly automated generation of media plans. A media plan may include some or all of the following: a list of television stations and/or programs, dates the advertisement(s) are scheduled to run, the part of the day during which the advertisement(s) will run (also referred to as a daypart), rate per ad, the market in which the advertisement(s) will run, the type of schedule, the number of airings, and/or total cost for each portion of the media plan and/or for all portions of the media plan. A media plan optionally includes multiple types of media (e.g., TV, radio, print, online, out of house, etc.).

Embodiments described herein may optionally be used in conjunction with methods and systems described in copending U.S. patent application Ser. No. 11/467,085, entitled “Systems and Methods For Media Planning, Advertisement Production, and Advertisement Placement,” incorporated herein by reference in its entirety.

Embodiments may include application to advertising (broadcast/cable/satellite/Internet/phone network/streaming television, radio, website, etc.) sold by stations, services or third parties within a DMA as syndicated national programming (similar to national broadcast TV), spot market programming (similar to spot market broadcast TV), and/or otherwise. Embodiments may be applied in syndicated programming sold locally and/or nationally, or spot market programming (e.g., sold in a local market). Embodiments may be applied to advertising purchased via individual stations or through an entity that sells multiple stations, and to advertising that is purchased based on day of week and/or daypart, and/or based on specific programming, in any combination.

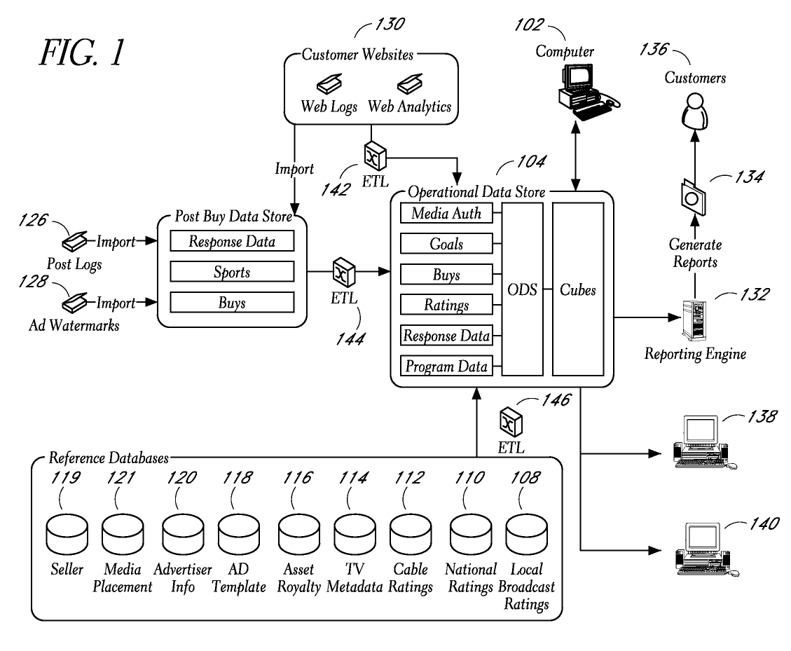

Referring now to FIG. 1, example systems and operating environment are illustrated. The illustrated media and advertisement system 102 and associated databases are configured (e.g., via software) to provide services, execute processes, and provide user interfaces described herein. Functions described as being performed by multiple systems can optionally be performed by fewer systems, and functions described as being performed by a given system can be performed by different and/or additional systems.

In this example embodiment, the system 102 is a computer system (e.g., a general purpose computer system) which hosts and executes programs including some or all of the following and/or other programs:

content packaging and playback enabling software;

extracting, transformation, and loading software, optionally including schema used to map data from disparate sources into a unified database;

audience compositing software;

reporting software configured to report data and data analysis (e.g., advertising efficacy measurements, ratings data, trends, etc.);

media marketplace engine software;

media plan generation software;

web server software (providing user interfaces, optionally over a network, for displaying data and for displaying forms and/or other interfaces for receiving data/commands).

The system 102 communicates (e.g., over a local network and/or a wide area network, such as the Internet) with a variety of other systems and data stores, including an operational data store 104 (ODS), a post buy data store 124, reference databases 106, and user/client terminals and computer systems.

The ODS 104 includes Online Analytical Processing (OLAP) cubes (that respond to queries using aggregations/view selections). Other databases/data structures can be used as well (e.g., relational databases).

The ODS data store 104 is coupled to one or more systems, such as a website 130 hosted by web servers associated with a customer (e.g., advertiser or other buyer of advertisement spots), the post buy data store 124 (e.g., which stores station post logs and watermark data), and reference data stores 106.

Data is transferred from and/or to the various data stores 104, 124, 106 using ETL (extract, transform, load) processes 142, 144, 146, which extract data from a data source (e.g., from a relational database, a flat file, free form data, an IMS data structure, a VSAM data structure, an XML publication, etc.), transform the extracted data as needed (e.g., select only a subset of data to be loaded, translate coded values, encode free-form values, calculate a value from the extracted data, join data from multiple sources, etc.), and load the data into a data store. For example, an ETL process is optionally utilized to transfer data with respect to the post buy data store 124 or the operational data store 104. The ETL process optionally utilizes a media marketplace markup language to perform transformation, described in greater detail elsewhere herein. Optionally, the ETL process is automatically performed periodically (e.g., one an hour, once every 12 hours, daily, or other regular or irregular interval) and/or is manually initiated.

As will be described in greater detail below, the system 102 captures data from web logs (e.g., providing data relating to how many times and when a Web page is requested; what incoming link a visitor followed to arrive at the web site; what search terms a visitor used at a search engine before arriving at the web site, etc.) and analytic stores of website 130. The system uses the captured data to build a historical trend and serve as a baseline for eventual comparison post campaign. For example, the system can determine whether an item of interest (e.g., a piece of content) is increasing in popularity, decreasing in popularity, or is staying substantially flat in popularity based on the number of requests for the content (e.g., Web page requests), and/or related communications (e.g., phone, email, or tangible mail communications directed to an address associated with the content, or mentions of the media in blogs, news articles, etc.) within a specified period or moment of time. In addition, the system can measure the rate of change (e.g., in popularity) from the captured data. The system can utilize such analysis to estimate the future desirability and/or value of the item of interest at a given point in time or range of times.

The post buy data store 124 stores data received from phone logs (e.g., in contexts where the marketing effort includes a call to action via a tracked phone number) that indicate how many calls were received at one or more tracked phone numbers from viewers/targets of a media campaign, email logs that indicate how many emails were received at one or more email addresses from viewers/targets of a media campaign, media schedule post logs 126, broadcast station affidavits of performance (e.g., submitted via an electronic form, stored via an OCR process from a physical document, or otherwise), watermark/fingerprint logs 128 (e.g., providing broadcast verification of spots, such as commercials), and/or other post buy data (including other data that provides ratings data with confirmation of commercial airings). Such data enables advertisers to monitor whether or not their advertisements are reaching target audiences and running in accordance with the advertisers' directions/contract.

A reporting engine 132 (which is optionally hosted by system 102) generates one or more types of reports 134 based on data accessed from data stores (e.g., data stores 124, 104, 106) and analysis of data accessed from the data stores. For example, the reports can provide broadcast verification information, goal achievement metrics, ratings information, trending data, campaign efficacy measurement data, etc. The reports can then be electronically and/or physically transmitted to one or more destinations 136.

Advertisements can be transmitted to broadcast systems 128 and/or directly to audiences 140 (e.g., via television, computer terminal, phone, etc.).

Other databases included in or accessible by the system 102 can include some or all of the following:

Local broadcast rating databases 108 (e.g., viewership information broken down by some or all of the following: demographics (age, gender, household size, income, address/zip code, etc.), daypart (optionally down to an hour, minute, second, or other time period), program, etc.);

national broadcast rating databases 110 (optionally with similar types of data as that stored in databases 108);

cable ratings databases 112 (optionally with similar types of data as that stored in databases 108;

television metadata database 114 (e.g., data that determines the rules and constraints for the advertisement(s) to be displayed);

asset royalty database 116 (e.g., royalties or rules for calculating royalties for content used in media sequences based on usage or otherwise, where the system 102 uses information 116 to calculate royalties);

advertisement template database 118 (storing customizable templates which an advertiser can edit/customize to include the advertiser's name, product name, other text, voice over reading a script provided by or on behalf of advertiser, music, logos, images, video clips, video objects, audio objects, image objects, text objects, etc.);

advertisement information/media buying rules databases 120 (e.g., storing information regarding the Multiple System Operators (MSOs) in Designated Market Areas (DMAs) (e.g., identifying a geographic area (e.g., of counties) in which the home market television stations hold a dominance of total hours viewed), Regions, Zones and/or Head Ends (e.g., a facility local to subscriber that originates/relays and communicates television and/or Internet services, such as cable television), including ratings information (e.g., Nielsen ratings) for one or more channels within various demographic categories (e.g., by age groups, gender, households, etc.), and rate cards specifying tiers of channels offered by the MSO and the costs for running ads on those channels during various part of the day (time slots) for the channels);

media placement databases 121 (storing information on showings of advertisement, such as the measurement of the quantity/timing/placement of showings);

seller databases 119 (storing seller account data, optionally including an indication from the seller as to whether the system is or is not authorized to complete a sales transaction on behalf of the seller).

The ODS 104 can access and store data relating to media authorizations, goals (e.g., a selection of day and daypart targets specific audiences defined by demographic (e.g., age, gender, etc.) and/or psychographic variables (e.g., lifestyle or interest choices) which the advertiser would like to reach), buys, ratings, response data, program data, and/or additional or different data.

The system can generate media plans based on some or all of the information stored in the various data stores. For example the media plan may provide a plan for placing advertisements that target certain demographics, based on industry selections, specified media types (e.g., television, radio, print, online, out of house, etc.), and/or direct selection of target demographics by the advertiser as well as plan objective, duration and/or budget information (e.g., total campaign budget, daily budget, weekly budget, monthly budget) provided by the advertiser.

The advertisements and plans utilize the respective media and distribution mechanisms described herein, such as television, radio, Internet, print, out-of-home, etc. Optionally, the system tracks inventory in respective different media separately and uses the information regarding the respective media in revising and enhancing the media plan to increase performance and to better reach (or exceed) the advertisers goals.

For example, the system optionally compares possible/predicted performance in different respective media for the respective target market of the advertiser and generates a media plan that uses media (e.g., a single type of media or multiple media types) that perform better for the respective target market.

An example media plan includes, some or all of the following: a list of stations (television and/or radio stations), publications, venues, Internet modes of advertisement, dates the advertisement will run, the part of the day during which the advertisement will run (e.g., for television, radio spots), the rate per advertisement showing/airing, the market in which the advertisement will run, the type of schedule (e.g., run of schedule or fixed), the number of airings, the physical location (for media displayed via billboard and other physical displays), the number of transit vehicles (for advertisements being displayed on transit vehicles), and the total cost for each portion of the media plan, as appropriate for the respective media.

By way of further example, a plan for out-of-home media advertisements (that reaches the consumer while the consumer is outside the home, such as via billboards, bus stop benches or other street furniture, transit, such as buses, cars, taxis) includes some or all of the following information: venues, dates the ads will run, rate per advertisement per venue, the market in which the advertisement will run, and total cost for each portion of the media plan.

Example systems and methods for enabling a content owner to dynamically control/specify the use of advertisements with digital video will be described.

A significant challenge content creators (e.g., such as creators/owners of advertising content, including some or all of the following: video, music, other audio, photographs, artwork, text, etc.) face is how to enable others to use their content, so that the creator/owner can monetize their content while still maintaining a reasonable amount of control over the content (e.g., an advertisement) served over the lifespan of that digital video's distribution, whether online of offline.

Using certain conventional techniques, the advertisement shown during a digital video playback session on a web site is selected by the web site publisher which is serving the video stream or is included into the video stream itself at encoding time. This approach limits content owners ability establish business relationships to monetize their digital video content dynamically, (e.g., not only vary it based on which sites are distributing the video, but also vary the advertisements based on who's watching them, while maintaining control over which are appropriate for their content). Certain conventional techniques merely provide control through filters offered by publishing web sites or online video networks. In such cases, the content owner may need to set those rules and constraints each time, on each site, wherein the different sites offer different rule sets and interfaces for doing so.

Certain embodiments described herein enable content owners (e.g., studios, artists, TV networks, etc.) to establish (e.g., prior to distributing their digital video files), which advertising entity(ies) (site or collection of sites) will handle the serving of advertisements during playback of their particular digital video stream via the Internet or other network. Thus, content owners, can establish commercial terms and relationships for content utilization and/or for monetizing their content ahead of time, according to content owner specified rules, and can inhibit/constrain the use of their content (e.g., by inhibiting content user with inappropriate advertisements or on inappropriate sites, such as those that do not comply with the content owner rules). Further, content owners can restrict sales of advertisements for their content to partners or other entities selected by the content owner, rather than simply having a web site publishing the content (e.g., videos, music, images, etc.) select the advertisement without the content owners control.

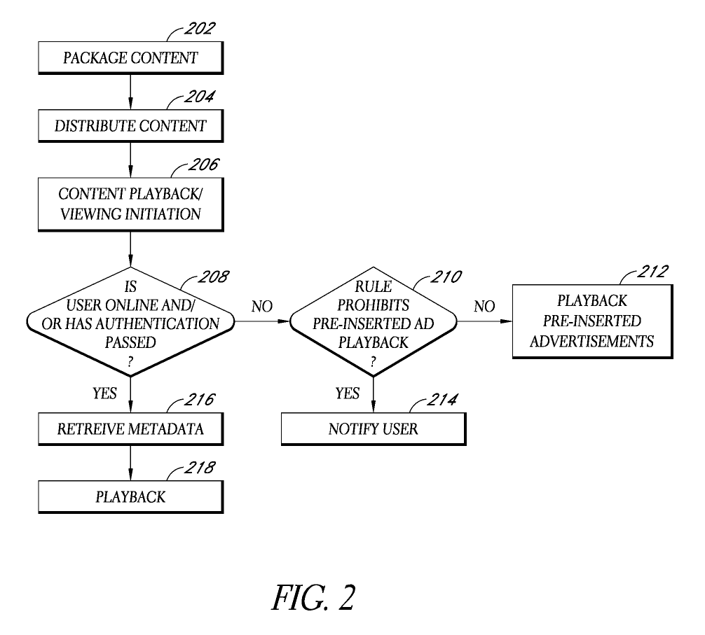

With reference to FIG. 2, an example content packaging and playback process is illustrated. However, fewer, additional, or different states can be used as well.

At state 202, content packaging is performed. The content packaging may be performed by the content owner on a content owner computer system 138 and/or other authorized entity via other computer system/packaging system. Optionally, the content packaging is performed via system 102, host 130, or otherwise.

For example, when the digital content (e.g., audio video content) is ready for distribution (e.g., over the Internet via a website), the file is “stamped” with the address or locator (e.g., a Universal Resource Locator (URL)) of the advertising service(s) which serves the advertisement(s) for that particular video. Optionally, the address is a re-direction service, which decides in real time or substantially real time which service (e.g., from a pre-specified set of services) will actually serve the advertisement(s).

Optionally, the process may insert a “default” advertisement or collection of advertisements that had previously been downloaded or otherwise stored on a user playback device (e.g., a personal computer, a mobile phone, a smartphone (e.g., on which third party applications can be installed), an interactive television, other networked device coupled to a display, etc.) to be played back in the event that the playback device is offline (with no connectivity to the advertisement serving site(s) when an advertisement would otherwise be served and streamed or otherwise provided for display to the user playback device).

Optionally, hashing and/or encryption techniques (or other digital rights management techniques) are utilized to protect metadata (e.g., data that determines the rules and constraints for the advertisement(s) to be displayed) injected by the content owner. Further, the use of a security token is optionally employed to ensure proper authentication between the video player and the various servers, services, sites that will be authorized by the content owner to serve advertisements for that particular file. The metadata injected into the stream may itself be hashed and/or encrypted. By way of example, a public-private key system may be used wherein the player may hold the public key and the server may hold the private key. The hashing function may be used to produce a large checksum value for the content file. The checksum value is then encrypted using the private key. The player can unlock the file and play the content using the public key.

At state 204, content distribution is performed. By way of example, content in the form of digital files (e.g., digital video/image (e.g., MPEG or vector-based content files) can be distributed (e.g., using a server or other distribution system or apparatus) via one or more web sites (e.g., hosted by a web server, such as host 130 or via system 102), via a cable provider, via satellite, via a telephone network, or offline, via DVDs, CDs, solid state memory, magnetic memory, etc.

Optionally, the content can delivered to and stored in users' digital video recorders (e.g., local or remote from the user, such as on a geographically local or remote server) or set-top boxes for later playback. By way of further example, content can be stored on, or otherwise accessed via a user terminal that includes playback functionality.

At state 206, a content playback/viewing initiation process occurs. For example, at playback time, a player, such as a digital video player hosted on, or otherwise accessed via a user terminal (e.g., a personal computer, a mobile phone, a smartphone, an interactive television, etc.) which is configured to read the meta data and render content packaged as described herein, performs some or all of the following acts:

At state 208, the process determines if the user is online (e.g., communicating with the Internet or other appropriate network) or offline. If the user is online, the process proceeds to state 216.

If the user is offline, at state 210 a determination is made (e.g., based on an instruction of the content owner or other corresponding authorized entity, such as an agent of the owner) as to whether playback of the content is prohibited during an offline state. If such a prohibition is present, the player is inhibited from playing the content (e.g., the digital video file). At state 214, the player then optionally displays a message to the user at state indicating the user terminal/playback device needs to be online to view the video or other specified content.

If there is no such offline playback prohibition, and if the user is offline, at state 212 the media player plays one or more still/video/animated advertisement(s) pre-inserted into the digital video file during the content packaging process. These advertisements can take many different forms and can be rendered/displayed at one or more points during the video playback. For example, one or more advertisements may be displayed to the user pre-roll (prior to the original video content), post-roll (at the end of the original video content), mid-roll (sometime between the beginning and the end of the original video content), overlaid, using curtains, or any combination thereof, and/or including other methods, such as pop-ups, animations outside the player frame, in a banner, etc. Optionally, the advertisement is hotspotted (where an element of the video advertisement is programmed to be clickable so that an action can be taken in response to the user clicking on the hotspot).

If the user playback device is online, at state 216, the metadata (inserted by the content owner during the content packaging, and which determines the rules and constraints for the advertisement(s) to be displayed) is retrieved from the digital video stream. The content is played back per the metadata at state 218. For example, the metadata can instruct the player that:

i. Pre-roll advertisement(s) are (or are not) to be displayed

ii. Mid-roll advertisement(s) are (or are not) to be displayed

iii. Post-roll advertisement(s) to be displayed

iv. Overlay advertisement(s) are (or are not) to be displayed—e.g., continuous ticker at the bottom of the screen, ¼, half the screen, ⅔, ¾, logo, pop-up, shrink-and-expand the video in frame to make room for the ad, etc.

v. The length/relative length of the original content (e.g., the original content is to be at least twice as long as the advertisement, etc.)

vi. Etc.

In certain optional embodiments, the advertisement includes an address or locator, such as a Universal Resource Locator (URL) address, where the user would be taken to via their playback device or browser (wherein the browser may be hosted on the playback device) if the user clicked on or otherwise selected the advertisement during its display. Optionally, this address is the same as for the advertisement itself, where the site serving the advertisement would then record the “click-through” event and send the user to the appropriate web site (e.g., a merchant website associated with/sponsoring the advertisement), channel (e.g., a network television channel running shows), etc.

For an advertisement (e.g., associated with a product of someone other than the content owner) to be displayed after the video started playing (e.g., a non pre-roll ad), the player optionally retrieves the metadata needed from the video stream while the player decodes it and renders it to the screen. For example, the needed data is optionally distributed throughout or at spaced apart portions of the video stream, and not necessarily only at the beginning of the video file.

For an address inserted into the metadata during the content packaging process, the site/service handling the request can be an aggregator, which determines which site/server will actually return the advertisement and redirects the video player to retrieve the advertisement from that site/server.

For some or all of the communications between the video player and the various servers/services/sites serving original and/or advertising content an optional security measure may be utilized, whereby a hand-shake between the video player application and a given server will ensure they are “trustworthy” and can exchange data securely (e.g., to thereby protect the integrity of a message, and to validate the identity of the video player and server).

This authentication can take many forms, including, by way of example and not limitation, use of message authentication codes, hashing and/or encryption techniques (e.g., using public/private keys) to secure the metadata (the advertisements themselves, the addresses for the ads, etc.) and user data (including, for example, subscription passwords) during transmission, and also for authenticating the response from the advertisement serving site(s).

As similarly discussed above with respect to states 210, 212, 214, in the event that the site fails to respond appropriately given with respect to an optional security measure(s) being utilized (e.g., at state 208), the player is optionally configured to:

1. Playback one or more pre-packaged advertisement(s) (e.g., video advertisements or static advertisements) included with the video itself (if any);

2. Playback one or more advertisement(s) previously downloaded to the player host system (if any); or

3. Refuse to playback the content and display an error message to the user.

Thus, content owners can establish content owner specified rules which inhibits the use of their content with inappropriate or undesirable advertisements or on inappropriate sites.

Methods and systems for performing media transactions (e.g., online) will now be described with respect to a media marketplace engine. To participate in a media marketplace, buyers describe (e.g., via an electronic user interface) their needs in terms of marketing goals and intent or other specifications. Media inventory (e.g., commercials, billboards, online advertisement placement, print ads, etc.) using media products (e.g., video media, music media, photographs, graphics, text, etc.) may be presented a priori by vendors, may be presented in real-time, may be presented as a direct response to a buyer's needs, or may be presented on behalf of the seller based on a prediction of the sellers' response. The marketplace system matches a buyer's goals with media inventory and media products which may satisfy some or all of those goals (e.g., based on inventory data, programming data, target demographic data, etc.).

Optionally, the system provides marketplace inventory integration (e.g., wherein the system has access, real-time and/or scheduled, to one or more seller databases that provide slot of availability by time and/or show and rates for the same).

An example embodiment of a marketplace engine enables buyers (e.g., advertisement agencies, product/service providers that desire to advertise a product, etc.) and sellers (e.g., an online media entity, a media network, such as CBS, a cable operator, a print publisher, an owner/marketer of out of home advertising sites, etc) of various types of media inventory (e.g., television advertisement slots, radio advertisement slots, print advertisements) to perform transactions using a web interface.

An example typical transaction involves a buyer placing orders on behalf of themselves (if they are end users) or their client (e.g., an advertiser, such as a car company, an electronics company, a retail establishment, etc.), to which sellers can respond and fulfill those orders. Optionally, the marketplace engine arbitrates (if needed or appropriate) this process by negotiating (automatically via a computer-based system and/or manually) with various sellers on behalf of buyers (or visa versa) and matching the negotiated inventory per buyer's goals/specifications. If a seller has an inventory database accessible by the market place engine (in real-time or otherwise), then optionally the orders are matched and fulfilled automatically. Once a transaction in completed, the system generates a confirmation message to the seller and/or buyer indicating that inventory is reserved and confirmed to buyer.

An example embodiment includes solver software that performs/identifies inventory allocation with an optimum/enhanced allocation obtained for buyer goals and/or seller goals. The solver is optionally configured to solve for multiple buyers per seller, a single buyer per seller, and/or multiple buyers and sellers.

Example embodiments enable sellers to manage avail responses/rate cards (e.g. programming information for the buyer's goals and their rates and ratings etc.). Optionally, the system also uses existing avail responses that match the goals from the buyer.

Optionally, the system provides one or more user interfaces (e.g., forms) via which a seller (which can be an aggregator) can create one or more proposals. For example, a form is provided via which a seller can specify some or all of the following: rates, dates/times, guaranteed viewership/ratings, viewership demographics, etc. Optionally, the system can automatically generate a seller proposal based on a buyer inquiry and seller inventory, thereby further automating the process of responding to buyer inquiries/offers.

Optionally, a user interface is provided by which a seller (which can be an aggregator) can manage and specify media packages (e.g. a set of media inventory to be sold as a unit). For example, the user interface can include fields via which the seller can specify the media included in the package and optionally the associated rate. By way of further example, optionally, a user interface is provided by which a seller (which can be an aggregator) can manage and specify clusters (e.g. a set of media inventory across networks to be sold as a unit).

Optionally, a user interface is provided by which a seller can specify buyer preferences. For example, the user interface optionally includes fields via which the seller can specify that buys from certain industry-types (e.g., using a menu listing industry types or by typing in an industry code or industry name) or that specific buyers will not be accepted (e.g., by entering or selecting a buyer name), that buys from certain industry-types or specific buyers are to be given a lower preference in terms of providing an offer to the buyer, that buys from certain industry-types or specific buyers will be accepted, that buys from certain industry-types or specific buyers are to be given a higher preference in terms of providing an offer to the buyer, etc. Optionally, fields are provided via which the seller can specify certain inventory discounts or premiums for buys from certain industry-types or specific buyers, or for certain volume of buys.

Certain embodiments facilitate negotiations between buyers and sellers. For example, certain embodiments optionally automatically and/or with manual intervention match and negotiate avail response/proposals to inventory. Optionally, certain embodiments optionally automatically and/or with manual intervention match and negotiate pre-made packages (e.g., the may include some slots on highly rated or desirable television programs/channels and some lots on lower rated or less desirable television programs/channels).

Certain embodiments provide buyer worksheets, including work sheets for spots negotiation, ratings and projections, historical trending and analysis, etc.

In addition, the system optionally provides marketplace inventory reverse transaction integration, wherein sold inventory is automatically or manually updated back into seller systems by communicating to the seller system what inventory has been sold to buyers/advertisers so that the seller knows that the inventory has been sold, and to prevent/inhibit the reselling of inventory.

Once a buyer offer has been accepted, a post-acceptance process is performed. For example, the post acceptance process can include a trafficking process, wherein campaigns are scheduled for delivery according to the clients' needs, specifications, and/or requirements and the schedule is fulfilled. The system transmits or facilitates the communication regarding trafficking status and fulfillment. For example, some or all of the following information is collected and reported: what commercials were broadcast, when they were broadcast, on what programs they where broadcast, what were the ratings, what were the rating demographics.

One or more embodiments provide make goods management to compensate for under-delivery. For example, once the commercials have been run and/or the time period for running the commercials has transpired, the ratings (e.g., in the form of ratings points, wherein a point is equal to 1% of a population or universe of the programs in which commercials were inserted, or otherwise) are examined to determine if the programs delivered the obligated/guaranteed ratings. If the actual program ratings are lower or significantly lower (e.g., lower than a specified amount or by a specified amount) than what was obligated/guaranteed, then the system, automatically or with human intervention, arranges or facilitates a “make good” for the difference in ratings by running additional advertisements/commercials, optionally without charge.

For example, the seller (or other party responsible for the make good) can designate certain inventory as being eligible to be used for a make good and other inventory as not being eligible to be used for a make good (e.g., a seller may designate the most desirable inventory as not being available for use as a “make good”). Based on such designation (e.g., stored in a seller and/or system data store, such as a programming database), the system can automatically and/or via human intervention identify such inventory eligible to be used for a make good, filter out such channels/programs/spots as do not comply with the buyer rules/specifications, identify those channels/programs/spots that do comply with the buyer rules/specifications, and determine which of such programs and/how many spots are needed to makeup for the rating shortfall. Thus, optionally, the system automatically determines make goods and reallocates inventory on behalf of buyer and seller.

The system is optionally integrated with buyer and/or seller systems to provide reporting (optionally using dashboards, image files, PDF files, word processing files, etc.) on buys, sales, fulfillment, make goods, to access program information, and spot content, as well as to provide workflow management and traffic logs management. By way of example, integration is optionally provided with respect to the Donovan Data Systems system (which provides inventory management) and/or the Media Ocean system (which sends electronic orders and revisions to update a traffic database) and/or others.

Additionally, the system optionally provides invoice and payment management. For example, as similarly discussed above, the system optionally obtains (e.g., from the seller database or other database) information on the ratings of the programs in which commercials were inserted (“as runs”), and based on the as runs and the buy terms (stored in computer readable memory), performs/facilitates invoice reconciliation and settlement (e.g., where the buyer's payment is dependent on the agreed upon rate and as run information). The example system supports one or more formats (e.g., American Association of Advertising Agencies (AAAA) Format).

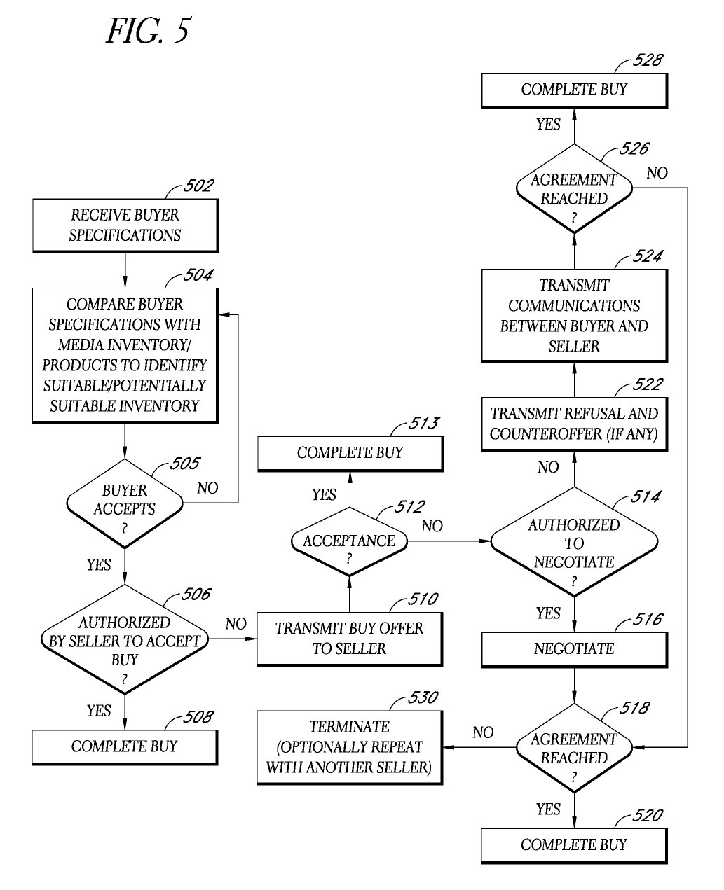

FIG. 5 illustrates an example marketplace process. At state 502, the system 102 receives buyer specifications (e.g., desired demographics, industry identification, tier mix, plan objective, duration and/or budget specifications, media types, etc., as described above). In an example embodiment, the buyer can specify:
One or more media types (e.g., TV, radio, print, online, etc.);
One or more inventory types (e.g., commercials, radio advertisements print ads, online ads, etc.);
One or more media products (e.g., video (optionally including audio track), audio only, photograph/graphic only, text only, etc.);
One or more buy guidelines (e.g., trp goals, network preferences (e.g., specific networks, cable, over-the-air, web-based, etc.);
Buy by Avail Request/Response/Rate Card (e.g., where the buyer can send goals as an avail request to various sellers and receives inventory responses including rates, ratings, etc.);
Daypart (e.g., where the buyer can specify a preferred or required date(s), day(s) of the week, and/or time(s));
Cluster or Package (e.g., where a cluster designates a list of networks and a number of advertisements or spots to place on these networks);
Programming (e.g., specify show(s)/series/event(s));
Keyword (e.g., specify a keyword (related to a product, good, or service being advertised) used to identify programs or channels associated with the keyword, and hence the product, good, service being advertised; for example, the keyword might be “wedding” if engagement rings are being advertised, “cooking” if kitchen equipment is being advertised, “vacation” if a hotel is being advertised, etc.; the program/station association with a keyword may be provided by the channel operator, program creator/distributor, system operator, other third party, via integration with a programming schedule database that provides information regarding shows and/or particular episodes, such as a summary of an episode (e.g., Tribune Media Services TV Listings)).

By way of example, the specifications can be received over a network via a web page form, via phone, via a physical document, or otherwise. The specifications can then be stored in a database (e.g., database 120). By way of example, the buyer specifies a duration (optionally by objective), a tier mix (e.g., wherein different tiers correspond to programming/networks of different desirability and/or expense (a first percentage to be shown on tier 1 programming; a second percentage to be shown on tier 2 programming; a third percentage to be shown on tier 3 programming)), a daypart mix (e.g., a first percentage to be shown in the morning, a second percentage to be shown in the afternoon, a third percentage to be shown in the evening, a fourth percentage to be shown at night), number of desired spots per specified period (e.g., hour, day, wee, month), buyer rules (e.g., specified programs, specified genre of programs, programs having a specified actor, specified station), that are not to be included in the media plan. Optionally, the buyer can specify different weightings/relative importance for different specification elements.

Optionally, a buyer can also browse for appropriate programming, inventory, etc. by performing a search (e.g., by using a search query specifying one or more terms discussed above with respect to a buyer specification, such as by entering queries related to channels, programs (e.g., name, genre, actor, etc.), tiers, dayparts, ratings, keywords, etc.). The system optionally hosts a search engine which performs the search and returns appropriate search results, optionally ordered based on relevancy (e.g., based on how many terms in the search query are satisfied and/or based on a confidence level as to the relevancy of the search results).

At state 504, the system compares (e.g., automatically and/or with human decision making) the buyer specifications with media inventory. For example comparisons may be performed using some or all of the following: rate card data (e.g., specifying requested/maximum requested advertisement placement rates (e.g., CPM), channel tiers, etc.), programming data from a programming schedule database, spot availability data, scheduling information, tier rating, media packages, clusters, etc., to identify suitable inventory. A media plan is then generated based on the comparisons. Optionally, a plurality of media plans are generated from which the buyer can accept, optionally including different inventory mixes (e.g., including inventory from one or more sellers).

Optionally, as similarly discussed above, the buyer database can store one or more rules specifying certain conditions where a buyer offer is not to be accepted, even if the seller financial conditions are met. For example, the seller can list certain buyers or class of buyers (e.g., advertisers of salacious materials or products) from which offers are not to be accepted. The system can optionally exclude inventory from the media plan if they buyer would not be eligible to purchase such inventory based on the seller rules.

At state 505, a determination is made as to whether the buyer accepted a media plan. If the buyer did not accept a media plan, the process proceeds back to state 504, and the system generates another media plan using a different combination of inventory.

If the buyer did accept a plan, the process proceeds to state 506. Seller account information for the seller(s) whose inventory is the media plan is accessed from the seller database to determine whether the seller has authorized the system to accept buyer orders/offers on behalf of the seller based on seller specified conditions. Optionally such acceptance is tentative, where the buyer can withdraw the acceptance based on certain, limited conditions, such as the buyer having a certain creditworthiness.

If the seller has authorized the system to accept an offer, than the process proceeds to state 508, and the transaction is completed (or provisionally completed). The transaction completion can include the sending of communications (e.g., electronically, physically, etc.) to the buyer and/or seller confirming the transaction, and optionally the updating of the seller and/or buyer databases. Optionally, payment is processed by the system (e.g., by charging a credit card, debiting an account or otherwise).

If the system is not authorized to automatically accept the buyer order, the process proceeds from state 506 to state 510, and the buyer order is transmitted to the seller (e.g., via email, a web page, human or automated phone call, physical mail, or otherwise). At state 512, the system receives an indication from the seller (e.g., via email, a web page, human or automated phone call, physical mail, or otherwise) as to whether the order is accepted, and optionally, whether the seller is making a counteroffer. If the order is accepted, the process proceeds to state 513, and the transaction is completed (or provisionally completed) as similarly discussed above.

If, at state 512, the seller indicates that the order is not accepted, the process proceeds to state 514. Seller account information is accessed from the seller database to determine whether the seller has authorized the system to accept negotiate on behalf of the seller (e.g., based on a seller counteroffer specifying a range or prices, products that the system is authorized to offer). If the seller has authorized the system to negotiate (where the phrase system includes the system operator in this context) on behalf of the seller, the process proceeds to state 516 and negotiations between the system and buyer take place (where the system negotiations can be automated in whole or in part, or can be performed manually by humans). At state 518, a determination is made as to whether agreement with the buyer has been reached. If agreement has been reached, the process proceeds to state 520 and the transaction is completed (or provisionally completed) as similarly discussed above. If agreement has not been reached, the process proceeds to state 530 and the transaction negotiations are terminated. Optionally, the process is repeated with a different seller and/or the same seller, but a different inventory mix.

At state 522, the system transmits the seller refusal and/or counter offer to the buyer. At state 524, the system transmits additional communications between the buyer and seller (e.g., acceptance of counteroffer, rejection of counteroffer, a new offer, etc.). At state 526, a determination is made as to whether agreement between the buyer and seller has been reached (e.g., via a communication provided by the buyer, seller, and/or both). If agreement has been reached, the process proceeds to state 528 and the transaction is completed (or provisionally completed) as similarly discussed above. If agreement has not been reached, the process proceeds to state 530 and the transaction negotiations are terminated as similarly discussed above.

While the foregoing example process refers to a seller, optionally multiple sellers whose inventory is in the media plan can likewise be included. Further, the buyer's offer can optionally be made contingent on all or a specified subset of the sellers accepting the buyers offer. For example, a user interface is optionally provided in association with the media plan wherein the buyer can specify which items of inventory must remain in the media plan in order for the offer to be good. Optionally a buyer and/or seller can specify via a user interface a date and/or elapsed time (e.g., via a date or elapsed time field) that an offer or acceptance is good for, after which it lapses.

Buyers and sellers can also place bids on inventory in a live marketplace and buy orders based on an auction engine mechanism (e.g., depending on the auction engine rules, where the highest bidder “wins” the inventory, and where ties are broken based on who submitted the bid first). Additionally, pre-made packages or clusters of inventory are optionally defined by sellers. Buyers can bid on and buy such inventory (e.g., directly as a group) from the marketplace.

Thus, optionally, a combination of bidding and negotiation can be used to set prices for campaign aspects, such as reach (e.g., with respect to television and radio, the unduplicated number of individuals or households exposed to an advertising medium at least once during the average week for a reported time period; with respect to the Internet, the percentage of users in a specified area (e.g., the United States) that have accessed the Web content of a specific site or property) and rating.

The auction process enables live buying and selling of orders by one or more buyers and one or more sellers, optionally in a many-to-many relationship (e.g., in a commodities-style market place where asks and bids are matched, and when a match is found the transaction is completed). For example, the auction can be buyer-centric (wherein the buyer places a buyer proposal up for bid, and wherein in sellers can bid to accept the proposal), seller centric (wherein the seller places a seller proposal/package of inventory up for bid, and wherein in buyers can bid to accept the seller proposal/package) or market centric.

Optionally, the auction is in the form of a combinatorial auction with the goal of satisfying one more buyer goals, while enhancing or maximizing seller revenue, and while meeting a combination of buyer preferences for multiple inventories.

Such an approach offers many advantages over conventional systems that fail to adequately provide a unified support engine for the electronic buying and selling of advertisement across multiple media types.

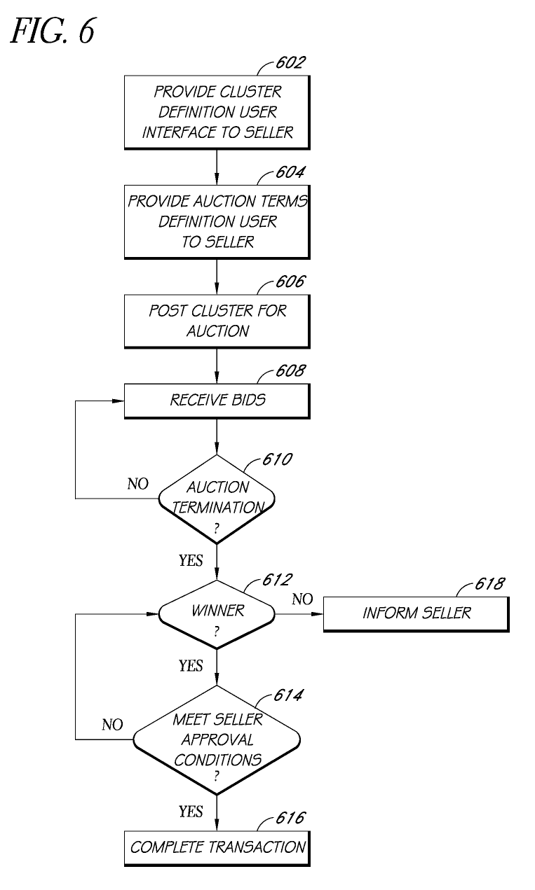

FIG. 6 illustrates an example buyer-centric auction process. At state 602, a user interface is provided to a seller (e.g., via a web page form, via phone, via a physical document, or otherwise) via which the seller can specify one or more clusters to be auctioned. For example, a form can include multiple fields via which the seller can add spot slots associated with multiple programs. By way of further example, a cluster may include inventory of multiple types of media (e.g., television, radio, print publications, out of home inventory, etc.), and characteristics associated therewith (spot lengths, times, frequency, network, etc.). The seller can also insert a cost per spot (e.g., cost per 30 second spot, per 60 second spot, CPM etc.). The cluster data is received over a network from the seller terminal, and then stored by the system in a data store.

At state 604, a user interface is provided via which a seller can set up an auction for the cluster. For example, fields may be provided in a web-based form (or physical paper form) via which the seller can specify a reserve price, a minimum bid price, a minimum bid increment, an auction start time, an auction end time and/or auction end condition (e.g., if no bids have been received for a specified period of time) for the cluster. The auction setup data is received over a network from the seller terminal, and then stored by the system in a data store.

At state 606, the cluster is posted (e.g., on a website) for auction in accordance with the seller setup instructions. At state 608, a user interface is provided (e.g., as a web page over a network to buyer terminals, or other form) via which buyers can submit bid amounts for one or more clusters. The bids are received (e.g., over the network) and stored in a system data store.

At state 610, a determination is made as to whether the auction has ended (e.g., in accordance with a seller specified auction end period, or when no bids have been received for a specified amount of time). If not, the process proceeds back to state 608. If the auction has ended, the process proceeds to state 612. At state 612, the system determines which, if any bidder has won the auction (e.g., which bid is the highest bid, and had the highest bid exceeded the reserve price and/or minimum bid).

If a winner has not been identified, the process proceeds to state 618, and the seller is so informed. If a winner has been identified, the process proceeds to state 614, and a determination is made (by the system based on seller rules or directly by the seller) as to whether the buyer meets one or more seller conditions (e.g., is not marketing certain specified products or services, or is not held in general disrepute). If the winner does not meet such conditions, the process proceeds back to 612, and another winner is selected (e.g., the next highest bidder). If the buyer does meet the seller conditions, the process proceeds to state 616 and the transaction is completed. For example, notifications can be transmitted to both the buyer and winner regarding the successful bid (e.g., via email, web page, physical document, or otherwise). Optionally, payment is processed by the system (e.g., by charging a credit card, debiting an account or otherwise). Optionally, buyer and/or seller databases are updated by the system to reflect the transaction.

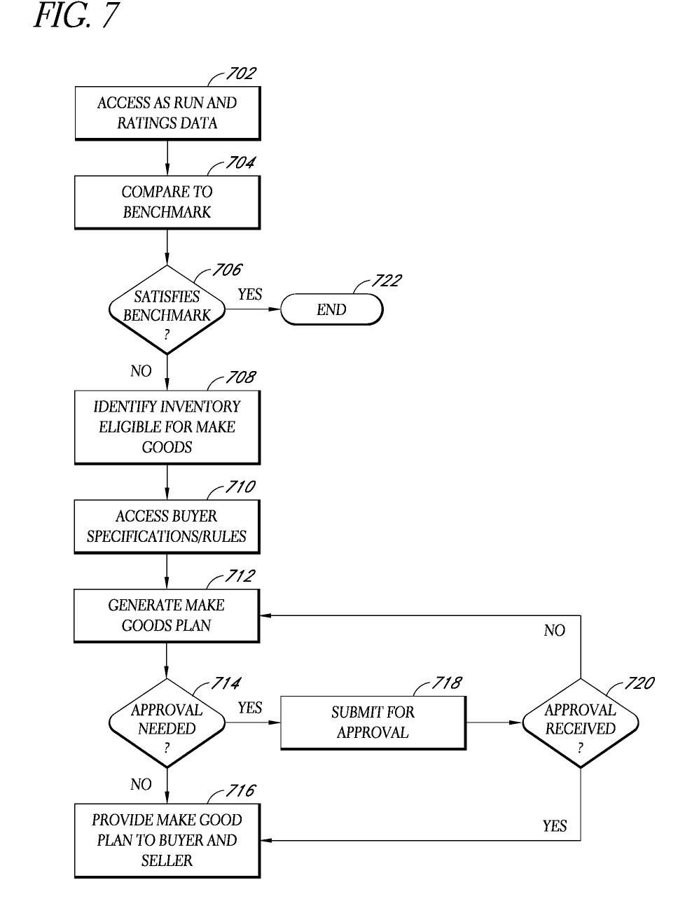

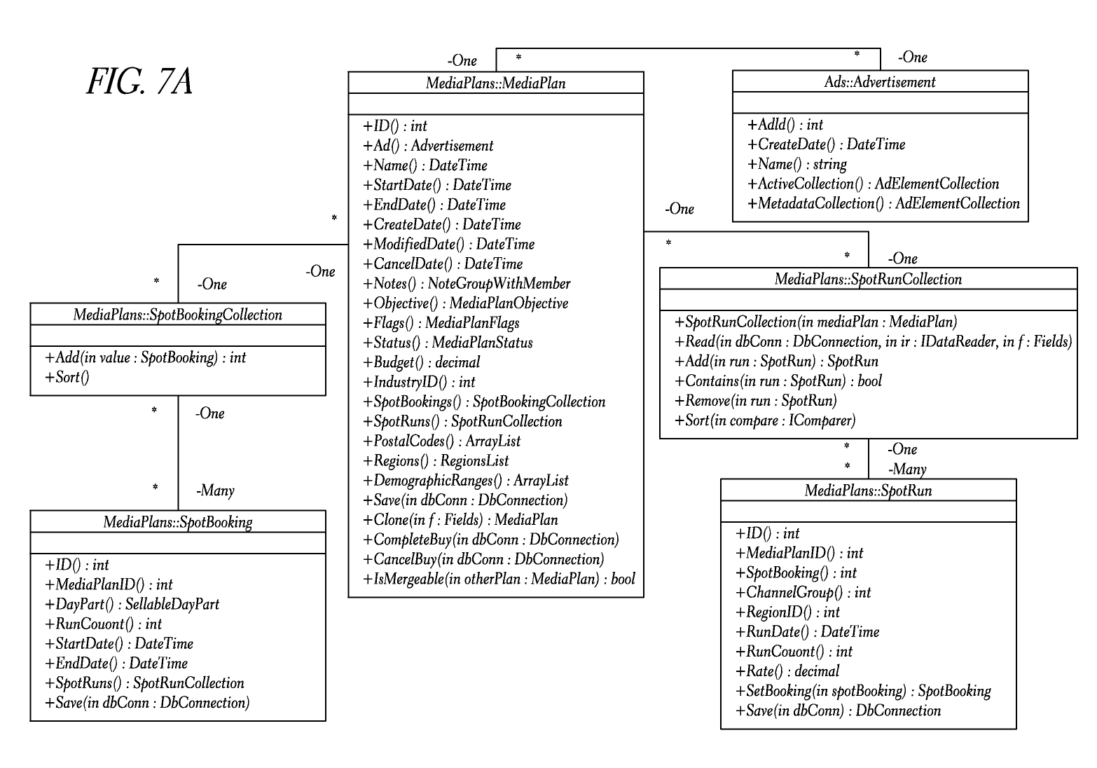

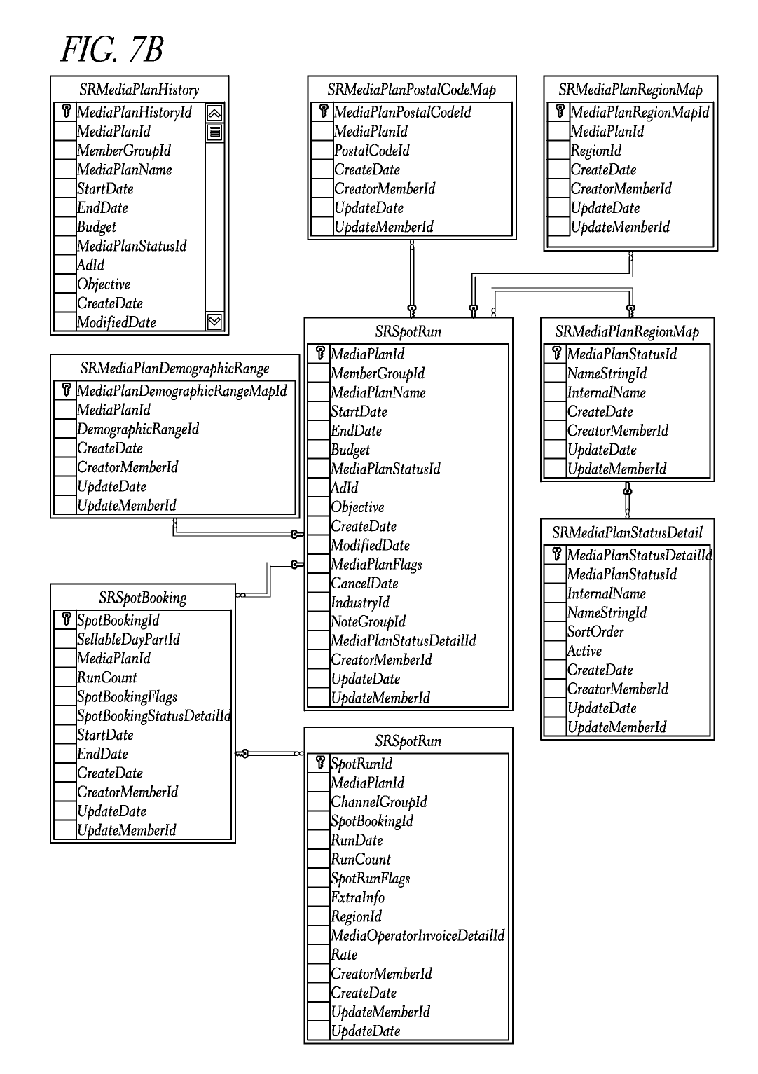

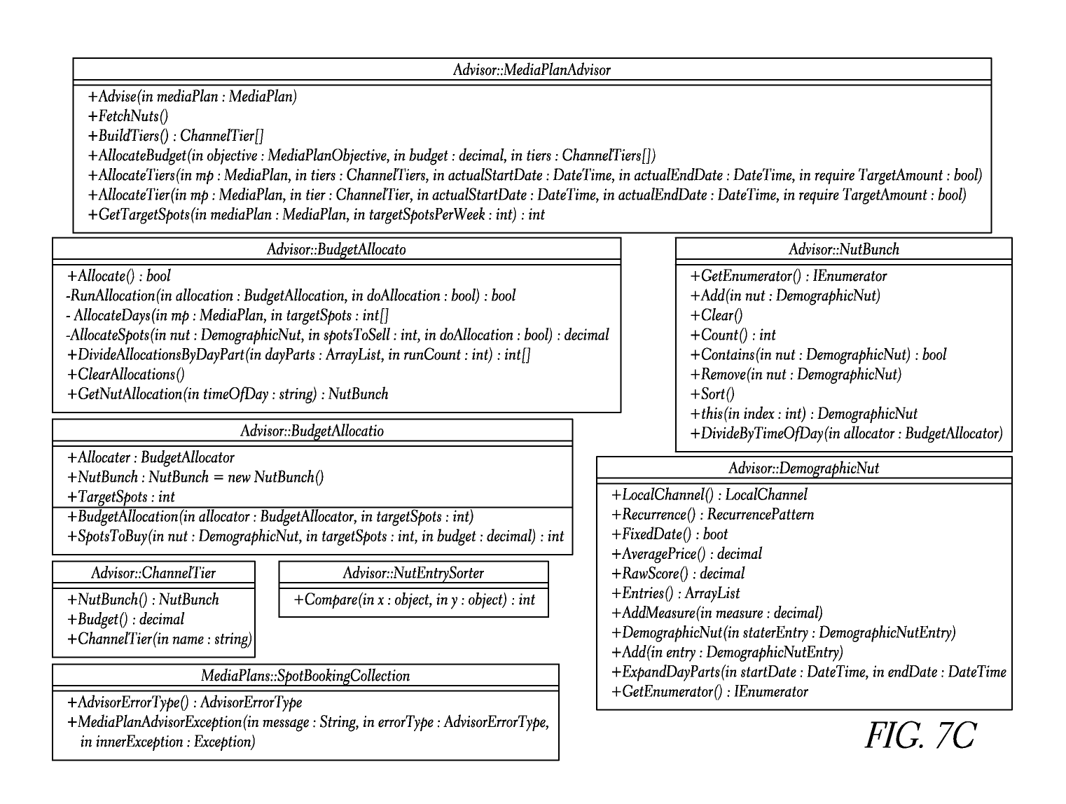

FIG. 7 illustrates an example make good process which is optionally executed using the system 102 or other computer system. At state 702, advertisement “as run” data, including demographic data, for a particular advertiser is accessed from a data store. At 704, the “as run” data is compared to a benchmark indicator/number (or numbers). For example, the benchmark numbers may be ratings information (total and/or broken down by demographics) stored in a data store. The benchmark number may be a ratings guarantee provided by a seller (e.g., a media outlet) to an advertiser. At state 706, a determination is made as to whether the “as run” data stratifies the benchmark (e.g., meets or exceeds, or is at least a specified percentage of the benchmark number), or whether there was under-delivery. If the “as run” data indicates the benchmark was satisfied, the process proceeds to state 722, and the make good process ends.

If a determination is made that there was an under delivery, the process proceeds to state 708, and spare inventory that is eligible to be used as part of a “make good” is identified (e.g., based on a designation provided by the seller). At state 710, buyer specifications/rules are accessed. Optionally the buyer creates special specifications/rules for make goods, or the same specifications for the original media plan can be used. At state 712, the system generates a “make goods” plan using the eligible inventory, the associated anticipated ratings and/or tier levels, optionally filtered using the buyer specifications/rules, to make up or approximate the difference (optionally in whole, or optionally in part) between the as run results and the benchmark.

At 714, a determination is made as to whether approval for the makes good plan is needed from the buyer and/or the seller, or whether the buyer and/or the seller has authorized the system (e.g., as determined from account information stored in an account data store) to automatically offer/accept the make good plan. If approval is needed, the process proceeds to state 718, and the plan is transmitted to the party (buyer and/or seller) whose approval is needed. If approval is not received, then optionally the process proceeds back to state 712, and a new make good plan is generated that is different than the previous plan (e.g., based on comments, specifications, or rules provided by the buyer and/or seller in rejecting the prior make good plan).

If approval is not needed or the needed approval is received (e.g., at state 720), the process proceeds to state 716, and the make good plan is considered accepted by the buyer and seller, and the plan is transmitted to the buyer and seller. The seller then undertakes to fulfill the make good plan. If there still is a remaining under run with respect to the benchmark, the process can be performed again to generate a make good plan to make up for the remaining under run.

FIG. 7D illustrates an example process for performing advertisement inventory transactions. The process can be utilized with multiple buyers and/or sellers. Sellers may be asked, prior to posting an offer to sell to agree to accept an offer that is within a certain range of the proffered sale terms. Similarly, buyers may be asked, prior to posting an offer to buy, to agree to seller offer that is within a certain range of the proffered purchase offer terms.

At state 702D one or more sellers submit one or more sell specifications (including one or more components, such as rates, tiers, specific programs, guaranteed ratings, etc.). For example, a specification can include an offering of advertising spot inventory at corresponding specified rates. Optionally, the seller can specify in the package certain alternatives with the package. For example, the seller can specify a certain combination of spots at different tier levels at different prices (e.g., First version: 50% to be shown on tier 1 programming; 50% to be shown on tier 2 programming; at a first ask rate. Second version: 60% to be shown on tier 1 programming; 40% to be shown on tier 2 programming; at a second ask rate).

At state 704D, one or more buy offers are received from one or more buyers (including one or more components, such as rates, tiers, specific programs, guaranteed ratings, etc.). As with the seller, a buyer can include certain alternatives within the buy offer (e.g., First version: 50% to be shown on tier 1 programming; 50% to be shown on tier 2 programming; at a first offer rate. Second version: 55% to be shown on tier 1 programming; 45% to be shown on tier 2 programming; at a second offer rate).

At state 706D, the system compares the asks to the offers (optionally including alternative versions) to identify acceptable matches, if any (e.g., exact matches of the various components of a seller specification and a buyer specification, or instances with a certain number/percentage of components match and/or are within a certain range of matching).

At 708D, a determination is made as to whether there are one or more matches. If there are no adequate matches, the process proceeds back to 708D. If there are one or more matches, at state 710D, matches (e.g., exact and/or within a range as to be potentially acceptable or potentially acceptable) are ranked (e.g., wherein the closer the match the higher the rank). Then, the closet/highest ranked purchase/sale set are paired, and at state 712D a transaction is completed between the seller/buyer associated with the purchase sale set based on the matched purchase offer and sale offer.

At state 714D, confirmations regarding the transaction are sent (electronically, via hardcopy, or otherwise) to the corresponding buyer and seller.

Optionally, a language (understandable by a computer) oriented toward a media market place may be used to provide or facilitate functionality described herein (e.g., the ETL process). For example, a Media Marketplace Markup Language (referred to herein as M3L) may be used to represent media inventory across various media types (e.g., television, radio, the Web, physical publications, etc.) and formats (e.g., CPx, Spot Runner, national, satellite, etc.). The M3L schema optionally supports various terminologies used in TV, Radio, the Web, physical publishing, and/or other industries and is extensible for future integrations, upgrades, and/or extensions across disparate media industries.

For example, the system may acquire data via the media marketplace engine. The markup language can be used to represent the marketplace data, and acts as an integration engine that integrates the conforming marketplace data into the system. Thus, the use of M3L enables the representation and information transfer of media inventory across multiple industries and enables disparate data to be stored in a unified database.

The example schema is optionally used by various integrated vendors and internal systems for:

Inventory representation and allocation

Avail Requests/Responses, worksheets/orders, make-goods, invoices etc. representation

Use cases to interact with an example media marketplace engine

Thus, a computer system (e.g., via ETL code) can access data obtained from one or more sources (e.g., accessed over a network from other computer systems/data storage devices, or manually entered by a user), identify the types of data being accessed (e.g., via tags and/or a predefined mapping stored in memory), and store the data in a record in computer readable memory (e.g., one or more databases stored in volatile or non-volatile memory) using the schemas discussed above (wherein the data is mapped/stored in the appropriate fields). The schemas can be utilized to integrate the data from the various sources.

Certain elements described herein use other elements described herein.

M3L Entities can include some or all of the following and/or additional/different entities

1. Avail (availability, such as of a slot)

2. AvailType (availability type)

3. AvailUnit (availability unit)

4. AvailUnitCpp (availability unit CPP)

5. AvailUnitCpm (availability unit CPM)

6. AvailUnitRating (availability unit rating)

7. AvailUnitSpot (availability unit spot)

8. AvailPrice (availability price)

9. AvailUnitPrice (availability unit price)

10. Price (price)

11. SpecialRate (special rate)

12. Geography (geography)

13. GeographyUnit (geography unit)

14. GeographyType (geography type)

15. GeoNational (geography national)

16. GeoDMA (geography DMA)

17. GeoPMSA (geography PMSA)

18. DemographicRange (demographic range)

19. Station (station)

20. Network (network)

21. Company (company/customer)

22. CompanyOwner (company owner)

23. CompanyClient (company's client)

4. CompanySeller (company seller)

25. Account (account)

26. AccountBuyer (account buyer)

27. AccountSeller (account seller)

28. Program (program)

29. DayPart (daypart)

30. DayOfWeek (day of the week)

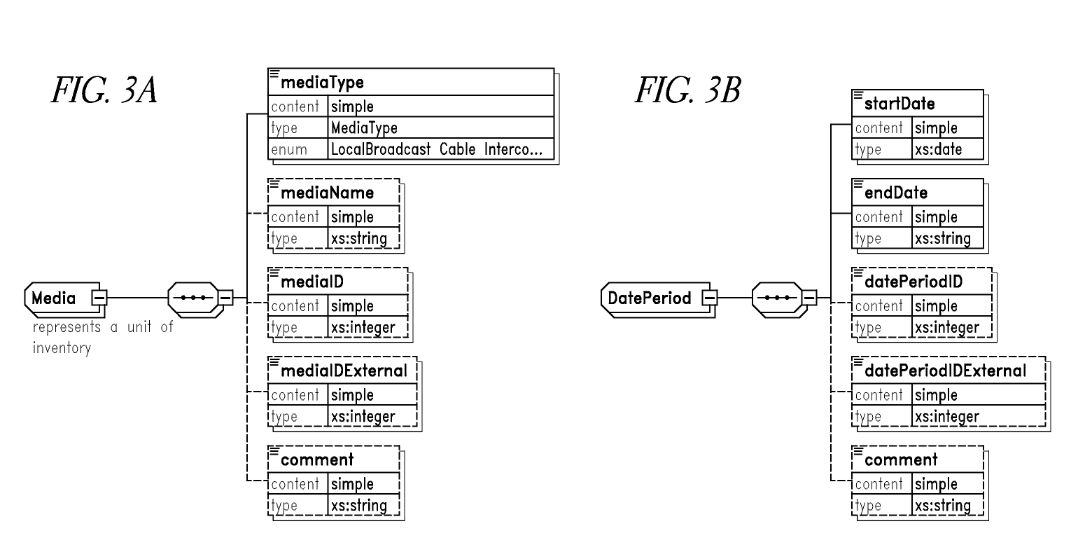

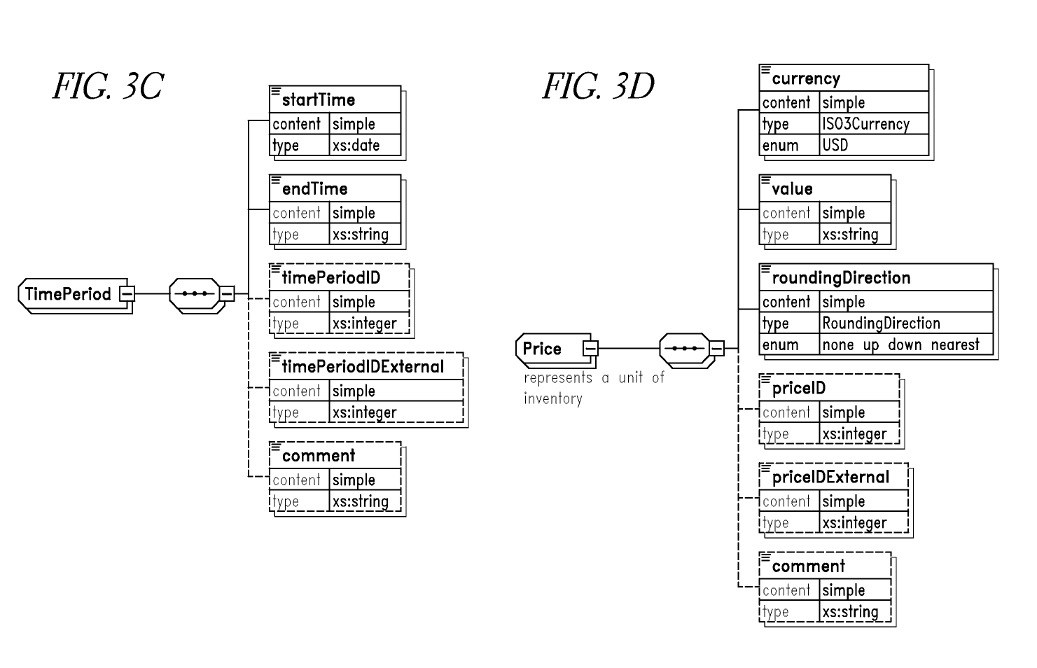

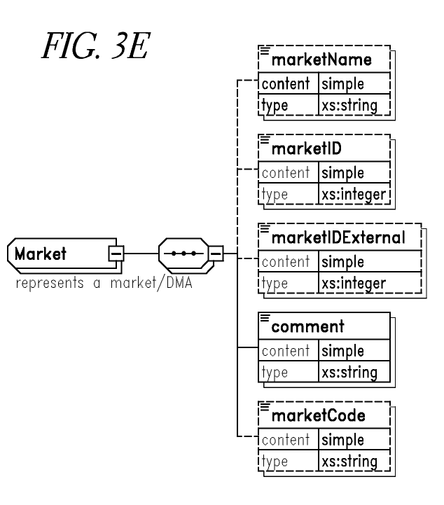

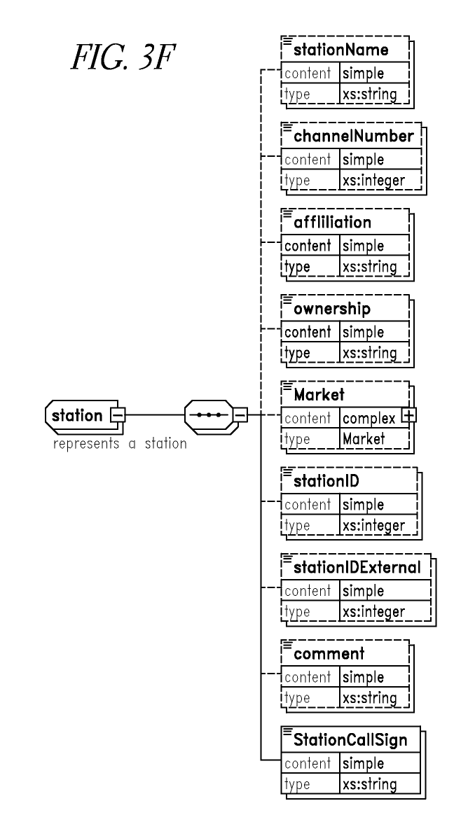

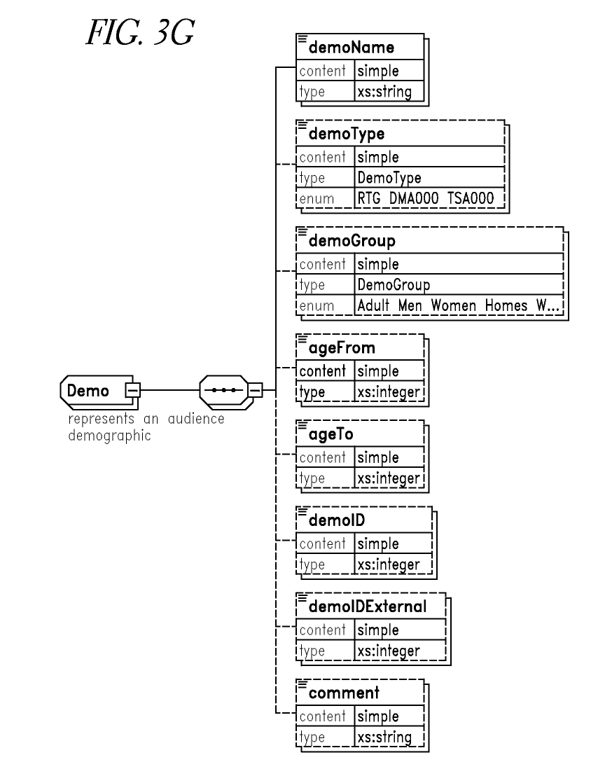

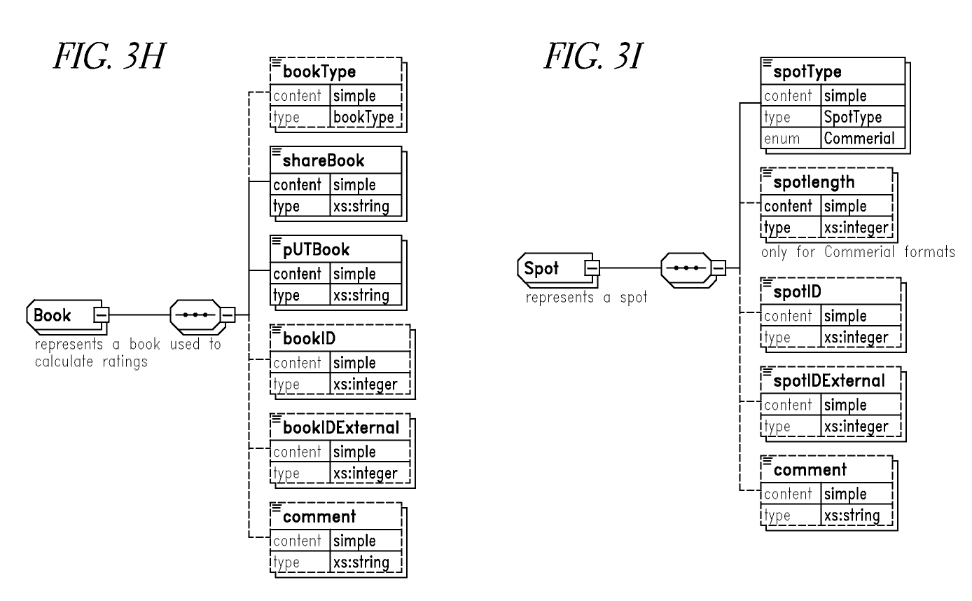

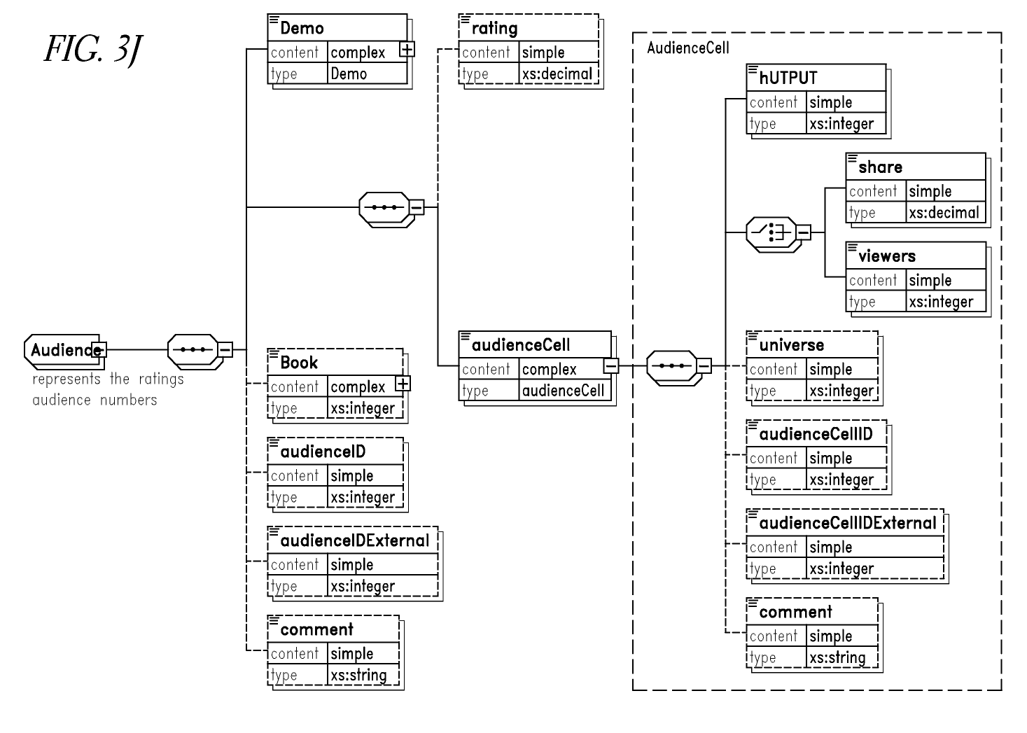

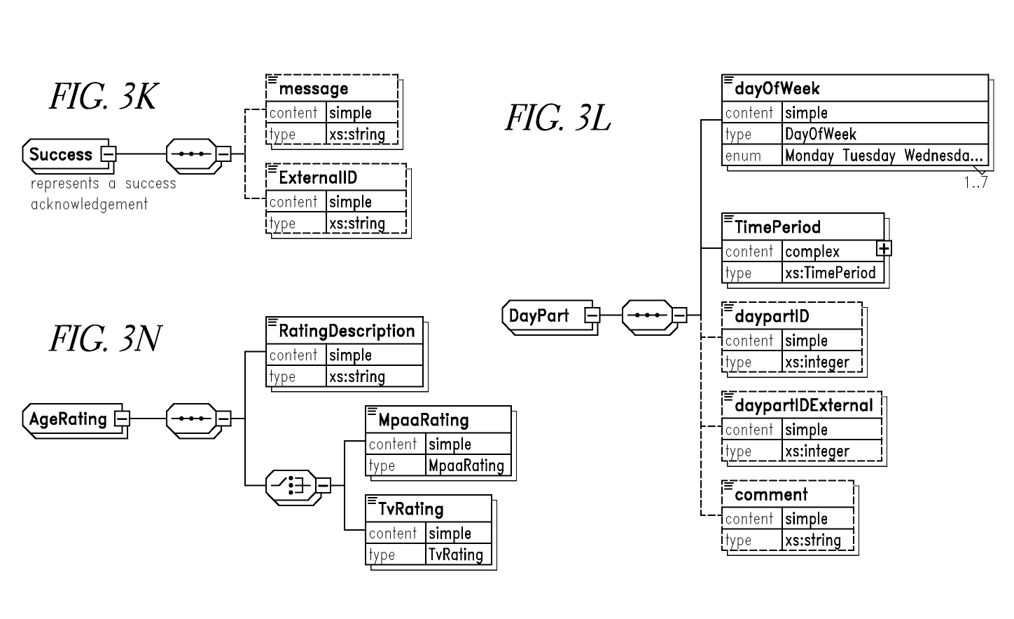

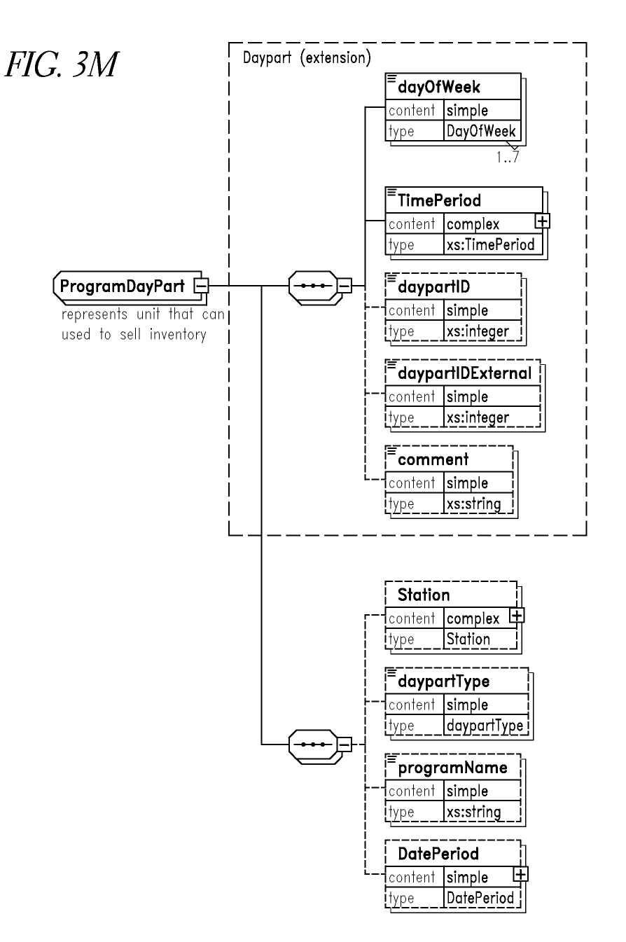

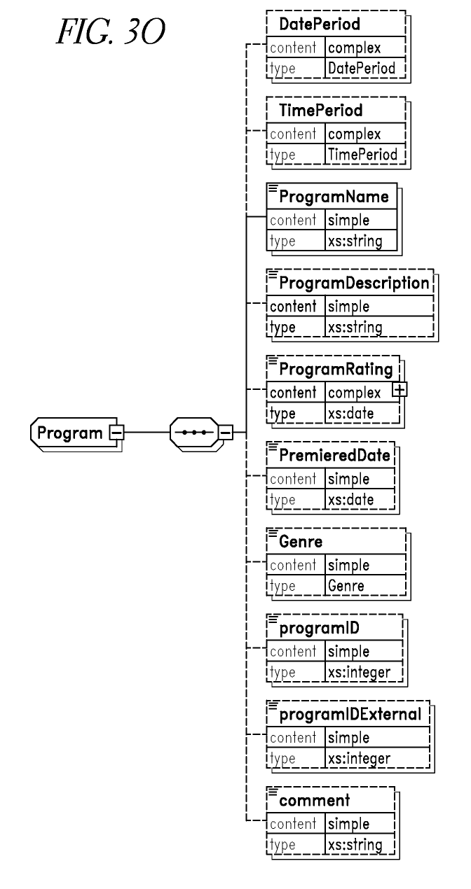

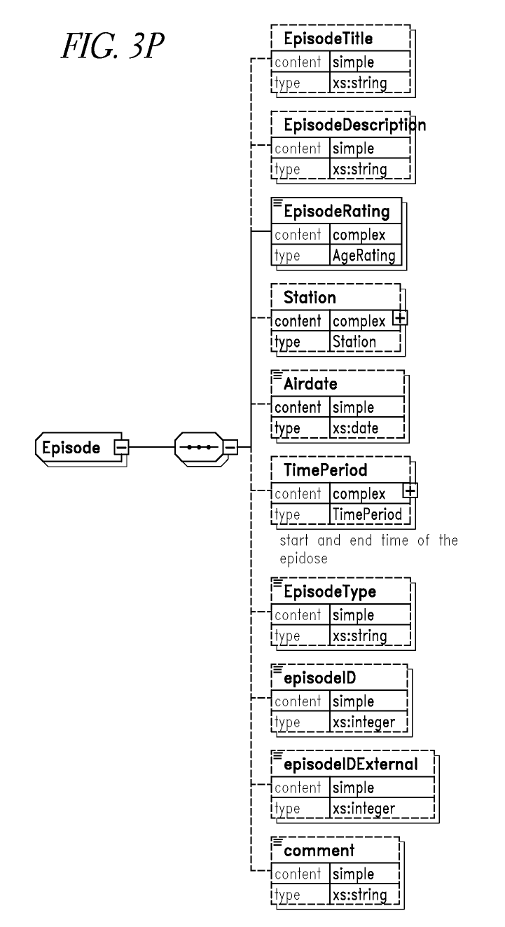

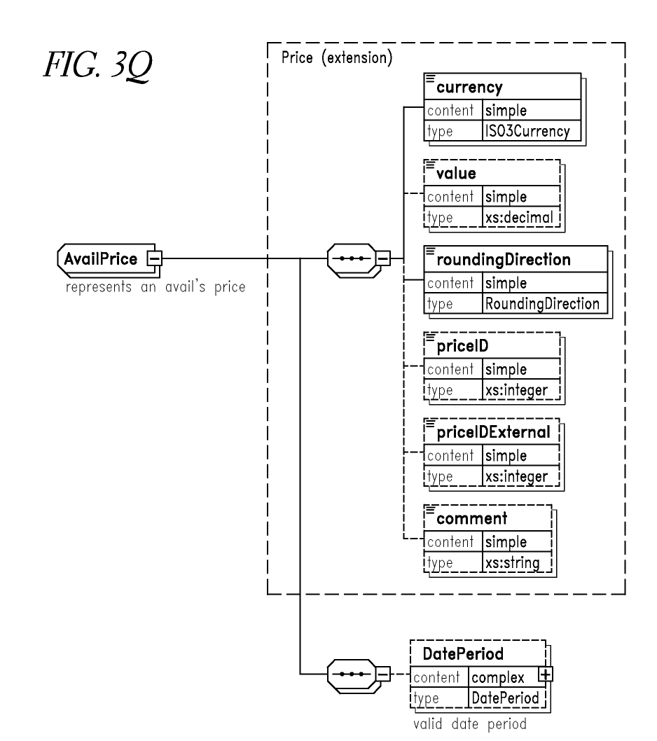

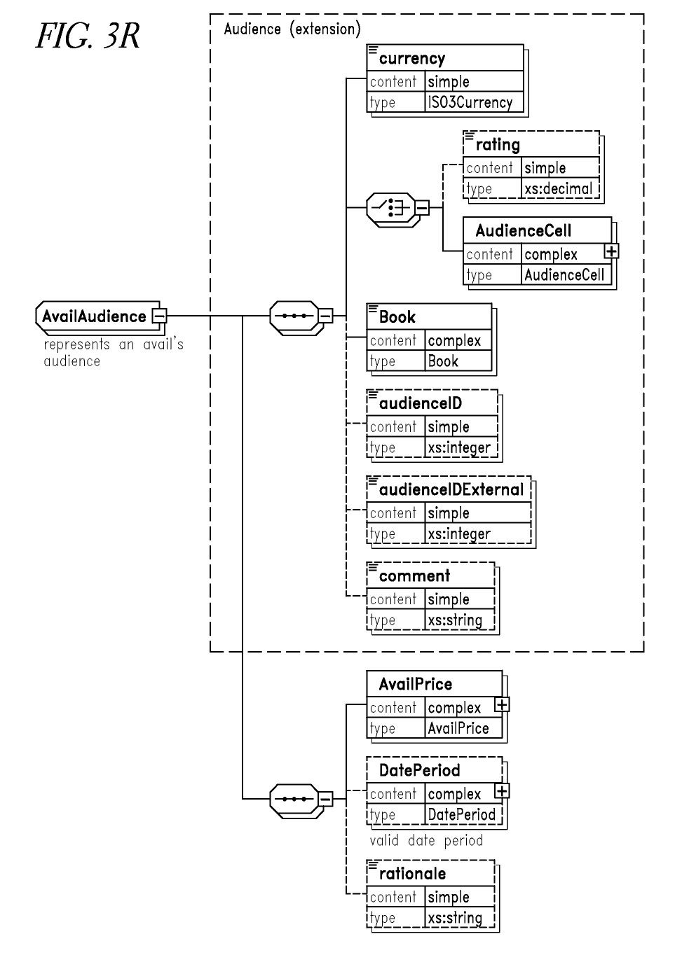

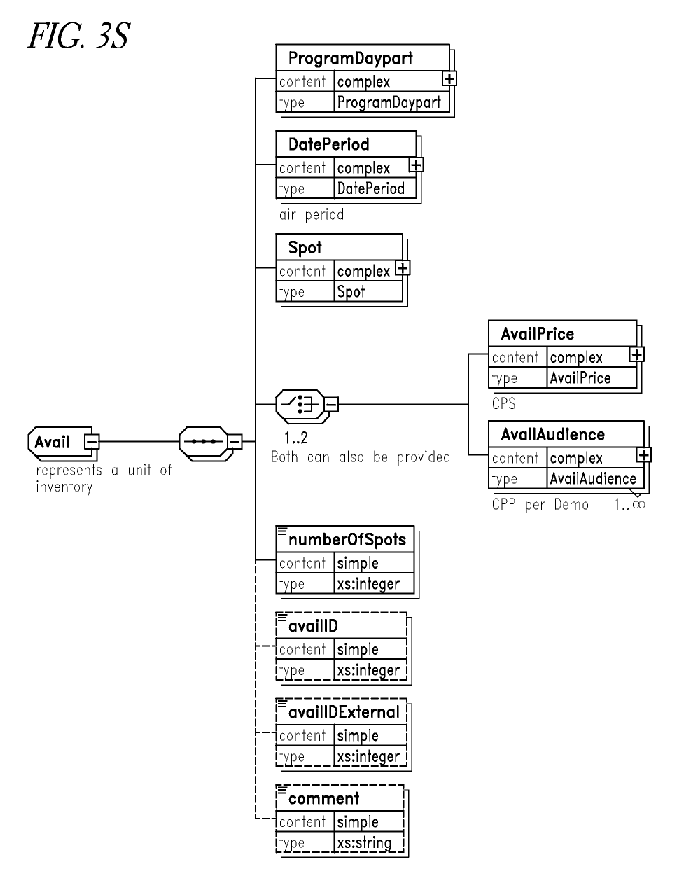

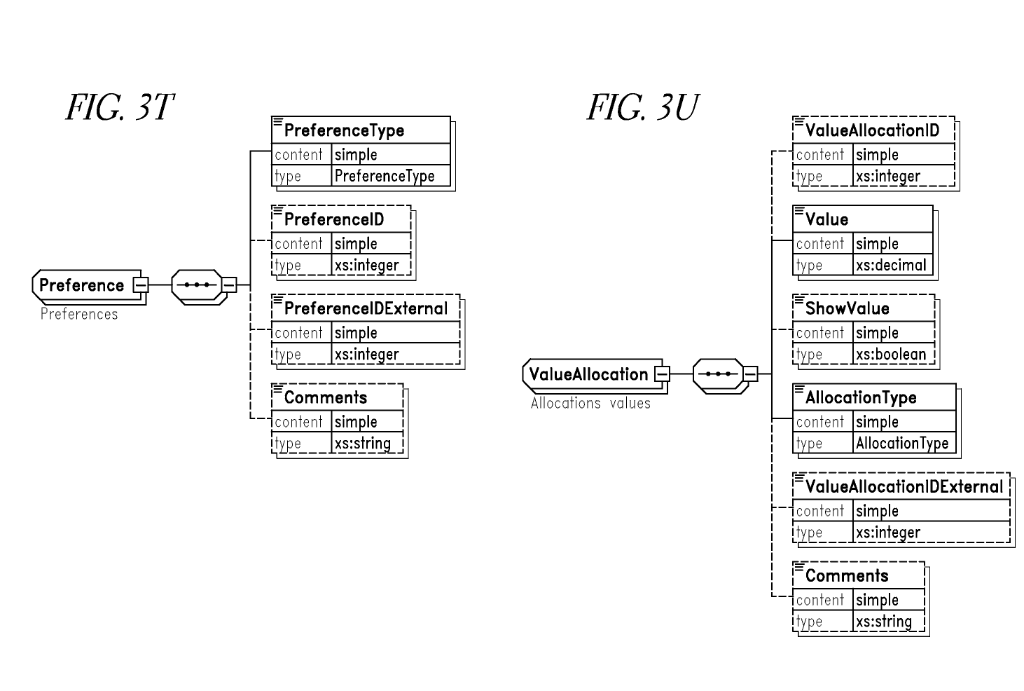

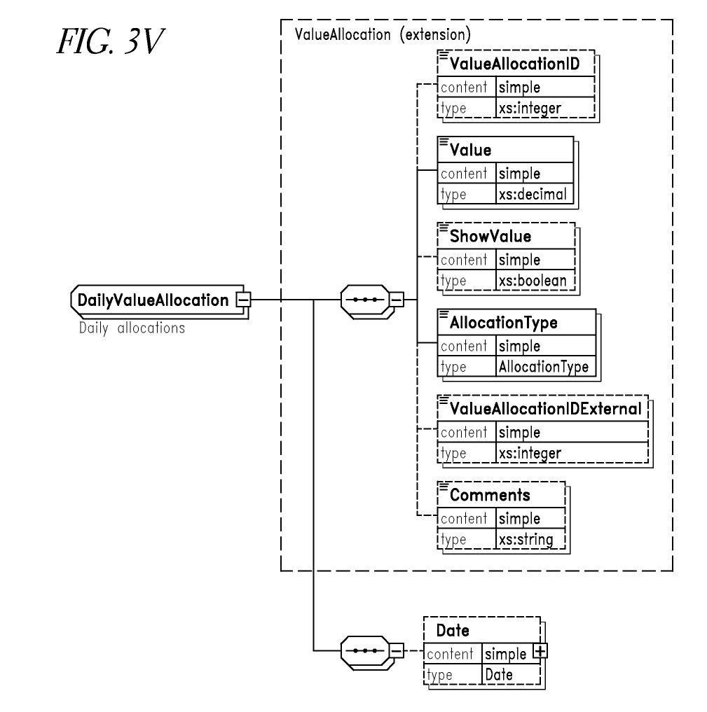

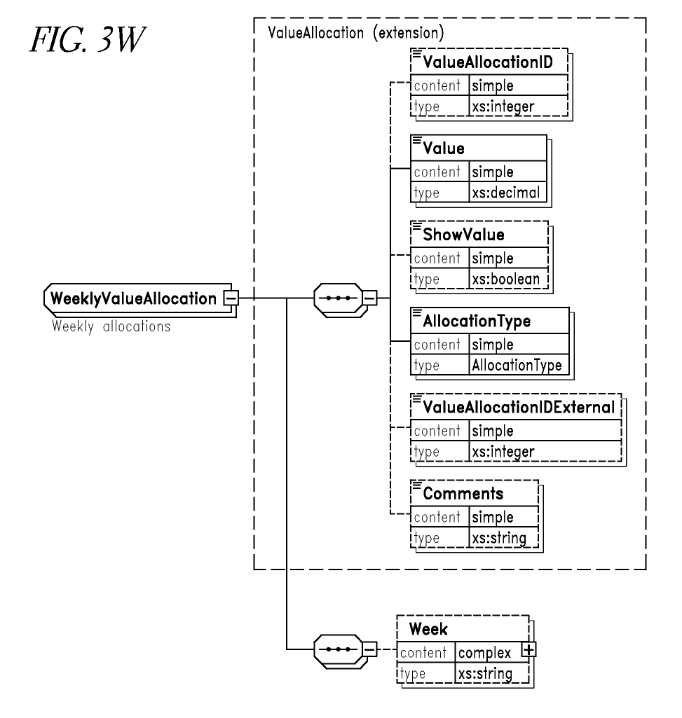

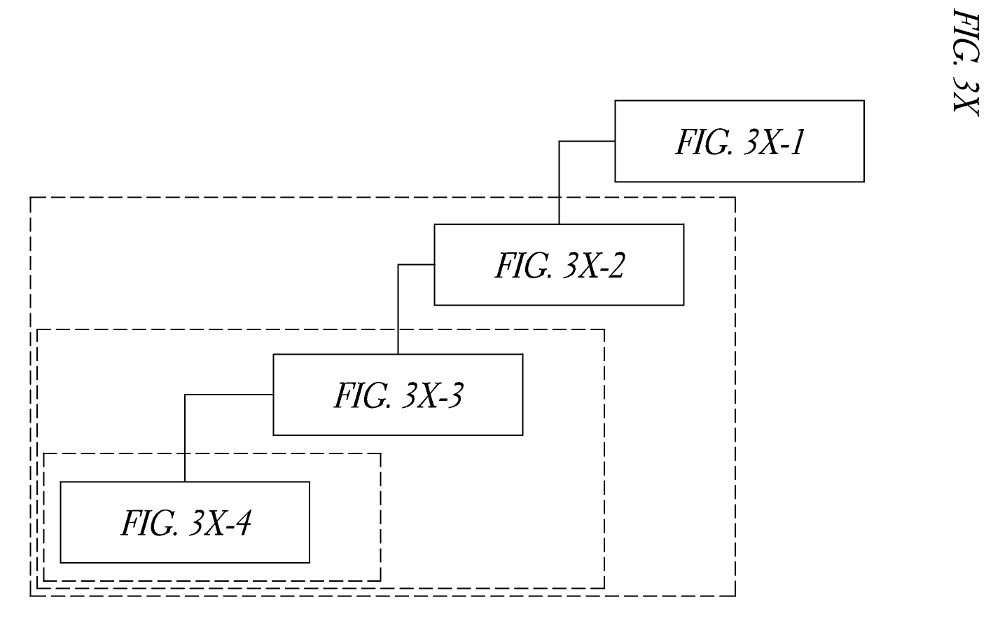

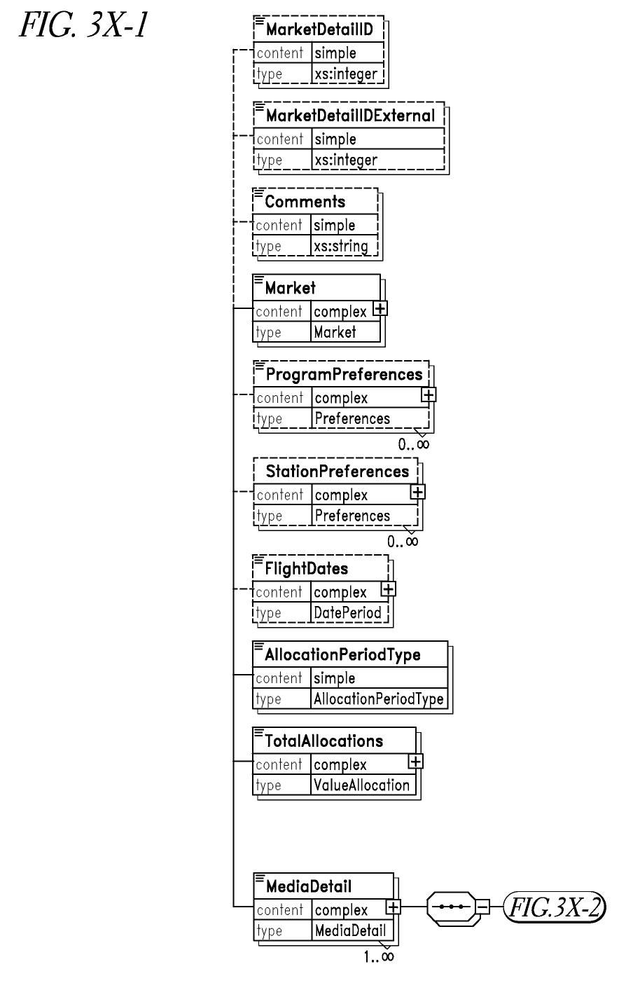

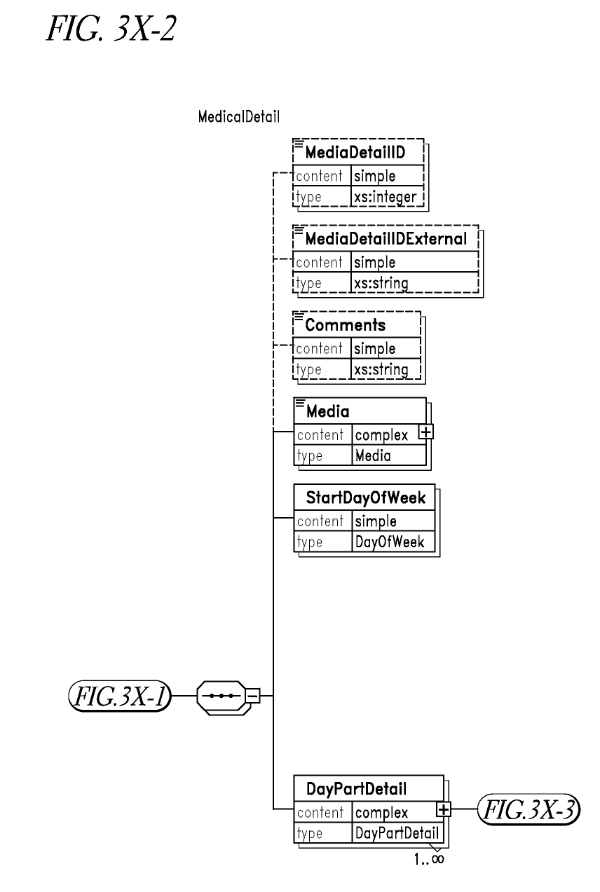

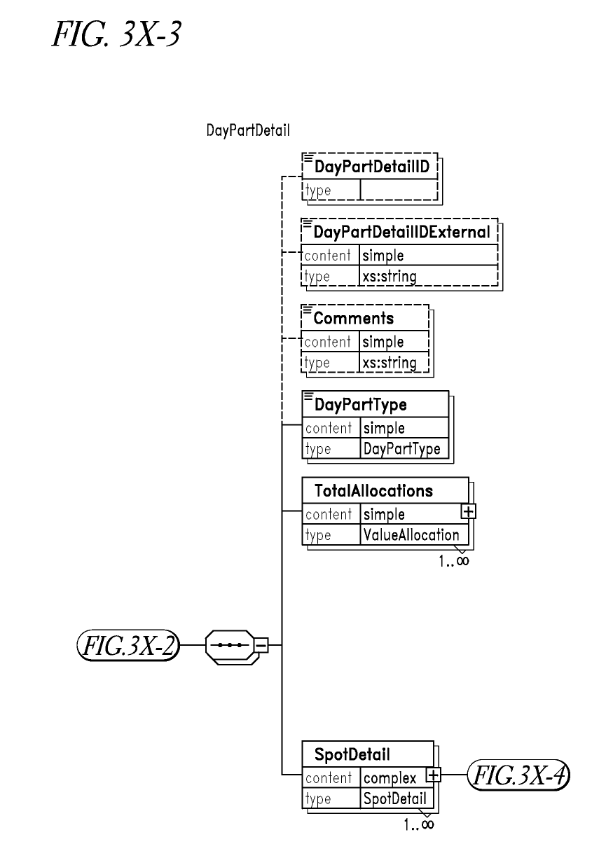

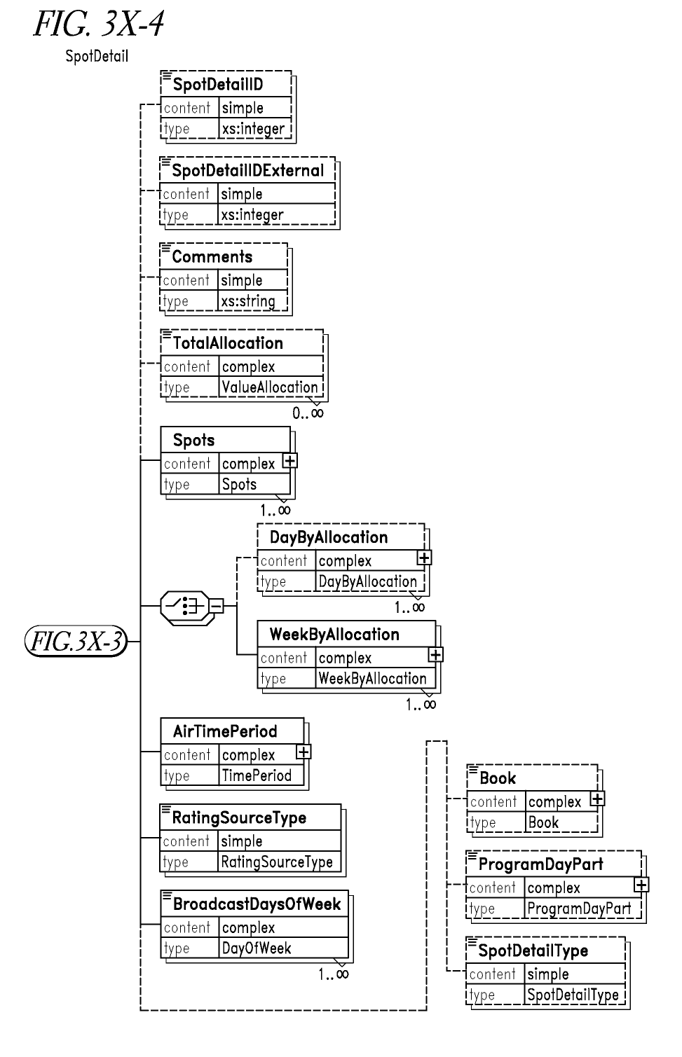

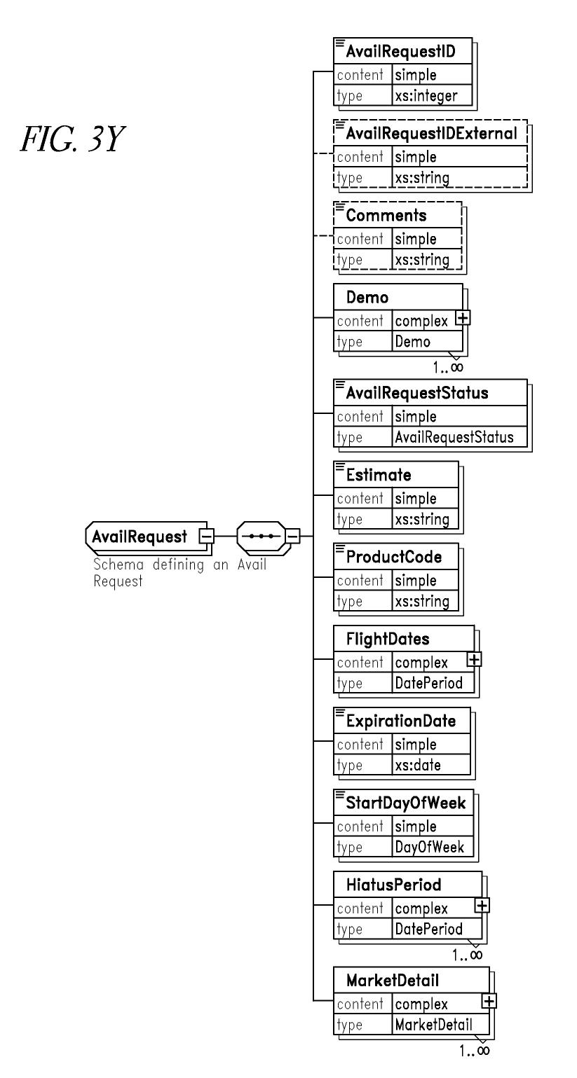

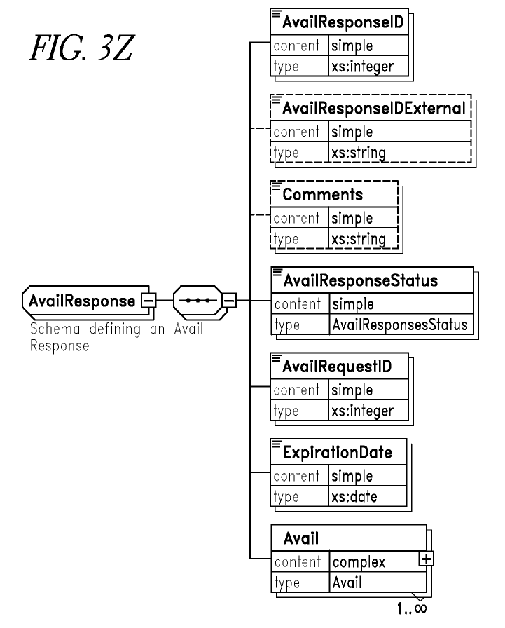

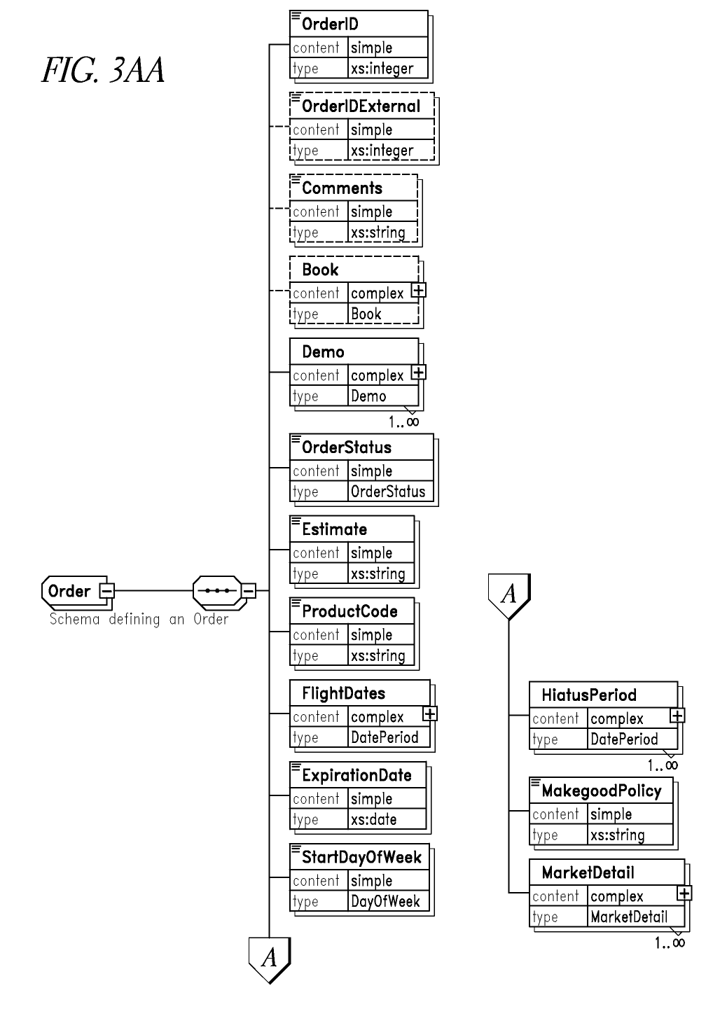

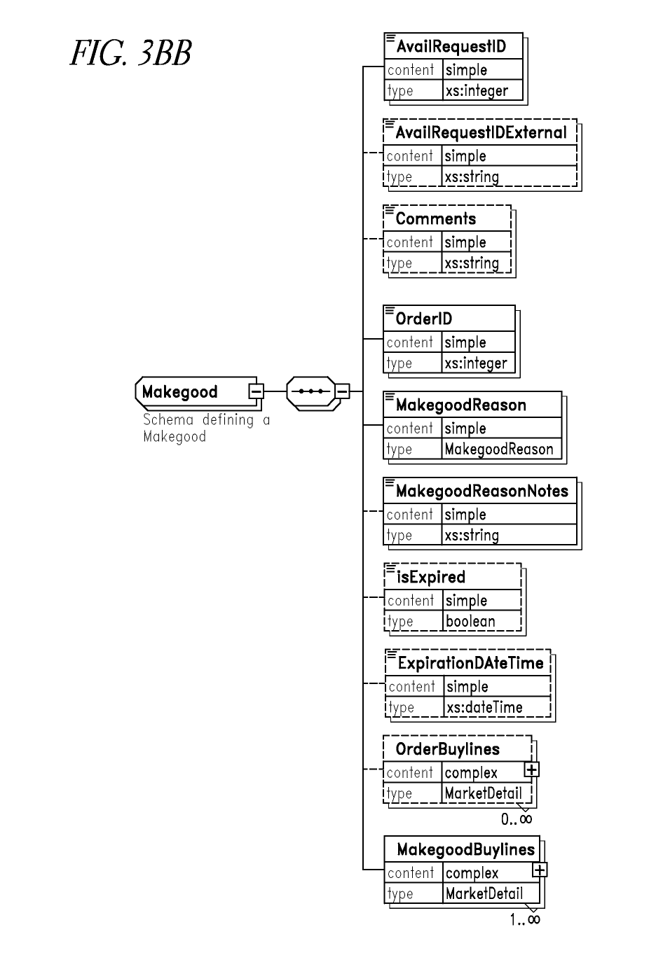

With reference to FIG. 3A, an example Media element is illustrated, including various fields used to describe the media at issue. The example Media element includes:

mediaType, with fields defining the content (e.g. simple, the media type (e.g., radio spot, television spot, web placement/spot, etc.), and an enumeration value (e.g., local broadcast, cable, Spot TV, etc.).

mediatime, with fields defining: content (e.g., “simple); and type (e.g., xs.string.

mediaID, with fields defining: content (e.g., “simple); and type (e.g., xs.integer).

mediaIDexternal, with fields defining: content (e.g., “simple); and type (e.g., xs.integer).

comment, with fields defining: content (e.g., “simple); and type (e.g., xs.string).

The Media element represents various media verticals in the system. Example values are provided below:

<Media>

<mediaType>SpotTelevision</mediaType>
<mediaName>Spot TV</mediaName>
<mediaID>1</mediaID>
<mediaIDExternal>12</mediaIDExternal>
<comment>sample comment</comment>

</Media>

MediaType

<xs:simpleType name=“MediaType”>

<xs:annotation>

<xs:documentation>represents the media
types</xs:documentation>

</xs:annotation>
<xs:restriction base=“xs:string”>

<xs:enumeration value=“SpotTelevision”/>

</xs:restriction>

</xs:simpleType>

With reference to FIG. 3B, an example DatePeriod element is illustrated, including various fields used to describe a date range at issue. The example DatePeriod element includes: startDate, endDate, datePeriodID; datePeriodIDExternal; comment. Example values are provided below:

```
<DatePeriod>
    <startDate>2007-01-01</startDate>
    <endDate>2007-07-30</endDate>
    <datePeriodID>1</datePeriodID>
    <datePeriodIDExternal>1</datePeriodIDExternal>
    <comment>sample comment</comment>
</DatePeriod>
```

With reference to FIG. 3C, an example TimePeriod element is illustrated, including various fields used to describe a time range at issue. The example TimePeriod element includes: startTime (e.g., expressed via a 24 hour clock format, or a 12 hour clock format, with AM and PM to distinguish the two 12 hour periods), endTime (e.g., expressed via a 24 hour clock format or a 12 hour clock format), timePeriodID, timePeriodIDExternal, comment.

Example values are provided below:

```
<TimePeriod>
    <startTime>14:20:00.0Z</startTime>
    <endTime>14:20:00.0Z</endTime>
    <timePeriodID>1</timePeriodID>
    <timePeriodIDExternal>1</timePeriodIDExternal>
    <comment>sample comment</comment>
</TimePeriod>
```

A DayOfWeek element includes elements enabling one or more days of the week to be specified.

Example values are provided below:

```
    <xs:simpleType name=“DayOfWeek”>
        <xs:annotation>
          <xs:documentation>represents  the  day  of
the week</xs:documentation>
        </xs:annotation>
        <xs:restriction base=“xs:string”>
          <xs:enumeration value=“Monday”/>
          <xs:enumeration value=“Tuesday”/>
          <xs:enumeration value=“Wednesday”/>
          <xs:enumeration value=“Thursday”/>
          <xs:enumeration value=“Friday”/>
          <xs:enumeration value=“Saturday”/>
          <xs:enumeration value=“Sunday”/>
        </xs:restriction>
    </xs:simpleType>
```

With reference to FIG. 3D, an example Price element is illustrated, including various fields used to describe a price in terms of currency type and value. The example Price element includes: Currency (e.g., United States Dollars, lbs, etc.), value (e.g., expressed as a dollar value), roundingDirection (e.g., up or down to the nearest round value). priceID, priceIDExternal, comment.

Example values are provided below:

```
<Price>
    <currency>USD</currency>
    <value>24.00</value>
    <roundingDirection>none</roundingDirection>
    <priceID>1</priceID>
    <priceIDExternal>12</priceIDExternal>
    <comment>sample comment</comment>
</Price>
```

Example Currency element values are provided below:

<xs:simpleTypename=“ISO3Currency”>

<xs:annotation>

<xs:documentation>ISO-4217 3-letter currency codes, as defined at

http://www.bsi-global.com/Technical+Information/Publications/_Publications/tig90.xalter or
available from http://www.xe.com/iso4217.htm Only a subset are defined
here.</xs:documentation>

</xs:annotation>
<xs:restriction base=“xs:string”>

<xs:length value=“3”/>
<xs:enumeration value=“USD”/>

</xs:restriction>

</xs:simpleType>

Example RoundingDirection element values are provided below:

<xs:simpleType name=“RoundingDirection”>

<xs:annotation>

<xs:documentation>Whether the decimal value is rounded

up, down or to the nearest round value.</xs:documentation>

</xs:annotation>
<xs:restrictionbase=“xs:string”>

<xs:enumeration value=“none”/>
<xs:enumeration value=“up”/>
<xs:enumeration value=“down”/>
<xs:enumeration value=“nearest”/>

</xs:restriction>

</xs:simpleType>

With reference to FIG. 3E, an example Market element is illustrated, including various fields used to describe a market/DMA in which inventory is being sold. An example Market element includes: marketName, marketID, marketIDExternal, comment, marketCode (corresponding to the market).

Example values are provided below:

```
<Market>
    <marketName>PORTLAND-AUBURN</marketName>
    <marketID>100</marketID>
    <marketIDExternal>100</marketIDExternal>
    <comment>sample comment</comment>
    <marketCode>100</marketCode>
</Market>
```

With reference to FIG. 3F, an example Station element is illustrated, including various fields used to describe a station (e.g., a network station) that runs the advertisement. An example Station element includes: stationName (e.g., may be the same as the station call sign); channelNumber (the channel number), affiliation, ownership; Market (e.g., the market name, such as city or cities; marketID; marketIDExternal), stationID, stationIDExternal, stationCallSign.

Example values are provided below:

```
<Station>
    <stationName>KTLA</stationName>
    <channelNumber>03</channelNumber>
    <Market>
      <marketName>PORTLAND-AUBURN</marketName>
      <marketID>100</marketID>
      <marketIDExternal>100</marketIDExternal>
    </Market>
    <stationID>0123</stationID>
    <stationIDExternal>0123</stationIDExternal>
    <stationCallSign>KTLA</stationCallSign>
</Station>
```

With reference to FIG. 3G an example demography (Demo) element is illustrated, including various fields used to describe a demographic or its superset (e.g., a Nielsen demographic or its superset). An example Demo element includes: demoName, Demotype (e.g., rating, DMA, TSA, etc.); demoGroup (e.g., one or more of the following: an age grouping, such as Adults, Teenagers, pre-teen, children, etc., a gender group such as Men/Women, race, or others, such as Home); ageFrom (beginning of age range); ageTo (end of age range); demoID; demoIDExternal; comment.

Example values are provided below:

```
<Demo>
    <demoName>RA1854</demoName>
    <demoType>RTG</demoType>
    <demoGroup>Adults</demoGroup>
    <ageFrom>18</ageFrom>
    <ageTo>54</ageTo>
    <demoID>1</demoID>
    <demoIDExternal>12</demoIDExternal>
    <comment>sample comment</comment>
</Demo>
```

Example DemoType element values are provided below:

```
<xs:simpleType name=“DemoType”>
    <xs:annotation>
      <xs:documentation>represents the type of
      demo</xs:documentation>
    </xs:annotation>
    <xs:restriction base=“xs:string”>
      <xs:enumeration value=“RTG”/>
      <xs:enumeration value=“DMA000”/>
      <xs:enumeration value=“TSA000”/>
    </xs:restriction>
</xs:simpleType>
```

Example DemoGroup element values are provided below:

```
  <xs:simpleType name=“DemoGroup”>
      <xs:annotation>
        <xs:documentation>represents the group of the
demo</xs:documentation>
      </xs:annotation>
      <xs:restriction base=“xs:string”>
        <xs:enumeration value=“Adults”/>
        <xs:enumeration value=“Men”/>
        <xs:enumeration value=“Women”/>
        <xs:enumeration value=“Homes”/>
        <xs:enumeration value=“WWomen”/>
        <xs:enumeration value=“Children”/>
        <xs:enumeration value=“Teens”/>
        <xs:enumeration value=“Persons”/>
      </xs:restriction>
  </xs:simpleType>
```

With reference to FIG. 3G, an example Book element is illustrated, including various fields used to describe a book (e.g., a rating book providing a percentage of a population viewing a program during a specified or average time slice and/or a share (the percentage of television/radio usage attributable to a program)) representing one or a combination of books (e.g., Nielsen books) used to calculate ratings for a given demo. An example Book element includes: BookType (e.g., for various demographic groups or other grouping, such as a specified ethnic group, income group, geographical group, resident type (e.g., metro, suburban), etc., see FIG. 3H); shareBook; pUTBook; bookID; boookIDExternal; comment.

Example values are provided below:

```
<Book>
    <bookType>Standard</bookType>
    <shareBook>MAY06 C-DMA Nielsen</shareBook>
    <pUTBook> JUN05 C-DMA Nielsen </pUTBook>
    <bookID>1</bookID>
    <bookIDExternal>12</bookIDExternal>
    <comment>sample comment</comment>
</Book>
```

Example BookType element values are provided below:

```
  <xs:simpleType name=“BookType”>
      <xs:annotation>
        <xs:documentation>represents the type of book
used</xs:documentation>
      </xs:annotation>
      <xs:restriction base=“xs:string”>
        <xs:enumeration value=“Black”/>
        <xs:enumeration value=“Hispanic”/>
        <xs:enumeration value=“Olympic”/>
        <xs:enumeration value=“Standard”/>
        <xs:enumeration value=“Metro”/>
      </xs:restriction>
  </xs:simpleType>
```

With reference to FIG. 3I, an example Spot element is illustrated, including various fields used to describe a spot (e.g., a commercial spot, a billboard, a print ad, etc.). An example spot element includes: spotType (e.g., commercial; billboard; transit; website); spotlength (e.g., expressed in seconds); spotID; spotIDExternal; comment.

Example values are provided below:

```
<Spot>
    <spotType>Commercial</spotType>
    <spotlength>15</spotlength>
    <spotID>1</spotID>
    <spotIDExternal>12</spotIDExternal>
    <comment>sample comment</comment>
</Spot>
```

Example SpotType element values are provided below:

```
<xs:simpleType name=“SpotType”>
    <xs:annotation>
      <xs:documentation>represents a spot type</xs:documentation>
    </xs:annotation>
    <xs:restriction base=“xs:string”>
      <xs:enumeration value=“Commercial”/>
    </xs:restriction>
</xs:simpleType>
```

With reference to FIG. 3J, an example Audience element is illustrated, including various fields used to describe an audience (e.g., representing a rating or rating values for a given demo and/or book). Share/Viewers and HUT (homes using television)/PUT (persons using television)/PVT (persons viewing television) values can be used to calculate the rating (e.g., HUT×Share=Rating; PUT×Share=Rating; PVT×Share=Rating). Optionally, in addition or instead, a rating is pre-calculated and provided by the seller. In the foregoing cases, the book is optionally specified or is optionally not specified. An example audience element includes: Demo; rating; Book; audianceID; audianceIDExternal; AudienceCell (which includes in this example hUTPUT; share; viewers (e.g., viewers viewing a program); universe (e.g., of households); audienceCellID; audienceCellIDExternal; comment; comment.

Example values are provided below:

```
<Audience>
    <Demo>
      <demoName>RA1854</demoName>
    </Demo>
    <Book>
      <shareBook>MAY06 C-DMA Nielsen</shareBook>
      <pUTBook> JUN05 C-DMA Nielsen </pUTBook>
    </Book>
    <AudienceCell>
      <hUTPUT>100000</hUTPUT>
      <share>.48</share>
      <universe>150000</universe>
    </Audience>
    <audienceID>1</audienceID>
</Audience>
```

With reference to FIG. 3K, an example Success element is illustrated, including various fields used to send a successful response back to the requester. An optional message could be added indicating details of the processed request.

An example Success element includes: message (e.g., an alphanumeric message indicating that a request was successfully processed); ExternalID.

Example values are provided below:

<Success>
<message>The request was processed successfully</message>
</Success>

With reference to FIG. 3L, an example Daypart element is illustrated, including various fields used to describe a time slot on a specific day of the week (e.g., early morning, daytime, early fringe, early news, prime access, prime time, late news, late fringe, etc.). An example daypart element includes: dayofweek; timeperiod; daypartID; daypartIDExternal; comment.

Example values are provided below:

```
  <xs:simpleType name=“DaypartType”>
      <xs:annotation>
        <xs:documentation>represents the different standard
dayparts</xs:documentation>
      </xs:annotation>
      <xs:restriction base=“xs:string”>
        <xs:enumeration value=“EarlyMorning”/>
        <xs:enumeration value=“Daytime”/>
        <xs:enumeration value=“EarlyFringe”/>
        <xs:enumeration value=“EarlyNews”/>
        <xs:enumeration value=“PrimeAccess”/>
        <xs:enumeration value=“PrimeTime”/>
        <xs:enumeration value=“LateNews”/>
        <xs:enumeration value=“LateFringe”/>
      </xs:restriction>
  </xs:simpleType>
```

With reference to FIG. 3M, an example ProgramDayPart element is illustrated, including various fields used to describe a time slot that can be used to represent a unit of inventory (e.g., Date Range, Time Range and DaysOfWeek) specifying the time frames that the spots are available, where DaysOfWeek is a set of values from DayOfWeek. An example ProgramDayPart element includes: dayOfWeek; TimePeriod (e.g., start time and end time); daypartID; daypartIDExternal; comment; Station (e.g., station name or call sign); daypartType; programName; DatePeriod (e.g., start date and end date). Example values are provided below:

```
<ProgramDaypart>
<TimePeriod>
      <startTime>14:20:00.0Z</startTime>
      <endTime>14:20:00.0Z</endTime>
</TimePeriod>
<Station>
      <stationCallSign>KTLA</stationCallSign>
</Station>
    <daypartType>EarlyMorning</daypartType>
    <programName>Morning News</programName>
    <dayOfWeek>text</dayOfWeek>
<DatePeriod>
      <startDate>2007-01-01</startDate>
      <endDate>2007-07-30</endDate>
</DatePeriod>
    <programDaypartID>1</programDaypartID>
    <programDaypartIDExternal>12</programDaypartIDExternal>
    <comment>sample comment</comment>
</ProgramDaypart>
```

Programming information elements will now be described, including type definitions used to represent details of a given program and its episodes.

With reference to FIG. 3N, an example AgeRating element is illustrated, including various fields used to describe a rating given by the censor board of the given programming. Different values for corresponding different types of programs are represented. An example AgeRating element includes: RatingDescription; and Rating (e.g., MPAA rating).

Example values are provided below:

```
<AgeRating>
    <RatingDescription>comment</ RatingDescription >
    <MpaaRating>24.00</MpaaRating>
</AvailPrice>
```

The example element MpaaRating includes: MoveRating (e.g., AO, G, NC-17, NR, PG, PG-13, R, X, or other rating that indicates age appropriateness).

Example values are provided below:

```
<xs:simpleType name=“MpaaRating”>
        <xs:annotation>
          <xs:documentation>represents the movie rating
          </xs:documentation>
        </xs:annotation>
        <xs:restriction base=“xs:string”>
          <xs:enumeration value=“AO”/>
          <xs:enumeration value=“G”/>
          <xs:enumeration value=“NC-17”/>
          <xs:enumeration value=“NR”/>
          <xs:enumeration value=“PG”/>
          <xs:enumeration value=“PG-13”/>
          <xs:enumeration value=“R”/>
        </xs:restriction>
</xs:simpleType>
```

The example element TVRating includes: TVRating (e.g., TVY, TVY7, TVG, TVPG, TV14, TVM), or other rating used in television that indicates age appropriateness).

Example values are provided below:

```
<xs:simpleType name=“TvRating”>
      <xs:annotation>
        <xs:documentation>represents the tv rating</xs:documentation>
      </xs:annotation>
      <xs:restriction base=“xs:string”>
        <xs:enumeration value=“TVY”/>
        <xs:enumeration value=“TVY7”/>
        <xs:enumeration value=“TVG”/>
        <xs:enumeration value=“TVPG”/>
        <xs:enumeration value=“TV14”/>
        <xs:enumeration value=“TVM”/>
      </xs:restriction>
</xs:simpleType>
```

The example element Genre includes: Genre (e.g., action, adults only, adventure, animals, etc.):

Example values are provided below:

```
      <xs:simpleType name=“Genre”>
              <xs:annotation>
                <xs:documentation>represents  the  program  info
genre</xs:documentation>
              </xs:annotation>
              <xs:restriction base=“xs:string”>
                <xs:enumeration value=“Action”/>
                <xs:enumeration value=“Adults Only”/>
                <xs:enumeration value=“Adventure”/>
                <xs:enumeration value=“Animals”/>
                <xs:enumeration value=“Animated”/>
                <xs:enumeration value=“Animated Musical”/>
                <xs:enumeration value=“Anthology”/>
                <xs:enumeration value=“Art”/>
                <xs:enumeration value=“Auto”/>
                <xs:enumeration value=“Awards”/>
                <xs:enumeration value=“Ballet”/>
                <xs:enumeration value=“Baseball”/>
                <xs:enumeration value=“Basketball”/>
                <xs:enumeration value=“Beauty”/>
                <xs:enumeration value=“Bicycle”/>
                <xs:enumeration value=“Billiards”/>
                <xs:enumeration value=“Biography”/>
                <xs:enumeration value=“Boat”/>
                <xs:enumeration value=“Bodybuilding”/>
                <xs:enumeration value=“Bowling”/>
                <xs:enumeration value=“Boxing”/>
                <xs:enumeration value=“Bus./Financial”/>
                <xs:enumeration value=“Bus./Financial Special”/>
                <xs:enumeration value=“Bus./Financial Talk”/>
                <xs:enumeration value=“Business”/>
                <xs:enumeration value=“Children”/>
                <xs:enumeration value=“Children Special”/>
                <xs:enumeration value=“Children Talk”/>
                <xs:enumeration value=“Children Music”/>
                <xs:enumeration value=“Classic”/>
                <xs:enumeration value=“Collectibles”/>
                <xs:enumeration value=“Comedy”/>
                <xs:enumeration value=“Comedy Drama”/>
                <xs:enumeration value=“Computers”/>
                <xs:enumeration value=“Cooking”/>
                <xs:enumeration value=“Crime”/>
                <xs:enumeration value=“Crime Drama”/>
                <xs:enumeration value=“Curling”/>
                <xs:enumeration value=“Dance”/>
                <xs:enumeration value=“Driving”/>
                <xs:enumeration value=“Docudrama”/>
                <xs:enumeration value=“Documentary”/>
                <xs:enumeration value=“Drama”/>
                <xs:enumeration value=“Educational”/>
                <xs:enumeration value=“Electronics”/>
                <xs:enumeration value=“Event”/>
                <xs:enumeration value=“Exercise”/>
                <xs:enumeration value=“Family”/>
                <xs:enumeration value=“Fantasy”/>
                <xs:enumeration value=“Fashion”/>
                <xs:enumeration value=“Fiction”/>
                <xs:enumeration value=“Fishing”/>
                <xs:enumeration value=“Football”/>
                <xs:enumeration value=“French”/>
                <xs:enumeration value=“Fundraiser”/>
                <xs:enumeration value=“Game”/>
                <xs:enumeration value=“Golf”/>
                <xs:enumeration value=“Gymnastics”/>
                <xs:enumeration value=“Health”/>
                <xs:enumeration value=“Historical”/>
                <xs:enumeration value=“Historical Drama”/>
                <xs:enumeration value=“Hockey”/>
                <xs:enumeration value=“Holiday”/>
                <xs:enumeration value=“Holiday Children”/>
                <xs:enumeration value=“Holiday Childrens Special”/>
                <xs:enumeration value=“Holiday Music”/>
                <xs:enumeration value=“Holiday Music Special”/>
                <xs:enumeration value=“Holiday Special”/>
                <xs:enumeration value=“Horror”/>
                <xs:enumeration value=“Horse”/>
                <xs:enumeration value=“House-Garden”/>
                <xs:enumeration value=“Housewares”/>
                <xs:enumeration value=“How-to”/>
                <xs:enumeration value=“International”/>
                <xs:enumeration value=“Interview”/>
                <xs:enumeration value=“Jewelry”/>
                <xs:enumeration value=“Lacrosse”/>
                <xs:enumeration value=“Magazine”/>
                <xs:enumeration value=“Martial Arts”/>
                <xs:enumeration value=“Medical”/>
                <xs:enumeration value=“Miniseries”/>
                <xs:enumeration value=“Motor”/>
                <xs:enumeration value=“Motorcycle”/>
                <xs:enumeration value=“Music”/>
                <xs:enumeration value=“Music Special”/>
                <xs:enumeration value=“Music Talk”/>
                <xs:enumeration value=“Musical”/>
                <xs:enumeration value=“Musical Comedy”/>
                <xs:enumeration value=“Musical Romance”/>
                <xs:enumeration value=“Mystery”/>
                <xs:enumeration value=“Nature”/>
                <xs:enumeration value=“News”/>
                <xs:enumeration value=“Non Event”/>
                <xs:enumeration value=“Olympics”/>
                <xs:enumeration value=“Opera”/>
                <xs:enumeration value=“Outdoors”/>
                <xs:enumeration value=“Parental Advisory”/>
                <xs:enumeration value=“Play”/>
                <xs:enumeration value=“Public Affairs”/>
                <xs:enumeration value=“Racing”/>
                <xs:enumeration value=“Racquet”/>
                <xs:enumeration value=“Reality”/>
                <xs:enumeration value=“Religious”/>
                <xs:enumeration value=“Rodeo”/>
                <xs:enumeration value=“Romance”/>
                <xs:enumeration value=“Romance Comedy”/>
                <xs:enumeration value=“Rugby”/>
                <xs:enumeration value=“Running”/>
                <xs:enumeration value=“Satire”/>
                <xs:enumeration value=“Science”/>
                <xs:enumeration value=“Science Fiction”/>
                <xs:enumeration value=“Self-help”/>
                <xs:enumeration value=“Shopping”/>
                <xs:enumeration value=“Situation”/>
                <xs:enumeration value=“Skating”/>
                <xs:enumeration value=“Skiing”/>
                <xs:enumeration value=“Sled Dogs”/>
                <xs:enumeration value=“Snow”/>
                <xs:enumeration value=“Soap”/>
                <xs:enumeration value=“Soap Opera”/>
                <xs:enumeration value=“Soap Special”/>
                <xs:enumeration value=“Soap Talk”/>
                <xs:enumeration value=“Soccor”/>
                <xs:enumeration value=“Softball”/>
                <xs:enumeration value=“Spanish”/>
                <xs:enumeration value=“Special”/>
                <xs:enumeration value=“Sports”/>
                <xs:enumeration value=“Sports Event”/>
                <xs:enumeration value=“Sports Non-Event”/>
                <xs:enumeration value=“Sports Talk”/>
                <xs:enumeration value=“Suspense”/>
                <xs:enumeration value=“Suspense Comedy”/>
                <xs:enumeration value=“Swimming”/>
                <xs:enumeration value=“Talk”/>
                <xs:enumeration value=“Tennis”/>
                <xs:enumeration value=“Thriller”/>
                <xs:enumeration value=“Track-Field”/>
                <xs:enumeration value=“Travel”/>
                <xs:enumeration value=“Variety”/>
                <xs:enumeration value=“Volleyball”/>
                <xs:enumeration value=“War”/>
                <xs:enumeration value=“Water”/>
                <xs:enumeration value=“Weather”/>
                <xs:enumeration value=“Western”/>
                <xs:enumeration value=“Western Comedy”/>
                <xs:enumeration value=“Wrestling”/>
              </xs:restriction>
      </xs:simpleType>
```

With reference to FIG. 3O, an example Program element is illustrated, including various fields used to describe programming. An example Program element includes: DatePeriod (e.g., start date and end date); TimePeriod (e.g., start time and end time); ProgramName; ProgramDescription; ProgramRating; PremeireDate (date program first shown); Genre; programID; programIDExternal; comment.

Example values are provided below:

```
<Program>
<DatePeriod>
          <startDate>2007-01-01</startDate>
          <endDate>2007-07-30</endDate>
</DatePeriod>
<TimePeriod>
          <startTime>14:20:00.0Z</startTime>
          <endTime>14:20:00.0Z</endTime>
</TimePeriod>
        <ProgramName>Heroes</ProgramName>
        <ProgramDescription>about the show</ProgramDescription>
        <programID>0123</programID>
        <programIDExternal>0123</ programIDExternal>
        <comment>comment</comment>
</AvailPrice>
```

With reference to FIG. 3P, an example Episode element is illustrated, including various fields used to describe an episode of a given programming. An example Episode element includes: EpisodeTitle; EpisodeDescription; EpisodeRating; Station, AirDate; TimePeriod; EpisodeType; EpisodeID; episodeIDExternal; comment.

Example values are provided below:

```
<Episode>
        <EpisodeTitle>Heroes - Heaven and Back</EpisodeTitle>
        <EpisodeDescription>about the episode</EpisodeDescription>
        <Station>
          <StationCallSign>KTLA</StationCallSign>
        </Station>
<AirDate>2007-07-30</AirDate>
<TimePeriod>
          <startTime>14:20:00.0Z</startTime>
          <endTime>14:20:00.0Z</endTime>
</TimePeriod>
        <programID>0123</programID>
        <programIDExternal>0123</ programIDExternal>
        <comment>comment</comment>
</AvailPrice>
```

Example inventory elements will now be described. The inventory definitions defined types used to represent various components or sellable unit of inventory by media owners/sellers. Example inventory elements include elements used to represent a rate for a given avail, an audience with a given rate, a unit of inventory, etc. although fewer, additional, or different elements may be used.

With reference to FIG. 3Q, an example AvailPrice element is illustrated, including various fields used to represent a rate for a given available spot. An example AvailPrice element includes: currency; value; roundingDirection; priceID; priceIDExternal; comment; DatePeriod (representing the validity period of the given rate).

Example values are provided below:

```
<AvailPrice>
        <currency>USD</currency>
        <value>24.00</value>
        <roundingDirection>none</roundingDirection>
        <priceID>1</priceID>
        <priceIDExternal>12</priceIDExternal>
<DatePeriod>
        <startDate>2007-01-01</startDate>
        <endDate>2007-07-30</endDate>
</DatePeriod>
</AvailPrice>
```

With reference to FIG. 3R, an example AvailAudience element is illustrated, including various fields used to represent an audience with a given rate (e.g., to represent the CPP for the demo specified in the Audience). An example AvailAudience element includes: Demo; rating; AudienceCell; Book; audienceID; audienceIDExternal; comment; AvailPrice; DatePeriod; rationale.

Example values are provided below:

```
<AvailAudience>
        <Demo>
          <demoName>RA1854</demoName>
          <demoType>RTG</demoType>
          <demoGroup>Adults</demoGroup>
          <ageFrom>18</ageFrom>
          <ageTo>54</ageTo>
          <demoID>1</demoID>
          <demoIDExternal>12</demoIDExternal>
          <comment>sample comment</comment>
        </Demo>
        <Book>
          <bookType>Standard</bookType>
          <shareBook>MAY06 C-DMA Nielsen</shareBook>
          <pUTBook> JUN05 C-DMA Nielsen </pUTBook>
          <bookID>1</bookID>
          <bookIDExternal>12</bookIDExternal>
          <comment>sample comment</comment>
        </Book>
        <AudienceCell>
          <hUTPUT>100000</hUTPUT>
          <share>.48</share>
          <universe>150000</universe>
          <audienceCellID>1</audienceCellID>
          <audienceCellIDExternal>12</audienceCellIDExternal>
          <comment>sample comment</comment>
        </Audience>
        <audienceID>1</audienceID>
        <audienceIDExternal>12</audienceIDExternal>
        <comment>sample comment</comment>
<AvailPrice>
<currency>USD</currency>
<value>24.00</value>
<roundingDirection>none</roundingDirection>
<priceID>1</priceID>
<priceIDExternal>12</priceIDExternal>
<DatePeriod>
        <startDate>2007-01-01</startDate>
        <endDate>2007-07-30</endDate>
        <datePeriodID>1</datePeriodID>
        <datePeriodIDExternal>1</datePeriodIDExternal>
</DatePeriod>
</AvailPrice>
<rationale>some reason</rationale>
</AvailAudience>
```

Avail represents a unit of inventory (e.g., from media owners/sellers), including a list of ProgramDayparts that represent a set of spots. A given Program Daypart has an AirPeriod that it runs in, the type of spots and the total number of spots. Optionally, the rate for these units is represented as CPS. Ratings and CPP are provided for a given demo. By way of example, a set for Avail rates and ratings can include the AvailAudience data for corresponding Nielsen demo ranges (e.g., Nielsen demo ranges).

With reference to FIG. 3S, an example availability (Avail) element is illustrated, including various fields used to represent a unit of inventory. An example Avail element includes: ProgramDayPart; DatePeriod; Spot; AvailPrice; AvailAudience; numberOfSpots; availID.

Example values are provided below:

```
<Avail>
<ProgramDaypart>
<Station>
          <stationCallSign>KTLA</stationCallSign>
</Station>
        <daypart>EarlyMorning</daypart>
        <programName>Morning News</programName>
        <dayOfWeek>text</dayOfWeek>
<DatePeriod>
          <startDate>2007-01-01</startDate>
          <endDate>2007-07-30</endDate>
</DatePeriod>
<TimePeriod>
          <startTime>14:20:00.0Z</startTime>
          <endTime>14:20:00.0Z</endTime>
</TimePeriod>
</ProgramDaypart>
<DatePeriod>
          <startDate>2007-01-01</startDate>
          <endDate>2007-07-30</endDate>
</DatePeriod>
        <Spot>
          <spotType>Commercial</spotType>
          <spotlength>30</spotlength>
        </Spot>
<AvailPrice>
        <currency>USD</currency>
        <value>24.00</value>
        <roundingDirection>none</roundingDirection>
<DatePeriod>
          <startDate>2007-01-01</startDate>
          <endDate>2007-07-30</endDate>
</DatePeriod>
</AvailPrice>
<AvailAudience>
        <Demo>
          <demoName>RA1854</demoName>
        </Demo>
        <Book>
          <shareBook>MAY06 C-DMA Nielsen</shareBook>
          <pUTBook> JUN05 C-DMA Nielsen</pUTBook>
        </Book>
        <AudienceCell>
          <hUTPUT>100000</hUTPUT>
          <share>.48</share>
          <universe>150000</universe>
        </Audience>
<AvailPrice>
<currency>USD</currency>
<value>24.00</value>
<roundingDirection>none</roundingDirection>
<DatePeriod>
                <startDate>2007-01-01</startDate>
                <endDate>2007-07-30</endDate>
</DatePeriod>
</AvailPrice>
</AvailAudience>
<numberOfSpots>25</numberOfSpots>
        <availID>1</availID>
        <availIDExternal>12</availIDExternal>
        <comment>some comment</comment>
</Avail>
```

Global—Media Elements will now be described. The Inventory definitions define types to represent various components of a sellable unit of inventory (e.g., by media owners/sellers).

The element “Preference” represents a generic qualitative preference during selection. With reference to FIG. 3T, an example Preference element is illustrated, including various fields used to represent a generic qualitative preference. An example Preference element includes: PreferenceType (e.g., acceptable, blocked, not acceptable; preferred); PreferenceID. PreferenceIDExternal; comments.

Example values are provided below:

<Preference>
<PreferenceType>Acceptable</PreferenceType>
</AvailAudience>

Example values for Preference Type are provided below:

<xs:simpleType name=“PreferenceType”>

<xs:annotation>

<xs:documentation>Preferencetypes</xs:documentation>

</xs:annotation>
<xs:restriction base=“xs:string”>

<xs:enumeration value=“Acceptable”/>
<xs:enumeration value=“Blocked”/>
<xs:enumeration value=“Preferred”/>

</xs:restriction>

</xs:simpleType>

The element “ValueAllocation” represents a value and its type for the given target. With reference to FIG. 3U (ValueAllocation), an example element is illustrated, including various fields used to represent a value and its type. An example ValueAllocation element includes: ValueAllocationID; Value; ShowValue; AllocationType (e.g., CPP, CPM, Budget, GRP, Impressions, TRP, Rate, Ratings, Spots; ValueAllocationIDExternal; comments.

Example values for ValueAllocation are provided below:

<ValueAllocation>
<Value>1.3</Value>
<AllocationType>TRP</AllocationType>
</ValueAllocation>

Example values for AllocationType are provided below:

```
<xs:simpleType name=“AllocationType”>
        <xs:annotation>
          <xs:documentation>Allocation types</xs:documentation>
        </xs:annotation>
        <xs:restriction base=“xs:string”>
          <xs:enumeration value=“CPP”/>
          <xs:enumeration value=“CPM”/>
          <xs:enumeration value=“Budget”/>
          <xs:enumeration value=“GRP”/>
          <xs:enumeration value=“Impressions”/>
          <xs:enumeration value=“TRP”/>
          <xs:enumeration value=“Rate”/>
          <xs:enumeration value=“Ratings”/>
          <xs:enumeration value=“Spots”/>
        </xs:restriction>
</xs:simpleType>
```

The element “DailyValueAllocation” represents a ValueAllocation for a given date. With reference to FIG. 3V, an example DailyValueAllocation element is illustrated, including various fields used to represent a value and its type. An example DailyValueAllocation element includes: ValueAllocationID; Value; ShowValue; AllocationType (e.g., CPP, CPM, Budget, GRP, Impressions, TRP, Rate, Ratings, Spots; ValueAllocationIDExternal; comments.

Example values for DailyValueAllocation are provided below:

<DailyValueAllocation>
<Value>1.3</Value>
<AllocationType>TRP</AllocationType>
<Date>2008-03-04</Date>
</DailyValueAllocation>

The element “WeeklyValueAllocation” represents a ValueAllocation for a given WEEK. With reference to FIG. 3W, an example WeeklyValueAllocation element is illustrated. An example WeeklyValueAllocation element includes: ValueAllocationID; Value; ShowValue; AllocationType (e.g., CPP, CPM, Budget, GRP, Impressions, TRP, Rate, Ratings, Spots; ValueAllocationIDExternal; comments; Week.

Example values for WeeklyValueAllocation are provided below:

```
<WeeklyValueAllocation>
<Value>1.3</Value>
<AllocationType>TRP</AllocationType>
<DatePeriod>
        <startDate>2007-01-01</startDate>
        <endDate>2007-07-30</endDate>
</DatePeriod>
</WeeklyValueAllocation>
```

Example values for AllocationPeriodType are provided below:

```
<xs:simpleType name=“AllocationPeriodType”>
      <xs:annotation>
        <xs:documentation>Allocation period types</xs:documentation>
      </xs:annotation>
      <xs:restriction base=“xs:string”>
        <xs:enumeration value=“Daily”/>
        <xs:enumeration value=“Weekly”/>
      </xs:restriction>
</xs:simpleType>
```

The element “MarketDetail” represents a values for a given market (e.g., including qualititative and quantitative value selections). With reference to FIG. 3X (including FIGS. 3X1-3X4), an example MarketDetail element is illustrated. An example MarketDetail element includes: MarketDetailID; MarketDetailExternalID; Comments; Market; marketcode; ProgramPreferences; StationPreferences; FlightDates; AllocationPeriodType; TotalAllocations; MediaDetail; Media; DayPartDetail; DayPartDetail; RatingsSourceType; BroadcastDaysOfWeek; StationCallSign.

Example values for MarketDetail are provided below:

```
<MarketDetail>
        <MarketDetailID>0</MarketDetailID>
        <MarketDetailExternalID>0</MarketDetailExternalID>
        <Comments>String</Comments>
        <Market>
          <marketCode>String</marketCode>
        </Market>
        <ProgramPreferences>
          <PreferenceType>Acceptable</PreferenceType>
          <ProgramName>String</ProgramName>
        </ProgramPreferences>
        <StationPreferences>
          <PreferenceType>Acceptable</PreferenceType>
          <StationCallSign>String</StationCallSign>
        </StationPreferences>
        <FlightDates>
          <startDate>1967-08-13</startDate>
          <endDate>1967-08-13</endDate>
        </FlightDates>
        <AllocationPeriodType>Daily</AllocationPeriodType>
        <TotalAllocations>
          <Value>0.0</Value>
          <ShowValue>true</ShowValue>
          <AllocationType>TRP</AllocationType>
        </TotalAllocations>
        <MediaDetail>
          <Media>
              <mediaType>LocalBroadcast</mediaType>
          </Media>
          <StartDayOfWeek>Monday</StartDayOfWeek>
          <DayPartDetail>
              <DayPartType>EarlyMorning</DayPartType>
              <TotalAllocations>
                  <Value>0.0</Value>
                  <ShowValue>true</ShowValue>
                  <AllocationType>TRP</AllocationType>
              </TotalAllocations>
              <SpotDetail>
                  <TotalAllocation>
                      <Value>0.0</Value>
                      <ShowValue>true</ShowValue>
                      <AllocationType>TRP</AllocationType>
                  </TotalAllocation>
                  <Spots>
                      <spotType>Commercial</spotType>
                      <spotlength>30</spotlength>
                  </Spots>
                  <DailyAllocation>
                      <Value>0.0</Value>
                      <ShowValue>true</ShowValue>
                      <AllocationType>CPP</AllocationType>
                      <Date>1967-08-13</Date>
                  </DailyAllocation>
                  <AirTimePeriod>
                      <startTime>14:20:00.0Z</startTime>
                      <endTime>14:20:00.0Z</endTime>
                  </AirTimePeriod>
        <RatingsSourceType>RatingsBook</RatingsSourceType>
        <BroadcastDaysOfWeek>Monday</BroadcastDaysOfWeek>
                  <Book>
                      <shareBook>String</shareBook>
                      <pUTBook>String</pUTBook>
                  </Book>
                  <ProgramDayPart>
                      <dayOfWeek>Monday</dayOfWeek>
                      <TimePeriod>
                          <startTime>14:20:00.0Z</startTime>
                          <endTime>14:20:00.0Z</endTime>
                      </TimePeriod>
                      <Station>
        <StationCallSign>String</StationCallSign>
                      </Station>
                      <daypartType>EarlyMorning</daypartType>
                      <programName>String</programName>
                      <DatePeriod>
                          <startDate>1967-08-13</startDate>
                          <endDate>1967-08-13</endDate>
                      </DatePeriod>
                  </ProgramDayPart>
                  <SpotDetailType>Standard</SpotDetailType>
              </SpotDetail>
          </DayPartDetail>
        </MediaDetail>
</MarketDetail>
```

Example values for SpotDetailType (used to specify if the given spot is assigned as a part of the order or if its makegood adjusted) are provided below:

```
<xs:simpleType name=“SpotDetailType”>
    <xs:annotation>
      <xs:documentation>Spot detail types</xs:documentation>
    </xs:annotation>
    <xs:restriction base=“xs:string”>
      <xs:enumeration value=“Standard”/>
      <xs:enumeration value=“Makegood”/>
    </xs:restriction>
</xs:simpleType>
```

Example avail request/response elements will now be described. The element “AvailRequest” represents an avail request from a given agency to a media seller. With reference to FIG. 3Y, an example AvailRequest element is illustrated. An example AvailRequest element includes: AvailRequestID; AvailRequestExternalID; Comments; Demo; AvailRequestStatus; Estimate; ProductCode; FlightDates; ExpirationDate; StartDayOfWeel; HiatusPeriodMarketDetail.

Example values for AvailRequest are provided below:

```
<AvailRequest>
    <AvailRequestID>0</AvailRequestID>
    <AvailRequestIDExternal>String</AvailRequestIDExternal>
    <Comments>String</Comments>
    <Demo>
      <demoName>String</demoName>
    </Demo>
    <AvailRequestStatus>New</AvailRequestStatus>
    <Estimate>String</Estimate>
    <ProductCode>String</ProductCode>
    <FlightDates>
      <startDate>1967-08-13</startDate>
      <endDate>1967-08-13</endDate>
    </FlightDates>
    <ExpirationDate>1967-08-13</ExpirationDate>
    <StartDayOfWeek>Monday</StartDayOfWeek>
    <HiatusPeriod>
      <startDate>1967-08-13</startDate>
      <endDate>1967-08-13</endDate>
    </HiatusPeriod>
    <MarketDetail>
      <Market>
        <marketCode>String</marketCode>
      </Market>
      <ProgramPreferences>
        <PreferenceType>Acceptable</PreferenceType>
        <ProgramName>String</ProgramName>
      </ProgramPreferences>
      <StationPreferences>
        <PreferenceType>Acceptable</PreferenceType>
        <StationCallSign>String</StationCallSign>
      </StationPreferences>
      <FlightDates>
        <startDate>1967-08-13</startDate>
        <endDate>1967-08-13</endDate>
      </FlightDates>
      <AllocationPeriodType>Daily</AllocationPeriodType>
      <TotalAllocations>
        <Value>0.0</Value>
        <ShowValue>true</ShowValue>
        <AllocationType>CPP</AllocationType>
      </TotalAllocations>
      <MediaDetail>
        <Media>
          <mediaType>LocalBroadcast</mediaType>
        </Media>
        <StartDayOfWeek>Monday</StartDayOfWeek>
        <DayPartDetail>
          <DayPartType>EarlyMorning</DayPartType>
          <TotalAllocations>
            <Value>0.0</Value>
            <ShowValue>true</ShowValue>
            <AllocationType>CPP</AllocationType>
          </TotalAllocations>
          <SpotDetail>
            <TotalAllocation>
              <Value>0.0</Value>
              <ShowValue>true</ShowValue>
  <AllocationType>CPP</AllocationType>
            </TotalAllocation>
            <Spots>
              <spotType>Commercial</spotType>
              <spotlength>30</spotlength>
            </Spots>
            <DailyAllocation>
              <Value>0.0</Value>
              <ShowValue>true</ShowValue>
  <AllocationType>CPP</AllocationType>
              <Date>1967-08-13</Date>
            </DailyAllocation>
            <AirTimePeriod>
              <startTime>14:20:00.0Z</startTime>
              <endTime>14:20:00.0Z</endTime>
            </AirTimePeriod>
  <RatingsSourceType>RatingsBook</RatingsSourceType>
  <BroadcastDaysOfWeek>Monday</BroadcastDaysOfWeek>
              <Book>
                <shareBook>String</shareBook>
                <pUTBook>String</pUTBook>
              </Book>
              <ProgramDayPart>
                <dayOfWeek>Monday</dayOfWeek>
                <TimePeriod>
  <startTime>14:20:00.0Z</startTime>
  <endTime>14:20:00.0Z</endTime>
                </TimePeriod>
                <Station>
  <StationCallSign>String</StationCallSign>
                </Station>
  <daypartType>EarlyMorning</daypartType>
                <programName>String</programName>
                <DatePeriod>
                  <startDate>1967-08-13</startDate>
                  <endDate>1967-08-13</endDate>
              </DatePeriod>
              </ProgramDayPart>
            <SpotDetailType>Standard</SpotDetailType>
          </SpotDetail>
        </DayPartDetail>
      </MediaDetail>
    </MarketDetail>
</AvailRequest>
```

Example AvailRequestStatus element values are provided below:

```
<xs:simpleType name=“AvailRequestStatus”>
    <xs:annotation>
      <xs:documentation>AvailRequest statuses</xs:documentation>
    </xs:annotation>
    <xs:restriction base=“xs:string”>
      <xs:enumeration value=“New”/>
    </xs:restriction>
</xs:simpleType>
```

The element “AvailResponse” represents a response from a media seller on an avail request. With reference to FIG. 3Z, an example AvailResponse element is illustrated. An example AvailResponse element includes: AvailResponseID; AvailResponseExternalID; Comments; Demo; AvailResponseStatus; ExpirationDate; Avail.

Example values for AvailResponse are provided below:

```
<AvailResponse>
    <AvailResponseID>0</AvailResponseID>
    <AvailResponseIDExternal>String</AvailResponseIDExternal>
    <Comments>String</Comments>
    <AvailResponseStatus>New</AvailResponseStatus>
    <AvailRequestID>0</AvailRequestID>
    <ExpirationDate>1967-08-13</ExpirationDate>
    <Avail>
    <ProgramDaypart>
      <dayOfWeek>Monday</dayOfWeek>
      <TimePeriod>
        <startTime>14:20:00.0Z</startTime>
        <endTime>14:20:00.0Z</endTime>
      </TimePeriod>
      <Station>
        <StationCallSign>String</StationCallSign>
      </Station>
      <daypartType>EarlyMorning</daypartType>
      <programName>String</programName>
      <DatePeriod>
        <startDate>1967-08-13</startDate>
        <endDate>1967-08-13</endDate>
      </DatePeriod>
    </ProgramDaypart>
    <Spot>
      <spotType>Commercial</spotType>
      <spotlength>30</spotlength>
    </Spot>
    <AvailPrice>
      <currency>USD</currency>
      <value>2000</value>
      <roundingDirection>none</roundingDirection>
      <DatePeriod>
        <startDate>1967-08-13</startDate>
        <endDate>1967-08-13</endDate>
      </DatePeriod>
    </AvailPrice>
    <numberOfSpots>2</numberOfSpots>
      <availIDExternal>1</availIDExternal>
    </Avail>
</AvailResponse>
```

Example values for the AvailResponseStatus element are provided below:

```
<xs:simpleType name=“AvailResponseStatus”>
    <xs:annotation>
      <xs:documentation>AvailResponse statuses</xs:documentation>
    </xs:annotation>
    <xs:restriction base=“xs:string”>
      <xs:enumeration value=“New”/>
    </xs:restriction>
</xs:simpleType>
```

Example order definitions (e.g., used to exchange orders between the integrating systems) will now be described.

The element “Order” represents a media order for a specific seller. With reference to FIG. 3AA, an example Order element is illustrated. An example Order element includes: OrderID; OrderExternalID; Comments; Book; Demo; OrderStatus; Estimate; ProductCode; FlightDates; ExperationDate; StartDayOfWeek; HiatusPeriod; MakeGoodPolicy; MarketDetail.

Example values for Order are provided below:

```
<Order>
    <OrderID>0</OrderID>
    <OrderIDExternal>0</OrderIDExternal>
    <Comments>String</Comments>
    <Book>
      <shareBook>String</shareBook>
      <pUTBook>String</pUTBook>
    </Book>
    <Demo>
      <demoName>String</demoName>
    </Demo>
    <OrderStatus>New</OrderStatus>
    <Estimate>String</Estimate>
    <ProductCode>String</ProductCode>
    <FlightDates>
      <startDate>1967-08-13</startDate>
      <endDate>1967-08-13</endDate>
    </FlightDates>
    <ExpirationDate>1967-08-13</ExpirationDate>
    <StartDayOfWeek>Monday</StartDayOfWeek>
    <HiatusPeriod>
      <startDate>1967-08-13</startDate>
      <endDate>1967-08-13</endDate>
    </HiatusPeriod>
    <MakegoodPolicy>String</MakegoodPolicy>
    <MarketDetail>
      <Market>
        <marketCode>String</marketCode>
      </Market>
      <ProgramPreferences>
        <PreferenceType>Acceptable</PreferenceType>
        <ProgramName>String</ProgramName>
      </ProgramPreferences>
      <StationPreferences>
        <PreferenceType>Acceptable</PreferenceType>
        <StationCallSign>String</StationCallSign>
      </StationPreferences>
      <FlightDates>
        <startDate>1967-08-13</startDate>
        <endDate>1967-08-13</endDate>
    </FlightDates>
    <AllocationPeriodType>Daily</AllocationPeriodType>
    <TotalAllocations>
        <Value>0.0</Value>
        <ShowValue>true</ShowValue>
        <AllocationType>CPP</AllocationType>
    </TotalAllocations>
    <MediaDetail>
        <Media>
          <mediaType>LocalBroadcast</mediaType>
        </Media>
        <StartDayOfWeek>Monday</StartDayOfWeek>
        <DayPartDetail>
          <DayPartType>EarlyMorning</DayPartType>
          <TotalAllocations>
            <Value>0.0</Value>
            <ShowValue>true</ShowValue>
            <AllocationType>CPP</AllocationType>
          </TotalAllocations>
          <SpotDetail>
            <TotalAllocation>
              <Value>0.0</Value>
              <ShowValue>true</ShowValue>
    <AllocationType>CPP</AllocationType>
            </TotalAllocation>
            <Spots>
              <spotType>Commercial</spotType>
              <spotlength>30</spotlength>
            </Spots>
            <DailyAllocation>
              <Value>0.0</Value>
              <ShowValue>true</ShowValue>
    <AllocationType>CPP</AllocationType>
              <Date>1967-08-13</Date>
            </DailyAllocation>
            <AirTimePeriod>
              <startTime>14:20:00.0Z</startTime>
              <endTime>14:20:00.0Z</endTime>
            </AirTimePeriod>
    <RatingsSourceType>RatingsBook</RatingsSourceType>
    <BroadcastDaysOfWeek>Monday</BroadcastDaysOfWeek>
            <ProgramDayPart>
              <dayOfWeek>Monday</dayOfWeek>
              <TimePeriod>
    <startTime>14:20:00.0Z</startTime>
    <endTime>14:20:00.0Z</endTime>
              </TimePeriod>
              <Station>
    <StationCallSign>String</StationCallSign>
              </Station>
    <daypartType>EarlyMorning</daypartType>
              <programName>String</programName>
              <DatePeriod>
                <startDate>1967-08-13</startDate>
                <endDate>1967-08-13</endDate>
              </DatePeriod>
            </ProgramDayPart>
            <SpotDetailType>Standard</SpotDetailType>
          </SpotDetail>
        </DayPartDetail>
      </MediaDetail>
    </MarketDetail>
</Order>
```

The element “Makegood” represents an offer on the order spots that could not be or was not delivered. The offer is within makegood policies/rules (e.g., defined by the seller or by a contract between the buyer and seller). With reference to FIG. 3BB, an example Makegood element is illustrated. An example Makegood element includes: MakegoodID; MakegoodExternalID; Comments; OrderID; MakegoodReason; MakegoodReasonNotes; is Expired; ExpirationDateTime; OrderBuylines; MakegoodBuylines.

Example values for Makegood are provided below:

```
  <Makegood>
      <MakegoodID>0</MakegoodID>
      <MakegoodIDExternal>0</MakegoodIDExternal>
      <Comments>String</Comments>
      <OrderID>0</OrderID>
      <MakegoodReason>UnderDeliveryOfWeight</MakegoodReason>
      <MakegoodReasonNotes>Actual rating was 1.2 insteadvertisement
of promised 2.1</MakegoodReasonNotes>
      <isExpired>false</isExpired>
      <ExpirationDateTime>2009-12-
      17T09:30:47.0Z</ExpirationDateTime>
      <OrderBuylines>
        <MarketDetailID>10</MarketDetailID>
        <Market>
          <marketName>Boston</marketName>
        </Market>
        <AllocationPeriodType>Daily</AllocationPeriodType>
        <MediaDetail>
          <Media>
            <mediaType>LocalBroadcast</mediaType>
          </Media>
          <DayPartDetail>
            <DayPartType>EarlyMorning</DayPartType>
            <SpotDetail>
              <Spots>
                <spotType>Commercial</spotType>
                <spotlength>30</spotlength>
              </Spots>
              <DailyAllocation>
                <Value>2</Value>
      <AllocationType>Spots</AllocationType>
              </DailyAllocation>
              <ProgramDayPart>
                <dayOfWeek>Monday</dayOfWeek>
                <TimePeriod>
      <startTime>14:20:00.0Z</startTime>
      <endTime>14:20:00.0Z</endTime>
                </TimePeriod>
                <Station>
      <StationCallSign>String</StationCallSign>
                </Station>
      <daypartType>EarlyMorning</daypartType>
                <programName>String</programName>
                <DatePeriod>
                  <startDate>2008-08-
13</startDate>
                  <endDate>2008-08-
13</endDate>
                </DatePeriod>
              </ProgramDayPart>
              <SpotDetailType>Standard</SpotDetailType>
            </SpotDetail>
          </DayPartDetail>
        </MediaDetail>
      </OrderBuylines>
      <MakegoodBuylines>
        <Market>
          <marketCode>String</marketCode>
        </Market>
        <MediaDetail>
          <Media>
            <mediaType>LocalBroadcast</mediaType>
          </Media>
          <DayPartDetail>
            <DayPartType>EarlyMorning</DayPartType>
            <SpotDetail>
              <Spots>
                <spotType>Commercial</spotType>
                <spotlength>30</spotlength>
              </Spots>
              <DailyAllocation>
                <Value>1</Value>
      <AllocationType>Spots</AllocationType>
              </DailyAllocation>
              <AirTimePeriod>
                <startTime>14:20:00.0Z</startTime>
                <endTime>14:20:00.0Z</endTime>
              </AirTimePeriod>
              <ProgramDayPart>
                <dayOfWeek>Monday</dayOfWeek>
                <TimePeriod>
      <startTime>14:20:00.0Z</startTime>
      <endTime>14:20:00.0Z</endTime>
                </TimePeriod>
                <Station>
      <StationCallSign>String</StationCallSign>
                </Station>
      <daypartType>EarlyMorning</daypartType>
                <programName>String</programName>
                <DatePeriod>
                  <startDate>1967-08-
13</startDate>
                  <endDate>1967-08-
13</endDate>
                </DatePeriod>
              </ProgramDayPart>
              <SpotDetailType>Makegood</SpotDetailType>
            </SpotDetail>
          </DayPartDetail>
        </MediaDetail>
      </MakegoodBuylines>
  </Makegood>
```

Example values for MakegoodReason are provided below:

```
<xs:simpleType name=“MakegoodReason”>
    <xs:annotation>
      <xs:documentation>Makegood reasons</xs:documentation>
    </xs:annotation>
    <xs:restriction base=“xs:string”>
      <xs:enumeration value=“Unknown”/>
      <xs:enumeration value=“Preempted”/>
      <xs:enumeration value=“MissedSpots”/>
      <xs:enumeration value=“SpotsAiredImproperly”/>
      <xs:enumeration value=“PoorReplacement”/>
      <xs:enumeration value=“InequitableRotations”/>
      <xs:enumeration value=“UnderDeliveryOfWeight”/>
      <xs:enumeration value=“Other”/>
    </xs:restriction>
</xs:simpleType>
```

Example order stewardship definitions (e.g., used during order/fulfillment tracking between the integrating systems) will now be described.

The element “TrafficLog” represents a run detail record of an ordered program. With reference to FIG. 3CC, an example TrafficLog element is illustrated. An example TrafficLog element includes: TrafficLogID; TrafficLogExternalID; Comments; OrderID; ProgramdayPart; ActualAirDate; ActualAirTime; ProgramType.

Example values for TrafficLog element are provided below:

```
<TrafficLog>
    <TrafiicLogID>0</TrafiicLogID>
    <TrafficLogIDExternal>0</TrafficLogIDExternal>
    <Comments>String</Comments>
    <OrderID>10</OrderID>
    <ProgramDaypart>
      <TimePeriod>
        <startTime>14:20:00.0Z</startTime>
        <endTime>14:20:00.0Z</endTime>
      </TimePeriod>
      <Station>
        <stationCallSign>KTLA</stationCallSign>
      </Station>
      <daypartType>EarlyMorning</daypartType>
      <programName>Morning News</programName>
      <dayOfWeek>text</dayOfWeek>
      <DatePeriod>
        <startDate>2007-01-01</startDate>
        <endDate>2007-07-30</endDate>
      </DatePeriod>
    </ProgramDaypart>
    <ActualAirDate>
      <startDate>2008-08-13</startDate>
      <endDate>2008-08-13</endDate>
    </ActualAirDate>
    <ActualAirTime>
      <startTime>14:20:00.0Z</startTime>
      <endTime>14:20:00.0Z</endTime>
    </ActualAirTime>
    <ProgramType>Movie</ProgramType>
</TrafficLog>
```

Example values for ProgramType are provided below:

```
<xs:simpleType name=“ProgramType”>
    <xs:annotation>
      <xs:documentation>Program Type</xs:documentation>
    </xs:annotation>
    <xs:restriction base=“xs:string”>
      <xs:enumeration value=“Unknown”/>
      <xs:enumeration value=“Show”/>
      <xs:enumeration value=“Movie”/>
      <xs:enumeration value=“Sports”/>
    </xs:restriction>
</xs:simpleType>
```

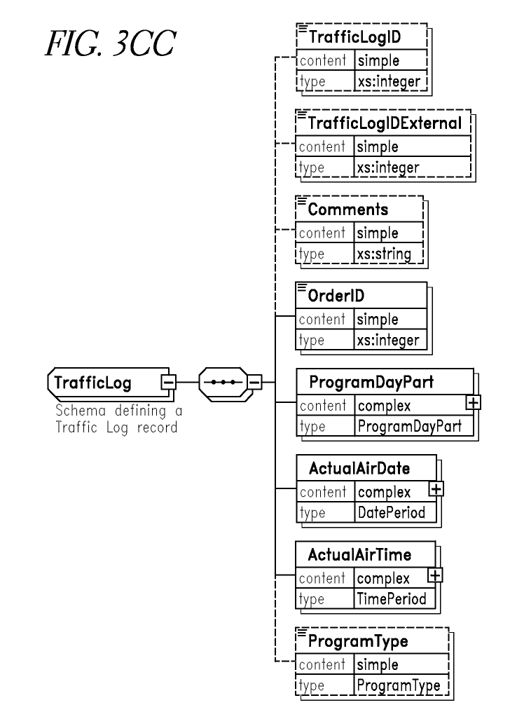

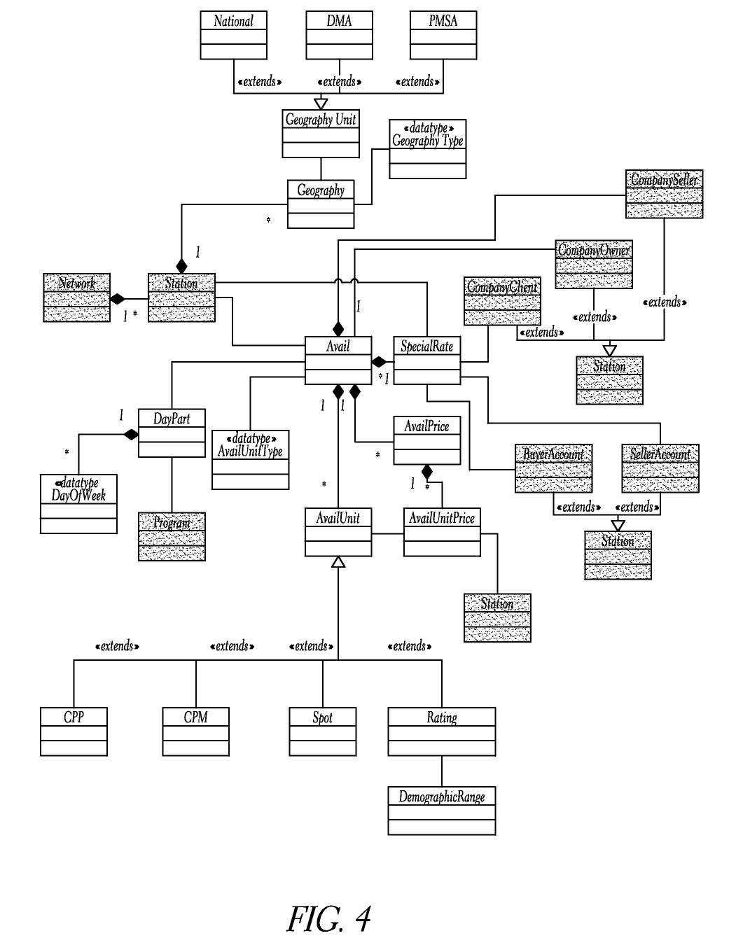

FIG. 4 illustrates the interrelationships/associations of elements discussed above. As can be seen, the elements are optionally hierarchical in nature.

As previously discussed certain embodiments provide a system (e.g., a media marketplace inventory management engine) which enables integration of inventory from disparate buyers and sellers.

An example embodiment imports inventory data from a multiplicity of sources into a unified repository (e.g., stored in one or more databases hosted by one or more servers). The stored data can then be exposed/provided in one or more formats, as appropriate or desired. For example, the seller inventor schema can be mapped to the system M3l schema. For example, importing software imports inventory feeds (e.g., rating, rates and/or programming databases) from one or more inventory sources using the predefined mapping between seller inventory and M3L. The mapped data is then stored in a repository (e.g., a centralized or decentralized database). The stored data is then utilized for one or more of the following purposes.

1. Import into a unified repository that can then expose this data in various formats as appropriate. Inventory, rating, rates and/or programming information is imported into appropriate databases. Mapping of the seller inventory schema and the system M3L schema is performed. Importers import the inventory feeds using the predefined mapping between seller inventory and M3L. Data is obtained and filled in using rating, rates and/or programming databases and is stored in a repository (e.g., a centralized database) where it can be used for various purposes, including, but not limited to, some or all of the following:

a. Convert to summary tables and use in conjunction with the marketplace engine system;

b. Merge feeds from various sources to provide high quality data for enhanced experience;

c. Expose as XML feeds for interested parties using M3L;

d. Reporting, Trending and Data Mining and/or Analysis.

Optionally, as similarly described above, a reverse integration process enables sold inventory data to be updated back into seller systems.

2. Integrate other data that needs to be transferred in either direction as required by the media marketplace engine (e.g. avail requests/responses, orders, traffic instructions, traffic logs, make-goods, invoices etc.).

3. Support adjustable workflows for expected flow of information between various buyer and seller systems.

4. Media Inventory can be accepted for various media types (example: TV, Print, online advertisement space, radio). Inventory can be as detailed as but not limited to:

a. Spots on programs

b. Spots in Dayparts

c. Spots in Clusters

d. Spots in Daypart+network

e. Radio spots

f. Advertisement placement space in print media

g. Advertisement placement space in online media with format, above fold, below fold placement, specified page placement.

5. Automated inventory feeds with inventory availability and allocation and re-allocation updates and re-pricing and re-rating updates. Dynamic integration between the inventory management system and seller and buyer inventory management systems.

6. Human upload of inventory updates.

7. Rich Web user interface enabling browsing, sorting and searching of inventory by parameters and values for example but not limited to some or all of the following:

i. Daypart

ii. Web page

iii. Program

iv. Price

v. Format

vi. Station

vii. Cluster name

8. Spot or Advertisement Space Allocation Server. Detailed allocation of spots or other advertisement space is provided a spot allocation server. Aggregated inventory such as Daypart, Cluster or Package can be allocated through the spot allocation server.

Thus, a unified solution for representation and information transfer of media inventory information is optionally provided. An example Inventory schema is outlined below.

Example methods and systems for a multi-vendor/multi-survey audience compositing system will now be described.

An example embodiment provides a compositing system (e.g., a multi-vendor/multi-survey audience compositing system).

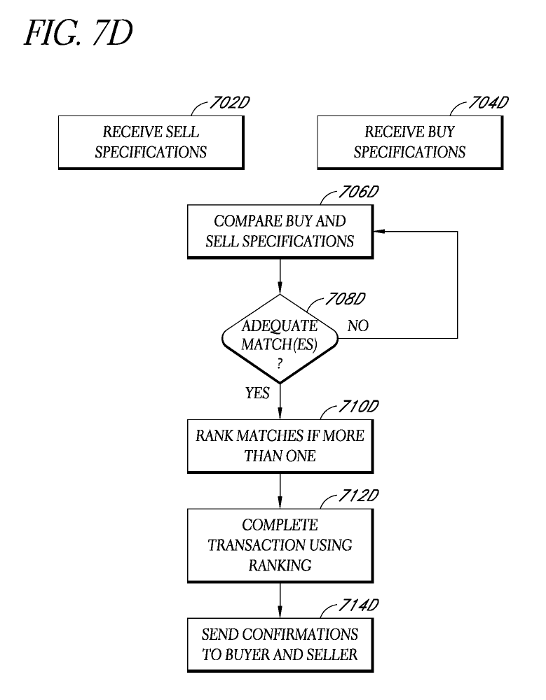

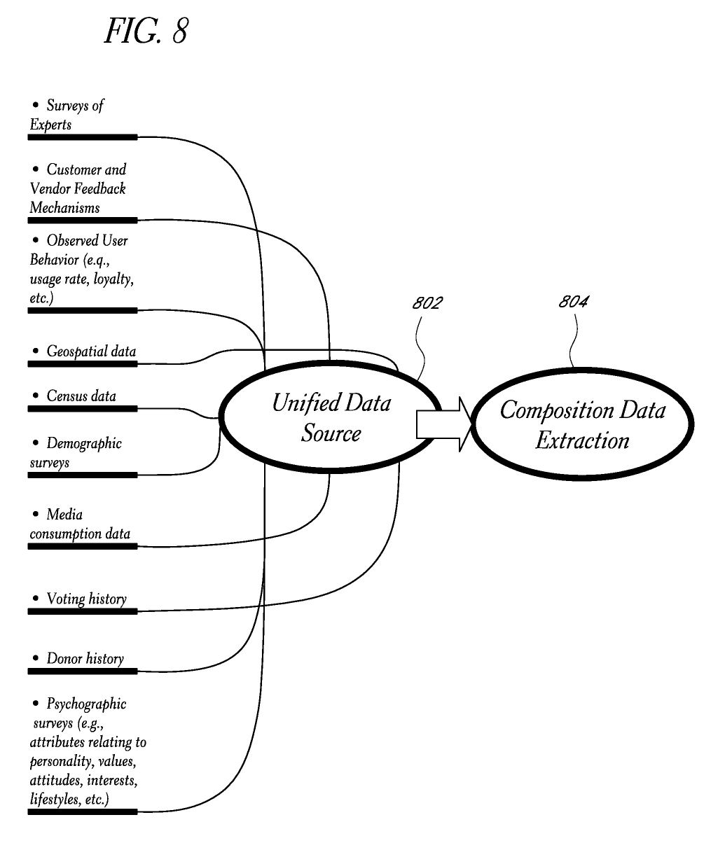

In an example embodiment, the compositing system aggregates information from media and market research data sources from multiple vendors, optionally at a variety of layers of aggregation (e.g., consumer segment, media segment, geography, timing, etc). With reference to FIG. 8, the audience compositing system combines some or all of these multiple data sources into a unified data source, and extracts and combines the significance of components thereof to form a composite which exceeds the statistical value of the components individually. The data can be collected electronically (e.g., by accessing data stores storing the data over a network or locally), converted (e.g., using optical character recognition (OCR)) from a printed documented, hand entered, and/or otherwise received.

In this example embodiment, the system includes or accesses a scalable unified data source engine that can, in substantially real-time automatically or partially automatically and partially manually aggregate and/or sub-set the survey metadata of an audience or a sub-set of an audience to establish a composite that is statistically valuable and unique. This enables the system to enhance or maximize the composite data generated from multiple data and vendor sources which can provide a new set or sub-set of valuable data as related but not limited to behaviors, consumer trends and feedback analysis of an audience or a subset of an audience.

The subject embodiment relates to but is not limited to television programs, radio programs, print and other advertisement marketing research and behavior analysis sources or vendors thereof; is not limited to viewer survey and response systems, to collecting, collating and evaluating advertisement and program research data, including operation of viewer evaluation and response panels, and to systems of census and other collected survey data as relates to individual or group behavior and other audience survey data sources.

The subject embodiment provides a method and system for aggregating and compositing varied and disparate audience survey data sources that some individual significance. It also provides a method by which user can access technical and analytical data that has been converted to a simplified or composite data set thus allowing them to generate independent, unique, accurate and more significantly informed decisions based upon this generated aggregate data.

In one or more examples of this embodiment, this composite or aggregation is achieved wherein the multiple data sources are weighted according to significance, importance and other characteristics as determined to be necessary by experts or other determiners related to, but not limited to, the individual data sources therein. This weighting, ranking or ordering can be and achieved in numerous ways and is not limited to Bayesian probabilistic determination, fuzzy logic weighting, or other statistical or mathematical methods. In an example embodiment, the result of the aggregation or sub-set of aggregation provides a possible result set, achieved through weightings, algorithms and/or other processes, which is a composite set that exceeds the statistical value of the components individually acquired from the multiple data sources and their vendors. Thus, the “whole is greater than the parts.”

The method and system for collecting and aggregating audience survey data to create a composite set or sub-set of audience survey data as described herein is presently representative of example embodiments, and is not intended as limitations on the scope of the invention.

An instance of this embodiment optionally unifies source data for the purpose of research and analysis (e.g., prior to recommending or performing a buy) as it relates to media markets, such as television programming, radio programming, web programming, publishing/print media, etc. For example, in order to generate inventory buy recommendations to one or more clients, the system acquires and stores information regarding the clients. Information is collected (e.g., from the clients via one or more forms or otherwise) regarding client markets (e.g., audiences), products, industry fields and/or methods of distributing their goods and/or services.

As an example, that collaborative process, combined with media research generated from the unified data source engine and optionally including other sources, such as Respondent Level Data, SQAD reports (for television), SPARC reports (for radio), Scarborough, Neilson, Arbitron, and/or other resources (e.g., generated internally or from one or more vendors), provides the data useful in planning and recommending client buys from a position of sufficient knowledge.

By way of further example, data (e.g., regarding viewership/user traits, demography, location, behavior, viewing habits, psychographic factors, etc.) can be gathered from some or allow of the following sources and/or from additional and/or different sources:

surveys of experts

observed user behavior (e.g., usage rate, loyalty, etc.)

customer and vendor feedback mechanisms

geospatial data

census data

demographic surveys

media consumption data

psychographic surveys (e.g., attributes relating to personality, values, attitudes, interests, lifestyles, etc.)

voting history

donor history

Arbitron

Competitive Media Reporting (LNA)

Competitrack

Mendelsohn

MRI

Nielsen

Publisher's Information Bureau

Scarborough (which measures the lifestyles, shopping patterns, media behaviors, and demographics of consumers)

Simmons Market Research Bureau (which provides consumer research information, including usage information with respect to brands, product categories, media genres).

SQAD and SPARC (providing media cost forecasting data for television and radio)

Example methods and systems for estimating/predicting advertisement prices will now be described. Optionally, the system can learn and predict an optimal, likely, and/or reasonable price of an advertisement (a the present or a future time) for a piece of online content by analyzing real-time and historical data from internal and external data sources. Optionally, such predictions are performed in substantially real-time. Optionally, such predictions are performed in batch mode.

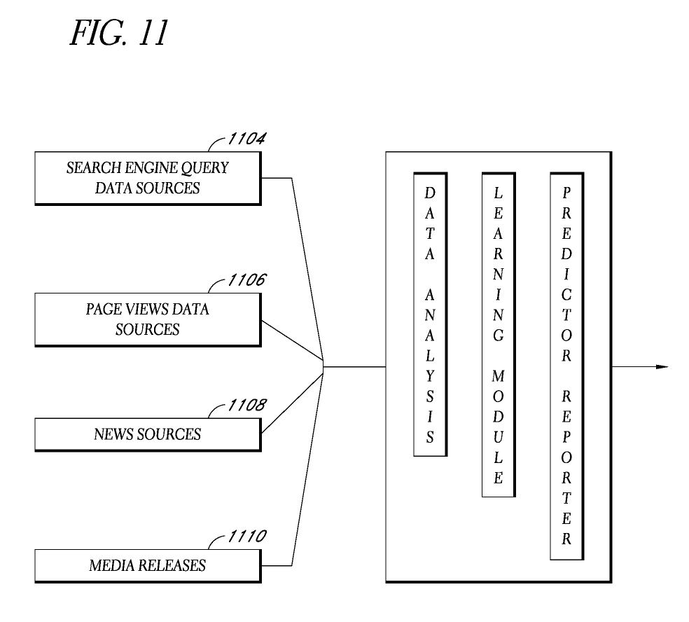

With reference to the system illustrated in FIG. 11, in an example embodiment, the system 102 hosts or accesses a scalable pricing engine 1102 that can, in substantially real-time automatically (or partially automatically and partially manually) predict and/or set the price of an advertisement (e.g., at the time the estimate is provided or at a future specified date) based on the current state of the interest in the content and/or historical trends and/or correlations (e.g., when a certain event or event-type occurs certain content or programs are more likely to have an increase in ratings/popularity). This enables the system 102 to enhance or maximize the revenue generated by the advertisements for that content by varying the price of the advertisement so that it at least partly reflects the interest level/demand for the advertisement content.

In certain instances, the interest level of a piece of content may be determined by a small number of factors, a large number of factors, or very large number of factors (e.g., far more than a human can process in anywhere near real time) to make an actionable determination of the interest level. The example pricing engine 1102 uses a variety of data sources to determine the current interest level in the content. The data sources may include data generated by the system itself (internal) as well as external data sources. The internal data sources may be defined by the data generated from a closed loop process including the hosting a piece of content and recording the content's viewership.

For example, the system may track (e.g., keep a count of) relevant content search engine queries using one or more search engine query data sources 1104 (e.g., a website hosting content that keeps track of search queries for content), website page views (e.g., of one or more websites or other data sources 1104 hosting content), and track and keep a record of details regarding the user's context on the website. The external data sources may include a variety of services or sources 1106, 1108, 1110 that provide access (e.g., substantially real-time access) to the world's events and interests (e.g., news about accidents, wars, sporting event results, celebrity news, weather information, media releases (e.g., movie, books, music releases)).

For example, external sources can include some or all of the following: news service feeds, local and national TV and radio station news, subject-based online blogs, and click-through rates by website users to provide positive feedback. These external data sources can be consumed as digital web feeds (e.g., XML RSS (Really Simple Syndication) feeds and/or ATOM feeds) and/or processed for keywords. The example engine includes a data analysis service component and a reverse-feedback based learning component. The data analysis service imports and process the data from the data sources to determine the optimal (or likely, or reasonable) price at that current time. The learning process monitors the data feeds and results of the content views to modify itself to provide additional data to the data analysis service.

The foregoing process enables pricing adjustments to be performed to help identify and take advantage of local maxima in revenue. These local maxima can move over time, and the system optionally closely (e.g., periodically, every 60 seconds, 5 minutes, 60 minutes, 24 hours and/or otherwise) follows such movements.

Data Sources can include, by way of example, some or all of the following:
News Feeds
Reuters
Local News Stations
National News Stations
Online Blogs
Search Engine Rankings
External Web Traffic Analysis
Internal Website Traffic
Page Views
User Context
IP Address
Geo Lookup
Content Views
Search Engine Queries
Purchase History
Popularity Rankings (‘5 Star’ Rating System)
Email Link Sharing

In an example embodiment, the following formula may be used to setting or adjusting content price:

Price(or Price modifier)=W₁f₁(ppe₁)+W₂f₂(ppe₂)+W₃f₃(ppe₃)+ . . . +Wₙfₙ(ppeₙ)

Were:

e=popularity predictor element (such as those discussed above (e.g., number or relevant queries, number of views of the content, users' context on one or more websites, number of mentions of a type of a news subject, an artist, or of a media);

W=weighting value

f=function (e.g., a normalizing function)

Example embodiments for measuring the efficacy of advertising will now be discussed, including example embodiments of methods and systems for using direct marketing methods as a measurement proxy for the efficacy of awareness advertising. Traditional methods for evaluating the effectiveness of marketing with an awareness objective typically entail direct measurement or estimation of consumer awareness. Such direct methods conventionally involve phone or other surveys, consumer panels, and indirect consumption “lift” measurements (e.g., the measures the change in peoples/viewers awareness of the object of the advertising).

An enhanced measurement system and process is described herein. An example embodiment collects and measures the results/metrics of an advertiser utilizing a direct marketing effort (e.g. coupons, direct mailings) in the absence of and concurrent to an awareness advertising effort. The results are analyzed to generate a measurement of brand lift attributable (or potentially attributable) to the awareness marketing effort. Thus, one or more embodiments enable advertiser inputs to be applied and correlated to multiple reference data points in a manner such that an advertiser is able to measure the efficacy of their campaign efforts and use such information to enhance and/or optimize the value of their advertising spend. While in the following example process, a measurement is performed prior to and then after an awareness campaign, optionally the first measurement is performed after the awareness campaign, and then some time later (e.g., after the effect of the awareness campaign is estimated to have substantially worn off) the second measurement is performed, and the results are compared.

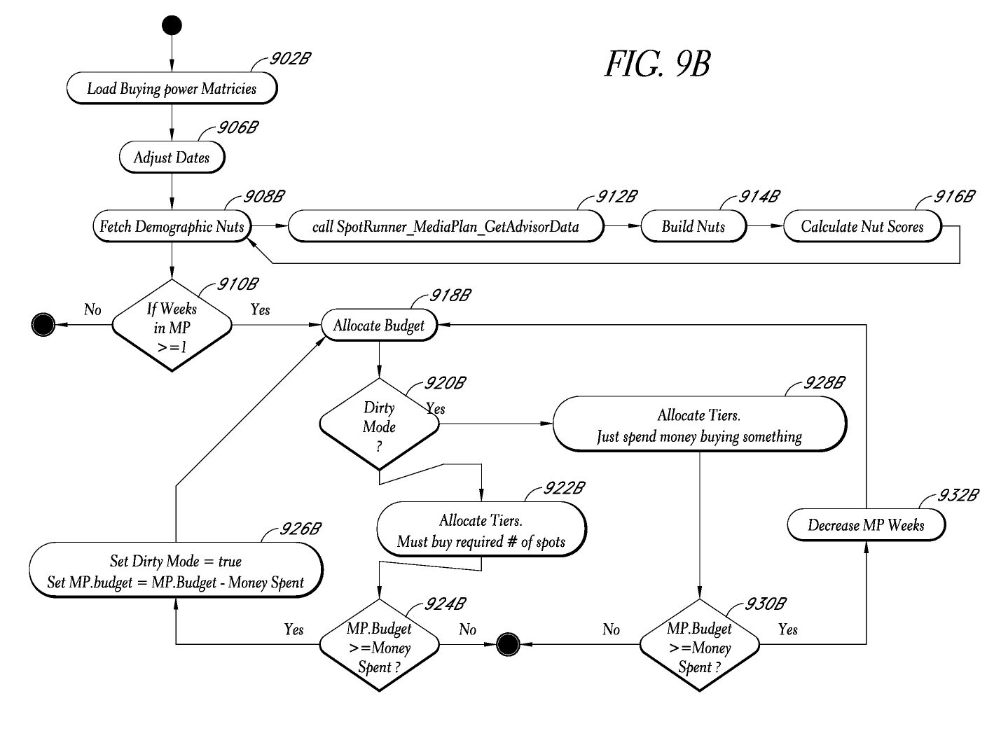

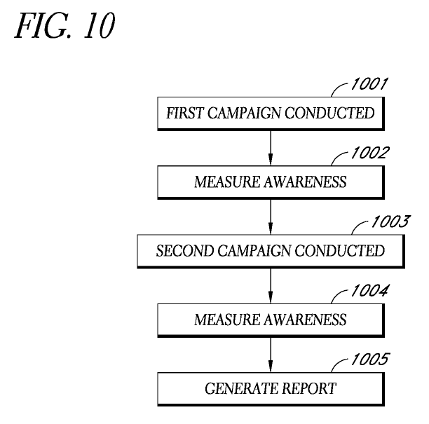

An example process will now be described with reference to FIG. 10. At state 1001, a first campaign (e.g., a direct marketing effort, including for example, coupons, direct mailings, etc., for a product, service, company or other marketing object) is conducted. The direct marketing campaign can involve asking or causing members of the target market to take an action that is directly measurable/connected to the marketing campaign. For example, a member of the target market may be asked to call a number associated with the advertiser, visit a Web site associated with the advertiser, mail a card to the advertiser, use a coupon association with a product or service of the advertiser, etc., enabling to directly determine the effect of the direct marketing campaign. Thus, the focus of a direct marketing campaign may be to cause the recipient to take some sort of action with some immediacy (e.g., within 7 days, within 30 days, within 90 days). While the awareness campaign may optionally be associated with a more general goal of consumers favorably remembering a brand, rather than ask the recipient to take a particular immediate action.

At state 1002, prior to a specific awareness advertising campaign, but after and/or during the direct marketing effort, metrics are collecting relating to consumer awareness (e.g., via telephone surveys, mail surveys, email surveys, web form surveys hosted by a web site, purchase data, etc.) of the marketing object.

At state 1004 an awareness advertising campaign is conducted (to raise the awareness of a targeted or untargeted audience of an object, such as a brand, service, or product, and/or increase the positive disposition toward the object), optionally in conjunction with a direct advertising campaign (e.g., contemporaneously with a direct marketing campaign including for example, coupons, direct mailings, etc.).

At state 1006 metrics are collecting regarding consumer awareness (e.g., via telephone surveys, mail surveys, email surveys, web form surveys hosted by a web site, purchase data, etc.). For example, the surveys can collect information on, where relevant, aided brand awareness (e.g., “do you recognize this brand?”, product awareness (“have you heard of this product?”), brand favorability (“is your impression of this brand favorable or unfavorable?”, product favorability (“is your impression of this product favorable or unfavorable?”, purchase intent (“do you intend to purchase this product in the next [specified time period]?).

At state 1008, a report is generated comparing the awareness metrics with and without the awareness campaign to provide a measurement of awareness lift, and thereby measure the effectiveness of a given awareness campaign. For example, the report can indicate the percentage change (increase or decrease) in responses for each of the measured parameters, optionally broken down by one or more demographic factors (e.g., age, gender, income, marital status, geographic location, etc.). Thus, advertiser inputs can be applied and correlated to multiple reference data points in a manner such that an advertiser is able to measure the efficacy of their campaign efforts and enhance/optimize the value of their advertising spend.

As an illustrative example, an advertiser conducting a national advertising campaign uses some or all of the following as data inputs into the measurement proxy in order to provide a report on campaign efficacy:

Website log data from the advertiser's website presence (e.g., provide some or all of the following information: how many times and when a Web page is requested; what incoming link a visitor followed to arrive at the web site; what search terms a visitor used at a search engine before arriving at the web site, errors that may have occurred);

Phone logs in contexts where the marketing effort includes a call to action via a tracked phone number that indicate how many calls were received at one or more tracked phone numbers from viewers/targets of a media campaign (where viewers are asked to call the tracked number);

email logs that indicate how many emails were received at one or more email addresses from viewers/targets of a media campaign (e.g., where viewers are asked to email/send a reply to a tracked email address);

Media schedule post logs and broadcast station affidavits of performance (e.g., specifying the size and/or demographic of the audience);

Broadcast verification/Watermark logs, indicating when and if advertisements were broadcast;

Ratings (e.g., across national and/or local broadcast, cable, satellite, web, overnights);

Licensed metadata on broadcast
In the example, the system begins capturing data from the client's web logs and analytic stores to build a historical trend and serve as a baseline for eventual comparison post campaign. This data will be moved via an ETL (extract, transform, load) process into either a post buy data store or an operational data store depending on the complexity of transformation and analysis that the client's data needs.

Upon the creation of a direct response campaign and media schedule, station post logs and watermark data as appropriate would be loaded into a post buy data store. As response data from the client becomes available in the form of web and phone logs, all data inputs are transitioned to the operational data store where correlation to ratings, programming schedules, and other reference data points is performed. Using the data and correlation results, a final report is generated and transmitted to one or more destinations. For example, the report can be provided to an advertiser/client via a web page, a word processing document, a PDF document, or otherwise. For example the report can be emailed, streamed, and/or physically mailed to the client. Optionally, the reports are periodically updated and/or transmitted to a client on a pre-defined schedule (e.g., defined by the client or the system operator).

Empirical data can be gathered on via a variety of awareness campaigns-types, including, by one or more of the following (and/or other types):
National Spot Only—wherein Web Traffic is correlated with Post Logs and advertisement fingerprint/tracking data (e.g., Nielsen SIGMA, KeepingTrac, and/or other forms of advertising digital (or analog) identification coding data), to demonstrate the “lift” on their visits.

National Spots with Vanity URL—data on lift through the use of spot specific URLs (e.g., vanity URLs) that can be used to measure lift as a campaign progresses. As the campaign also has a component of spot based segmentation, enhancements/optimization of campaigns are optionally made based upon the individualized results of a specific URL and spot.

National Spot plus Local Markets—provides the marketer the ability to compare results from national spot message and of localized markets. Optionally, a negative test is performed in which a national spot is aired and then “blocked” in several local markets to provide a concrete measurement of awareness lift.

In an example embodiment, a media planning system is provided. Optionally, the media planning system includes a buying advisor system. An example media planning and buying advisor system enables a user to describe their marketing situation in terms of business conditions, objectives, goals, desired demographics, budget, and/or duration via one or more user interfaces (e.g., accessed via a web browser, a client application, or otherwise). Thus, the system optionally provides a user interface via which the user can define some or all of a viewing universe (the population within a defined demographic, psychographic, or product consumption segment against which media audiences are calculated to determine ratings, coverage, reach, etc.). The system enables the user to refine their options, and select (or deselect) among presented options. A media buy plan is presented via which the user may place purchase requests and make purchases of media time and/or content to be presented during that media time.

The system (e.g., hosted on system 102) may include one or more of the following components and/or other components described herein:
Price Prediction Engine
Placement Prediction Engine
Multi-Vendor/Multi-Survey Audience Compositing Subsystem

With reference to FIG. 8, the system can utilize data from one or more of the following data sources and/or other sources in providing recommendations, predictions, etc.:

Surveys of Experts

Observed User Behavior (e.g., usage rate, loyalty, etc.)

Customer and Vendor Feedback Mechanisms

Geospatial data

Census data

Demographic surveys

Media consumption data

Psychographic surveys (e.g., attributes relating to personality, values, attitudes, interests, lifestyles, etc.)

Voting history

Donor history

The foregoing sources are merged into a unified data source 802, and then composition data extraction engine 804 extracts the desired data.

By way of illustration, a Media Plan (MP) is automatically generated (or partially manually and partially automatically generated) by the system. Optionally, the Media Plan serves as a system shopping cart via which a user can make media time and/or advertisement purchases. Optionally, the shopping cart can be edited by the user (e.g., the buyer), wherein the user can make deletions, change quantities, make additions, etc. Then, when the user is satisfied with the shopping cart contents, the user can submit a purchase order/request for the shopping cart contents. Thus, the media plan shopping cart can act a placeholder for advertisement and spot bookings.

The media plan system optionally can be accessed via a user web browser and/or a dedicated client application hosted on a user computer or other system. When a user accesses the media planner, the user is taken through the flow of a) purchase of an advertisement and/or b) the purchase of air time.

By way of example, an advertisement may be a fully custom advertisement or preexisting advertisement content that is to be customized for the user. For example, a user can create a customized ad from an advertisement template by forming customized media sequences based on media templates as described herein. The templates may take various forms adapted for various forms of media including television, radio, Internet, print, out-of-home, or other media according to various embodiments.

In an example embodiment, the templates are optionally customized with additional media objects or information provided by the user. The media templates may include video objects, audio objects, image objects, and/or text objects as well as an edit decision list (EDL) indicating the timeline for playing/displaying one or more objects in the media sequence. Media editing software may be used to compile the media objects into a media file, such as a Windows® Media Player or a Quicktime® file. The user can play the media file from a web page to view the media sequence with generic information (e.g., where the media sequence is an advertisement, the generic information may be generic store name, product name, voiceover, etc.).

Dialog boxes may be displayed to the user for template elements that may be customized, such as all or a portion of a voiceover, background music, text, logo, other video objects, audio objects, image objects and/or text objects that are played during a portion of the media sequence. Optionally, the user may type new text for the customizable part of the voiceover, or select or upload other custom media objects for use in the media sequence.

The template is then tailored using automated and/or manual processes. By way of example, a new image may automatically be loaded and inserted into the EDL to be displayed during a desired portion of a media sequence or a new voice over may be manually recorded for the text input by the user. After the customized media objects are created or uploaded, the customized media sequence is compiled in accordance with the EDL and transmitted (via email, web page or other means) to a third party (such as an advertiser) for approval.

For example, in an embodiment with an Internet advertisement, the template may include a preexisting rich media on-line advertisement or other template for creating a customized advertisement. The user can play the ad template from the web to view and/or hear the ad with generic information (e.g., generic store name, voiceover, etc.). In the case of e-mail advertisements, according to various embodiments, the user can peruse e-mail addresses and other information. In the case of static on-line ads (some banner ads, pop-up ads, etc.), according to various embodiments, the user can view the static on-line ad.

The media plan may identify one or more web sites on which ads are to be placed or e-mail addresses to which the advertisements will be sent, dates the ads will be posted on the web or sent to an e-mail list, rate per ad based on the type of ad (e.g., rich media, banner ad, e-mail, streaming clip on a third party website, pop-up ad, click-through ad), the market in which the ad will run, websites on which the ad will run, length of time the ad will run, frequency with which the ad appears in a given amount of time, total number of airings and total cost for each portion of the media plan.

FIG. 7A illustrates an example media plan object classes diagram. However, other embodiments can include fewer, additional, or different classes.

The example classes will now be described in greater detail

MediaPlan.cs represents a MediaPlan (MP). This object contains generic information regarding the media plan (e.g., Start and End date, Objective, Industry, Target Demographics and/or Advertising location). The class optionally stores a pointer to a selected advertisement and a pointer to the collection of air time bookings. The object can include some or all of the following properties:

Ad—Pointer to the Ad object attached to this MP

Start/End dates—Start and the End date of the MP.

Objective (by way of illustrative example and not limitation):
Ongoing brand awareness
Limited time sale/promotional event (e.g., of service or item being advertised)
Call to action/direct response. By way of example, a call to action advertisement is a type of advertising campaign that tries to get the viewer to perform an action (e.g., go to a store, visit a website, send an email, send an SMS message, or call a phone number). Optionally, a “call to action” ad contains an incentive or a sense of urgency (e.g., a time deadline) to persuade a viewer to take the action.

An objective property instructs an example embodiment of a media plan advisor software how to divide budget between different types of channels and which day parts it is to select during the air time generation.

Budget—contains information regarding client's budget.

SpotBookingCollection—Collection of Booking objects.

DemographicRanges—Information regarding targeted demographics. This is taken from the industry chosen by the user on the front end.

Industry—information regarding industry chosen by the end user during the media plan creation.

IsMergeable—This flag marks MP as Mergeable (e.g., advertisement purchase can be combined with airtime purchase, as discussed below). If the user purchases an advertisement (e.g., custom or customized) and stops the process without purchasing airtime, the media plan is stored in the system with the Ad on it, and without airtime. At this point system sets the flag on the MediaPlan and the MemberAttribute (“MergableMediaPlanId”) flag to the ID of the current Media Plan. The next time the user creates an MP (media plan) with air time and without an Ad, optionally, the system will detach the Ad from the MP which is marked as “Mergeable” and will attach the Ad to the MP with air time.

Advertisement.cs This is the main class of the Advertisement object.
Active collection—A pointer to the current version of the elements collection.
Metadata collection—Collection of the metadata values
SpotBookingCollection.cs—Collection of the Spot Booking objects.
SpotBooking.cs—Represents air time purchased on particular channel.
   DayPart—Pointer to the DayPart object which defines the time of day when this particular booking should be played.
   RunCount—Number of times Ad is to be played within specified time of day over the course of advertising campaign. Optionally, the MSO (Multiple System Operator) does not guarantee exact time when an Ad will be played. In such an instance the Run Count represents the total overall number of airings of particular Ad within particular part of the day. Thus, for example, if the run count is 1, the MSO may play 2 spots one day and not play any the next day.

SpotRunCollection.cs—Collection of Spot Run objects.

SpotRun.cs—If SpotBooking contains information regarding the part of the day and total number of airings customer have purchased. This particular object represents each one of these airings. For example, if RunCount=4 there will be four SpotRun objects equally distributed over the start/end dates of MP. This further enables the system to reconcile reports regarding actual airings received from MSO and SpotRuns.

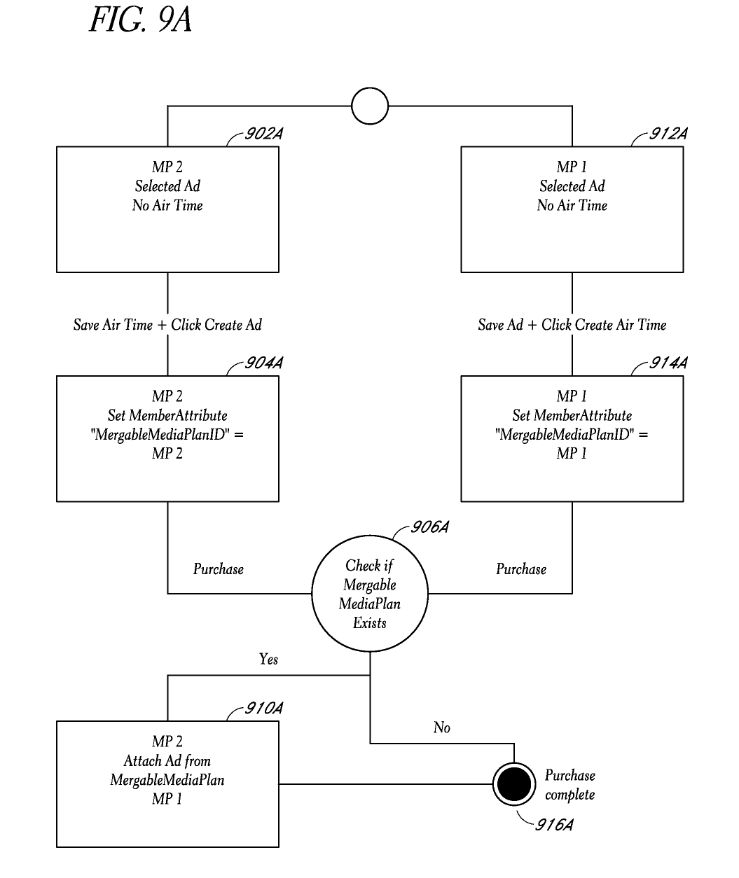

FIG. 9A illustrates an example media plan transaction process, including an advertisement and airtime purchase process. If air time is to be purchased, the process proceeds to state 902A. The air time purchase is saved in the user's shopping cart and the user can then create an advertisement (e.g., by customizing a preexisting template as similarly described elsewhere herein). At state 904A, the mergeable media plan identifier is set to MP2. At state 906A, the system determines if a mergeable media plan exists for the user (wherein an airtime purchase can be combined with an advertisement purchase). If a mergeable media plan exists, the process proceeds to state 910A and an advertisement from the existing media plan (e.g., MP1) is attached to the current media plan (MP2). The process proceeds to state 916A, and the airtime purchase is completed, wherein the media plan2 includes both air time and the advertisement.

If, at state 906A, a determination is made that the mergeable media plan does not exist for the user, the process proceeds to state 916A, and the purchase is completed.

If an advertisement is to be purchased, the proceeds to state 912A where the ad is selected (e.g., an advertising template which the user can customize). The user can also add air time to the user's shopping cart. At state 914A, the mergeable media plan identifier is set to MP1. At state 906A, the system determines if a mergeable media plan exists for the user (wherein an advertisement purchase can be combined with an airtime purchase), If these is a mergeable media plan, the process proceeds to state 910A, as similarly described above. If there is no mergeable media plan, the process proceeds to state 916A, as similarly described above. FIG. 7B illustrates an example media plan schema.

An example embodiment of a media plan advisor will now be described. While the following example discusses a media plan advisor as applied to scheduled television, the media plan advisor can similarly generate advice with respect to one or more of internet advertising, advertising via on-demand programming, advertising utilizing digital video recorders, and so on.

The media plan advisor accesses the user's business conditions, objectives, goals, region, industry, desired demographics, budget, start date, end date, and/or duration from memory to generate a recommended media schedule for the media plan. An example computer program may evaluate networks, number of spots, dayparts (e.g., broadcast time periods), dates, run on site (ROS) vs. targeted rotation vs. fixed placement, region or zone, reach, frequency, and/or cost to determine a recommended plan based on rules in media buying rules database. The media plan is optionally optimized to select dayparts/programs which, within a defined media budget, offer the highest reach or “effective reach” of a specified universe of viewers.

In an example embodiment, in order to generate an MP for a user, user interfaces are provided (e.g., via a website web page or a physical form) that asks the user to provide some or all of the following information, the responses to which are stored in system memory:

Advertising region (physical location, zip code, state, city, radius around a specified point, etc.)

Industry

Objective

Desired demographics

Desired ratings/viewership

Start Date of the MP

End Date of the MP

Advertising period (length of the MP)

Budget

The system uses some or all of the foregoing to execute business rules and create/suggest a suitable media plan for the user.

The foregoing example parameters will now be described in greater detail.

Advertising region—The media planner advisor uses the region information to obtain and/or predict the air time price and available channels/networks/programs, by locating suitable rate card(s) (e.g., a document detailing actual or proposed prices for various ad placement options) in the system. For example, a rate card can specify channels being offered, pricing tiers, and the costs for running ads on those channels during various parts of the day (time slots) for each channel.

Industry—The system uses knowledge of the user's industry to select appropriate networks and/or programs on which to advertise the user's goods and/or services. For example if user is in the “Pet supply” business, “Animal planet” may be a suitable network/channel. The system identifies a relationship between the business/good/service the user desires to advertise and the available channels. By way of example, the system may use viewer demographics of the channels/programs and of the user's industry to identify such a relationship. The system stores and accesses such demographics for a variety of industries (e.g., electronically accessed from a remote database or manually entered into the local database) and for a variety of channels. A given industry has defined set of demographics attached to it (e.g., entered manually into the system or automatically imported from Nielsen, Arbitron and/or other rating databases or feeds). Optionally, the media advisor system matches or attempts to match the industry/product demographics with the network/program demographics to identify and present to the user a network/channel and/or program selection.

As discussed above, an ad campaign may include some or all of the following objectives:
Ongoing brand awareness
Limited time sale/promotion event
Call to action/direct response

The media advisor system uses the objectives to determine, by way of example, how to divide the total budget between spots played in the morning, during the day, afternoon (prime time) and during the night. This adds extra intelligence to the planning process.

The Start date is the campaign start date

The Advertising period is the length of the campaign

The Budget is the campaign budget

FIG. 7C illustrates an example media plan class diagram corresponding to an example embodiment of a media plan advisor. The following are example Media Plan Advisor (MPA) related classes. Fewer, additional, or different classes may be used as well.

MediaPlanAdvisor.cs This is the main class of the example MPA system. The following are example methods, although fewer, additional, or additional methods can be used:
MediaPlanAdvisor( )—Constructor
Advise( )—This method is called when website needs to generate a MediaPlan(MP). One of the input parameters is the MediaPlan object which has region, industry, budget and time frame information.
BuildTiers( ) This method fetches channels from the database and sorts them into different tiers of buckets (e.g., 3 tier buckets). Optionally instead, all channels are treated equally and put in the same bucket.
FetchNuts( ) As described above, when user chooses an Industry the user selects or specifies a set of demographics, which are attached to the MediaPlan. The FetchNuts function calls a database stored procedure and asks for a return list of channels within one or more specified regions which satisfy or substantially satisfy demographic range criteria. Based on returned recordset, channel-pricing information is grouped by channel name which forms a NutBunch object. Then, within this object, channels are grouped by demographics (e.g., male/female, age 18-25/26-40/41-55/56-70, income under $25000/between $25000-$60000/greater than $60000, household size 1/2/3-4/greater than 4, etc.) and that forms a DemographicNut object.

BudgetAllocator.cs Performs the allocation of spots within the available air time. This class takes NutBunch objects and sorts them (e.g., by score), then takes a certain NutBunch (e.g., the highest scoring NutBunch) and attempts to allocate the needed air time. If it can not allocate the target amount of spots, it so marks the NutBunch (e.g., as bad) and moves on to next one, until it exhausts the budget or NutBunches.

DemogrphicNut.cs Represents a collection of rate card schedules related to a particular channel. For example, if a user requested the creation of a media plan in a region, the system will retrieve rate card schedules for the channels available within this region. The rate card schedules are then grouped by channel (each group later will be a NutBunch). The groups are then further grouped by day part property (e.g., time of day, morning, day, evening, etc.) of rate card schedule. Each such group is a DemographicNut.

NutBunch.cs—Represents a collection of rate card schedules grouped by channel.

Optionally, the MPA modifies dates specified by user for the target Media Plan. Optionally, the MSO does not guarantee the time when the spot will be played. If the MSO does not guarantee the time when the spot will be played, optionally the user is not guaranteed that the user's Media Plan will start on a specific day requested by the user (e.g., Thursday or exactly Friday). For example, air time may be sold in units of several days, by week, by month, etc. By way of illustration, if air time is sold by the week, and if the user specifies a start date of the media plan as Tuesday, optionally, the start date is modified by the system to the previous Monday. Similarly, the end date may be moved to last Friday of the week.

FIG. 9B illustrates an example process of generating a media plan. At state 902B, one or more buying power matrices are loaded by the system from memory. At state 906B, a requested campaign start date and/or end date are adjusted as specified by system rules (e.g., to align the start and/or end dates with the unit period (e.g., a week)). By way of example, during an initial client survey, the system asks the user what type of campaign the user is trying to put together. Example options may include one or more of the following; “Awareness”, “Promotion Event”, “Direct Response”. A “Buying Power Matrices” may be or include a matrix of suggested amount of spots-per-time period (e.g., per week) a user should buy in order to accomplish (or likely accomplish) the goals of the campaign as specified by the user. Optionally, this is based at least in part on the average and/or media cost of a spot in the advertising area (e.g., calculated using the rate card pricing information, total media plan budget, the time span of the media plan). The system calculates the “buying power” which is amount of spots user can buy per week (or other specified time period) based on some or all of the foregoing parameters. The buying power is then looked up in the buying power matrices, which contains suggested number of spots, which prevents or reduces the possibility that the user will overbuying spots or under buying spots per week or other time period.

At state 908B, one or more demographic nuts are loaded by the system from memory. A procedure (e.g., SpotRunner_MediaPlan_GetAdvisorData) is called. The nuts are generated and scored. If, a determination is made at state 910B that the campaign period specified by a user is less than a permissible minimum (e.g., 1 week), an error message is generated, and the user is prompted to provide a valid value. If the user provided a valid value, a budget allocation process is performed at state 918B. At state 920B, a determination is made as to whether a “dirty mode” allocation is to be made. The allocation may be made using a one or more score scaling matrices optionally in conjunction with Buying Power Matrices. A score scaling matrix may include coefficients for day parts (e.g., “Day”, “Afternoon”, “Evening”, and “Overnight”). When the raw score is calculated for a given DemographicNut, the system applies a corresponding Score Scaling coefficient to the DemographicNut, thereby boosting or downgrading particular day parts for each type of the campaign. This enables correct, or projected most advantageous daypart spot distribution along with week-based spot distribution for the given type of the campaign, making for well balanced media plans for a given type of the campaigns.

If a “dirty mode” process is to be performed, at state 928B the system calculates how many spots it needs to allocate for each type of the day part for the period of the media plan. By way of illustrative example, if there are to 2 spots per day part for a period of 5 days, there will be a total of 10 spots. An Allocate Tiers process selects the first NutBunch (collection of day parts for one channel, such as “CNN”, and will try to book 10 spots, 2 every day).

If, for example, a portion of the week is sold out, the corresponding NutBunch is so marked (e.g., as “not workable”) and the process proceeds to the next NutBunch, and so on until the budget has been fully allocated (as determined at state 930B) or there are no remaining NutBunches. If the budget is less than or equal to the money spent, the process proceeds to state 932B and the number of weeks in the media plan is reduced.

The dirty mode is optionally used if a booking is not successful. By way of illustrative example, if there are 5 channels, and the system has unsuccessfully attempted to book 10 spots on channel, then the system utilizes the “Dirty Mode” which is a parameter passed to function AllocateTiers( ). When the dirty mode is on, the system loops again through the channels and attempts to allocate as many spots as possible (given the existing constraints), which may be less then the target of 10.

If the dirty mode is not being used, the process proceeds to state 922B and a tier allocation is performed and the number of specified spots are purchased. At state 924B, a determination is made as to whether the MP budget is greater or equal to the money spent. If it is, the process proceeds to state 926B and the dirty mode flag is set to true, and the MP budget is calculated by subtracting the money spent from the MP budget. The process then proceeds back to state 918B.

Example methods and systems for rate prediction will now be described. Rate prediction (RP) describes the ability to estimate the future cost of a given media type for specific markets, geographies and/or media providers. An optional Rate Prediction Engine (RPE) (e.g., hosted by system 102) utilizes one or more processes applied to several dimensions of media data that are stored in a database, such as a Media Analytics Data Mart (MADM) database, to calculate the future media cost.

Optionally, predictions are performed differently for different types of media distribution. For example, predications may be done differently for cable television than for broadcast television.

By way of illustration, for cable distribution, a rate card, in conjunction with optional adjustment factors (e.g., historical rates, seasonality, unique events, etc.), may be used to predict what the actual rate will be.

By way of further illustration, for broadcast distribution, the system may predict ratings that a time slot will achieve based at least in part on historical data.

When the prediction is complete, negotiation with a seller is optionally performed so as to set an actual rate. The results of such negotiations may be analyzed and utilized for future predictions (e.g., as historical rate information).

In a buyer wants to have a higher confidence level that the buyer's offer to have an advertisement aired on a particular channel, program, and/or time slot, the buyer may want to offer more than the predicted rate.

Optionally, no negotiations take place between the buyer and seller. Instead, the seller may have previously agreed that the seller is willing to accept a price set by the system based on its predictions (which may include human modification of the predictions). Thus, if a buyer agrees to pay a price and/or accept a package presented by the system, the system may accept the offer on behalf of the seller. The seller may have the option to terminate the sale if the buyer made certain misrepresentations (e.g., regarding the buyer's/client's industry) or whose advertising content fails to meet certain seller standards.

Optionally, the system evaluates the efficacy of a campaign (e.g., by surveying advertisers and/or consumers).

Example Media Analytics Data Mart Components can include some or all of the following and/or other data:

1. Planning rates gathered from media operator(s) (e.g., periodically, such as a quarterly basis, a monthly basis, a weekly basis, a daily basis, or otherwise)

a. By DMA

b. Cost (CPP) by target demographic

c. By coverage area or zone

d. By station or channel

e. By day-part

2. Negotiated media rates from our research and purchase activity

a. By DMA

b. Cost (CPP) by target demographic

c. By coverage area or zone

d. By station or channel

e. By day-part

f. Date

g. Date relative to planned showing of ad on media

3. Spot Runner Marketplace bid and purchase activity

a. By DMA

b. Cost (CPP) by target demographic

c. By coverage area or zone

d. By station or channel

e. By day-part

f. Date

g. Date relative to planned showing of ad on media

4. Regional Ad Supply/Demand Drivers

a. Sporting Event schedules

b. Holiday Schedules

c. Political Election Schedules

5. Third-party data

a. Costs/CPP

b. Ratings

6. Demographic data on viewers, subscribers, listeners, etc.

a. Geography

b. Income levels

c. Media consumption

d. Consumer profiles

7. Supply and demand model

a. Radio

b. TV—commercial, placements

c. Online—search, display, online video, online audio, CPA

d. Print

e. Out-of-home

8. Media Catalog

a. Media types

1. Radio

2. TV—commercial, placements

3. Online—search, display, online video, online audio, CPA

4. Print

5. Out-of-home

b. Geography

c. Ad type

d. Currency—How it is rated or measured

Because data may be collected from multiple vendors and/or viewers, the system optionally accesses historical ratings and rate data from a variety of sources, accesses demographic data, and uses the combination to normalize and/or correct currently received data, such as rate data. One or more feedback loops can be used to determine the efficacy of a campaign. For example, the system can (1) view advertiser modifications to the advertising plan suggested by system; (2) evaluate actual ratings and rates that are produced by the advertising plan, compared to the predictions; (3) evaluate efficacy of advertising campaign.

The system optionally determines/estimates and demonstrates to a user the efficacy of a campaign. For example, the system can first conducting a conventional direct marketing campaign and evaluating results (baseline), and the conducting a conventional direct marketing campaign in combination with a system bid campaign and the results are evaluation. For example, after the campaign was added, a survey is optionally performed to measure (e.g., via surveys) how much of a results boost was achieved by comparing with a pre-campaign survey.

An example Rate Prediction Engine Process can include some or all of the following states:
1. Creates a model that populates the metrics for different media types in the media catalog, using available and authoritative pricing information available, optionally in order of authority (optionally other orderings can be used):
a. Purchased
b. Negotiated
c. Planning
d. Estimated
2. Decomposes the factors that drive cost for a specific unit or item of advertising inventory, such as some or all of the following:
a. Audience
b. Geography
c. Demography
i. Income
ii. Education
iii. Ethnicity
iv. Age
v. Household size
vi. Gender
vii. Education level
viii. Broadband access
ix. Interactive TV access
d. Supply & Demand assumptions based on time series view of ad clearance (e.g., a coverage percentage indicating the collective percent of homes (e.g., total homes or only homes in which it is believed a television is present) in a geographical area accounted for by the markets in which the program airs).
i. Lead time (Order versus booking)
ii. Specificity of Request (e.g.: length of day-part being predicted)
iii. Level of guaranteed clearance/pre-emption and other terms
iv. Volume Discount estimates
3. Provides estimated metrics for media by finding authoritative information that can be applied to the ad metric in question, by finding proximity (in terms of the decomposition), correlation, or some other relationship.

An example placement prediction system (optionally hosted on system 102) will now be described. Media contracts are often signed at a broader grain than the specific timeslots and programs in which they will run. Specific slots and programs will have varying values for a given marketing goal. Broader guarantees of placement will often be sold at lower costs. The placement prediction system predicts/estimates what specific placement will be realized for given a contract—therefore enabling optimization of contract terms (e.g., to maximize the marketing benefit yield as a function of cost).

By way of example, the system can access historical information from one or more databases that stores sales and placement information, including some or all of the following related variables:

Price

CPP

CPM

PMSA

DMA

Demographics

Daypart

Number of dayparts

Station

Program

Number of programs

Date

Industry

Number of spots

Length of spots

Length of run

Advertiser

Optionally, certain historical information may be weighted more heavily than other historical information, such as based on the recentness of the information and the degree of match with a proposed placement or media plan.

While the foregoing detailed description discloses several embodiments of the present invention, it should be understood that this disclosure is illustrative only and is not limiting of the present invention. It should be appreciated that the specific configurations and operations disclosed can differ from those described above.

What is claimed is:

1. A computer-implemented method for generating a unified advertising spot inventory database based on data existing in different formats stored on different systems, the method comprising:
gathering advertising inventory-related data existing in the different systems in different formats;
identifying various data elements in the gathered advertising inventory-related data; and
at least partly based on the identification, storing the gathered data in a plurality of records in a unified data store using a common set of schema.

2. The method as defined in claim 1, the method further comprising enabling a computer-based media market place system to access the unified data store.

3. The method as defined in claim 1, the method further comprising:
accessing radio inventory data from a first source in a first format;
using the common schema to store the radio inventory data in the unified data store;
accessing television inventory data from a second source in a second format; and
using the common schema to store the television inventory data in the unified data store.

4. The method as defined in claim 1, the method further comprising:
accessing out of home inventory data from a first source in a first format;
using the common schema to store the out of home inventory data in the unified data store;
accessing Web advertising inventory data from a second source in a second format; and
using the common schema to store the Web advertising inventory data in the unified data store.

5. The method as defined in claim 1, the method further comprising:
accessing data from a first source related to a first media inventory;
determining the type of media the first source data is associated with;
storing in a first record an indication as to the type of media the first source data is associated with;
accessing data from a second source related to a second media inventory;
determining the type of media a second source data is associated with, wherein the type of media the second source data is associated with is different than the type of media the first source data is associated with; and
storing in a second record an indication as to the type of media the second source data is associated with.

6. The method as defined in claim 1, the method further comprising:
accessing data from a first source related to a first media inventory of a first type;
identifying a first date range associated with the first media inventory;
storing the first data range in a first record;
identifying first days of the week associated with the first media inventory;
storing the first days of the week in the first record;
accessing data from a second source related to a second media inventory of a second type;
identifying a second date range associated with the second media inventory;
storing the second data range in a second record;
identifying second days of the week associated with the second media inventory; and
storing the second days of the week in the second record.

7. The method as defined in claim 1, the method further comprising:
accessing data from a first source related to a first media inventory of a first type;
identifying a first market identifier associated with the first media inventory;
storing the first market identifier in a first record;
accessing data from a second source related to a second media inventory of a second type;
identifying a second market identifier associated with the second media inventory; and
storing the second market identifier in a second record.

8. The method as defined in claim 1, the method further comprising:
accessing data from a first source related to a first media inventory of a first type;
identifying a first station identifier associated with the first media inventory;
storing the first station identifier in a first record;
accessing data from a second source related to a second media inventory of a second type;
identifying a second station identifier associated with the second media inventory; and
storing the second market identifier in a second record.

9. A computerized method for encoding media related data for a plurality of media types from a plurality of data sources, the method comprising:
mapping data from a first source to a first schema using a first map and/or tags;
accessing data from the first source related to a first media spot;
determining the type of media the first source data is associated with;
storing in a first record an indication as to the type of media the first source data is associated with;
identifying a date range associated with the first media spot;
storing the data range in the first record;
identifying days of the week associated with the first media spot;
storing the days of the week in the first record;
identifying a market identifier associated with the first media spot;
storing the market identifier in the first record;
identifying a station identifier associated with the first media spot;
storing the station identifier in the first record;
identifying a demographic data associated with the first media spot;
storing the demographic data in the first record;
mapping data from a second source to a second schema using a second map and/or tags;
accessing data from the second source related to a second media spot;
determining the type of media the second source data is associated with, wherein the type of media the second source data is associated with is different than the type of media the first source data is associated with;
storing in a second record an indication as to the type of media the second source data is associated with;
identifying a date range associated with the second media spot;
storing the data range in the second record; and
enabling a computer-based media market place system to access the first record and the second record.

10. The method as defined in claim 9, wherein the first record and the second record are stored on the same system.

11. The method as defined in claim 9, wherein the first record and the second record are stored in unified database.

12. The method as defined in claim 9, wherein the data from the first source related to the first media spot is in a different format then the data from the second source related to a second media spot.

13. The method as defined in claim 9, wherein the first media spot is a radio advertising spot and the second media spot is a television media spot.

14. The method as defined in claim 9, the method further comprising:
identifying a price associated with the first media spot; and
storing the price in the first record.

15. The method as defined in claim 14, the method further comprising:
identifying a currency type associated with the price; and
storing the currency type in the first record.

16. The method as defined in claim 14, the method further comprising:
identifying a spot type associated with the first media spot; and
storing an indication as to the spot type in the first record.

17. A system for integrating advertising inventory data from disparate data stores associated with disparate sources, comprising:
one or more network interfaces coupled to a plurality of disparate data stores associated with disparate sources, wherein the data stores supply advertising inventory data, wherein different data stores store data related to different types of advertising media in different formats;
a module that transforms the inventory data from the data stores into a common format;
a data store the stores the transformed advertising inventory data; and
an interface that provides access to the transformed advertising inventory data to a computer-based media transaction system.

18. The system as defined in claim 17, wherein the module is configured to transform advertising inventory data for radio spots and television spots into the common format.

19. The system as defined in claim 17, wherein the module is configured to transform inventory data for out of home advertising inventory into the common format.

20. The system as defined in claim 17, wherein the module is configured to map the following data elements to the common format:
media type;
spot type;
time period;
price;
ratings;
demographics.
